(19) United States
(12) Patent Application Publication
(10) Pub. No.: US 2002/0197729 A1
(43) Pub. Date: Dec. 26, 2002

(54) Biochemical analysis unit and method for manufacturing the same

(75) Inventor: Hirohiko Tsuzuki, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/166,291

(22) Filed: Jun. 11, 2002

(30) Foreign Application Priority Data
Jun. 21, 2001 (JP) 2001-187853

(51) Int. Cl. G01N 21/03

(52) U.S. Cl. 436/165; 436/164; 436/169; 436/172; 436/57; 422/52; 422/55; 422/56; 422/58; 422/82.05; 422/82.08; 435/288.7

(57) ABSTRACT

A biochemical analysis unit includes a plurality of absorptive regions two-dimensionally formed so as to be spaced apart from each other by weaving a plurality of light shielding strips made of a material capable of attenuating radiation energy and a plurality of absorptive strips made of an absorptive material so that the light shielding strip is present between neighboring absorptive regions. According to the thus constituted biochemical analysis unit, it is possible to prevent noise caused by the scattering of electron beams (β rays) released from a radioactive labeling substance from being generated in biochemical analysis data even in the case of forming in the biochemical analysis unit at a high density a plurality of spot-like regions selectively labeled with a radioactive labeling substance, thereby preparing the biochemical analysis unit, bringing the biochemical analysis unit into close contact with a stimulable phosphor layer to expose the stimulable phosphor layer to the radioactive labeling substance, irradiating the stimulable phosphor layer with a stimulating ray to excite the stimulable phosphor, photoelectrically detecting the stimulated emission released from the stimulable phosphor layer, and producing biochemical analysis data.

### BACKGROUND OF THE INVENTION

The present invention relates to a biochemical analysis unit and a method for manufacturing the same and, particularly, to a biochemical analysis unit and a method for manufacturing the same which can prevent noise caused by the scattering of electron beams (β rays) released from a radioactive labeling substance from being generated in biochemical analysis data even in the case of forming in the biochemical analysis unit at a high density a plurality of spot-like regions of specific binding substances which can specifically bind with a substance derived from a living organism and whose sequence, base length, composition and the like are known, selectively labeling the plurality of spot-like regions with a radioactive labeling substance, thereby preparing the biochemical analysis unit, bringing the thus prepared biochemical analysis unit into close contact with a stimulable phosphor layer, exposing the stimulable phosphor layer to the radioactive labeling substance, irradiating the stimulable phosphor layer with a stimulating ray to excite the stimulable phosphor, photoelectrically detecting the stimulated emission released from the stimulable phosphor layer, and producing biochemical analysis data, a biochemical analysis unit and a method for manufacturing the same which can prevent noise caused by the scattering of chemiluminescence emission released from a plurality of spot-like regions of a biochemical analysis unit from being generated in biochemical analysis data even in the case of forming in the biochemical analysis unit at a high density the plurality of spot-like regions containing specific binding substances which can specifically bind with a substance derived from a living organism and whose sequence, base length, composition and the like are known, selectively labeling the plurality of spot-like regions with a labeling substance which generates chemiluminescence emission when it contacts a chemiluminescent substrate, thereby preparing the biochemical analysis unit, bringing a chemiluminescent substrate into contact with the biochemical analysis unit, thereby causing the plurality of spot-like regions of the biochemical analysis unit to release chemiluminescence emission, holding the biochemical analysis unit formed with the plurality of spot-like regions which are selectively releasing chemiluminescence emission in close contact with a stimulable phosphor layer, exposing the stimulable phosphor layer to chemiluminescence emission, irradiating the stimulable phosphor layer with a stimulating ray, photoelectrically detecting stimulated emission released from the stimulable phosphor layer, and producing biochemical analysis data, and a biochemical analysis unit and a method for manufacturing the same which can prevent noise caused by scattering chemiluminescence emission or fluorescence emission released from a plurality of spot-like regions of a biochemical analysis unit from being generated in biochemical analysis data even in the case of forming in the biochemical analysis unit at a high density the plurality of spot-like regions containing specific binding substances which can specifically bind with a substance derived from a living organism and whose sequence, base length, composition and the like are known, selectively labeling the plurality of spot-like regions with a labeling substance which generates chemiluminescence emission when it contacts a chemiluminescent substrate and/or a fluorescent substance, photoelectrically detecting chemiluminescence emission or fluorescence emission released from a plurality of spot-like regions of a biochemical analysis unit and producing biochemical analysis unit.

### DESCRIPTION OF THE PRIOR ART

An autoradiographic analyzing system using as a detecting material for detecting radiation a stimulable phosphor which can absorb, store and record the energy of radiation when it is irradiated with radiation and which, when it is then stimulated by an electromagnetic wave having a specified wavelength, can release stimulated emission whose light amount corresponds to the amount of radiation with which it was irradiated is known, which comprises the steps of introducing a radioactively labeled substance into an organism, using the organism or a part of the tissue of the organism as a specimen, superposing the specimen and a stimulable phosphor sheet formed with a stimulable phosphor layer for a certain period of time, storing and recording radiation energy in a stimulable phosphor contained in the stimulable phosphor layer, scanning the stimulable phosphor layer with an electromagnetic wave to excite the stimulable phosphor, photoelectrically detecting the stimulated emission released from the stimulable phosphor to produce digital image signals, effecting image processing on the obtained digital image signals, and reproducing an image on displaying means such as a CRT or the like or a photographic film (see, for example, Japanese Patent Publication No. 1-60784, Japanese Patent Publication No. 1-60782, Japanese Patent Publication No. 4-3952 and the like).

There is further known chemiluminescence analysis system comprising the steps of employing, as a detecting material for light, a stimulable phosphor which can absorb and store the energy of light upon being irradiated therewith and release a stimulated emission whose amount is proportional to that of the received light upon being stimulated with an electromagnetic wave having a specific wavelength range, selectively labeling a fixed high molecular substance such as a protein or a nucleic acid sequence with a labeling substance which generates chemiluminescence emission when it contacts a chemiluminescent substance, contacting the high molecular substance selectively labeled with the labeling substance and the chemiluminescent substance, storing and recording the chemiluminescence emission in the wavelength of visible light generated by the contact of the chemiluminescent substance and the labeling substance in the stimulable phosphor contained in a stimulable phosphor layer formed on a stimulable phosphor sheet, scanning the stimulable phosphor layer with an electromagnetic wave to excite the stimulable phosphor, photoelectrically detecting the stimulated emission released from the stimulable phosphor to produce digital signals, effecting data processing on the obtained digital signals, and reproducing data on displaying means such as a CRT or a recording material such as a photographic film (see for example, U.S. Pat. No. 5,028,793, UK Patent Application 2,246,197 A and the like).

Unlike the system using a photographic film, according to these systems using the stimulable phosphor as a detecting material, development, which is chemical processing, becomes unnecessary. Further, it is possible reproduce a desired image by effecting image processing on the obtained image data and effect quantitative analysis using a computer. Use of a stimulable phosphor in these processes is therefore advantageous.

On the other hand, a fluorescence analyzing system using a fluorescent substance as a labeling substance instead of a radioactive labeling substance in the autoradiographic analyzing system is known. According to this system, it is possible to study a genetic sequence, study the expression level of a gene, and to effect separation or identification of protein or estimation of the molecular weight or properties of protein or the like. For example, this system can perform a process including the steps of distributing a plurality of DNA fragments on a gel support by means of electrophoresis after a fluorescent dye was added to a solution containing a plurality of DNA fragments to be distributed, or distributing a plurality of DNA fragments on a gel support containing a fluorescent dye, or dipping a gel support on which a plurality of DNA fragments have been distributed by means of electrophoresis in a solution containing a fluorescent dye, thereby labeling the electrophoresed DNA fragments, exciting the fluorescent dye by a stimulating ray to cause it to release fluorescence emission, detecting the released fluorescence emission to produce an image and detecting the distribution of the DNA fragments on the gel support. This system can also perform a process including the steps of distributing a plurality of DNA fragments on a gel support by means of electrophoresis, denaturing the DNA fragments, transferring at least a part of the denatured DNA fragments onto a transfer support such as a nitrocellulose support by the Southern-blotting method, hybridizing a probe prepared by labeling target DNA and DNA or RNA complementary thereto with the denatured DNA fragments, thereby selectively labeling only the DNA fragments complementary to the probe DNA or probe RNA, exciting the fluorescent dye by a stimulating ray to cause it to release fluorescence emission, detecting the released fluorescence emission to produce an image and detecting the distribution of the target DNA on the transfer support. This system can further perform a process including the steps of preparing a DNA probe complementary to DNA containing a target gene labeled by a labeling substance, hybridizing it with DNA on a transfer support, combining an enzyme with the complementary DNA labeled by a labeling substance, causing the enzyme to contact a fluorescent substance, transforming the fluorescent substance to a fluorescent substance having fluorescence emission releasing property, exciting the thus produced fluorescent substance by a stimulating ray to release fluorescence emission, detecting the fluorescence emission to produce an image and detecting the distribution of the target DNA on the transfer support. This fluorescence detecting system is advantageous in that a genetic sequence or the like can be easily detected without using a radioactive substance.

Similarly, there is known a chemiluminescence detecting system comprising the steps of fixing a substance derived from a living organism such as a protein or a nucleic acid sequence on a support, selectively labeling the substance derived from a living organism with a labeling substance which generates chemiluminescence emission when it contacts a chemiluminescent substrate, contacting the substance derived from a living organism and selectively labeled with the labeling substance and the chemiluminescent substrate, photoelectrically detecting the chemiluminescence emission in the wavelength of visible light generated by the contact of the chemiluminescent substrate and the labeling substance to produce digital image signals, effecting image processing thereon, and reproducing a chemiluminescent image on a display means such as a CRT or a recording material such as a photographic film, thereby obtaining information relating to the high molecular substance such as genetic information.

Further, a micro-array analyzing system has been recently developed, which comprises the steps of using a spotting device to drop at different positions on the surface of a carrier such as a slide glass plate, a membrane filter or the like specific binding substances, which can specifically bind with a substance derived from a living organism such as a cell, virus, hormone, tumor marker, enzyme, antibody, antigen, abzyme, other protein, a nuclear acid, cDNA, DNA, RNA or the like and whose sequence, base length, composition and the like are known, thereby forming a number of independent spots, specifically binding the specific binding substances using a hybridization method or the like with a substance derived from a living organism such as a cell, virus, hormone, tumor marker, enzyme, antibody, antigen, abzyme, other protein, a nuclear acid, cDNA, DNA or mRNA by extraction, isolation or the like and optionally further subjected to chemical processing, chemical modification or the like and which is labeled with a labeling substance such as a fluorescent substance, dye or the like, thereby forming a micro-array, irradiating the micro-array with a stimulating ray, photoelectrically detecting light such as fluorescence emission released from a labeling substance such as a fluorescent substance, dye or the like, and analyzing the substance derived from a living organism. This micro-array analyzing system is advantageous in that a substance derived from a living organism can be analyzed in a short time period by forming a number of spots of specific binding substances at different positions of the surface of a carrier such as a slide glass plate at high density and hybridizing them with a substance derived from a living organism and labeled with a labeling substance.

In addition, a macro-array analyzing system using a radioactive labeling substance as a labeling substance has been further developed, which comprises the steps of using a spotting device to drop at different positions on the surface of a carrier such as a membrane filter or the like specific binding substances, which can specifically bind with a substance derived from a living organism such as a cell, virus, hormone, tumor marker, enzyme, antibody, antigen, abzyme, other protein, a nuclear acid, cDNA, DNA, RNA or the like and whose sequence, base length, composition and the like are known, thereby forming a number of independent spots, specifically binding the specific binding substance using a hybridization method or the like with a substance derived from a living organism such as a cell, virus, hormone, tumor marker, enzyme, antibody, antigen, abzyme, other protein, a nuclear acid, cDNA, DNA or mRNA by extraction, isolation or the like and optionally further subjected to chemical processing, chemical modification or the like and which is labeled with a radioactive labeling substance, thereby forming a macro-array, superposing the macro-array and a stimulable phosphor sheet formed with a stimulable phosphor layer, exposing the stimulable phosphor layer to the radioactive labeling substance, irradiating the stimulable phosphor layer with a stimulating ray to excite the stimulable phosphor, photoelectrically detecting the stimulated emission released from the stimulable phosphor to produce biochemical analysis data, and analyzing the substance derived from a living organism.

However, in the macro-array analyzing system using a radioactive labeling substance as a labeling substance, when the stimulable phosphor layer is exposed to a radioactive labeling substance, since the radiation energy of the radioactive labeling substance contained in spot-like regions formed on the surface of a carrier such as a membrane filter is very large, electron beams (β rays) released from the radioactive labeling substance contained in the individual spot-like regions are scattered in the carrier such as a membrane filter, thereby impinging on regions of the stimulable phosphor layer that should be exposed only to the radioactive labeling substance contained in neighboring spot-like regions, or electron beams released from the radioactive labeling substance adhering to the surface of the carrier such as a membrane filter between neighboring spot-like regions impinge on the stimulable phosphor layer, to generate noise in biochemical analysis data produced by photoelectrically detecting stimulated emission, thus making data of neighboring spot-like regions hard to separate and lowering resolution, and to lower the accuracy of biochemical analysis when a substance derived from a living organism is analyzed by quantifying the radiation amount of each spot. The degradation of the resolution and accuracy of biochemical analysis is particularly pronounced when spots are formed close to each other at high density.

In order to solve these problems by preventing noise caused by the scattering of electron beams released from radioactive labeling substance contained in neighboring spot-like regions, it is inevitably required to increase the distance between neighboring spot-like regions and this makes the density of the spot-like regions lower and the test efficiency lower.

Furthermore, in the field of biochemical analysis, it is often required to analyze a substance derived from a living organism by forming at different positions on the surface of a carrier such as a membrane filter or the like a plurality of spot-like regions containing specific binding substances which can specifically bind with a substance derived from a living organism such as a cell, virus, hormone, tumor marker, enzyme, antibody, antigen, abzyme, other protein, a nuclear acid, cDNA, DNA, RNA or the like and whose sequence, base length, composition and the like are known, specifically binding, using a hybridization method or the like, the specific binding substances contained in the plurality of spot-like regions with a substance derived from a living organism labeled with a labeling substance which generates chemiluminescence emission when it contacts a chemiluminescent substrate, thereby selectively labeling the plurality of spot-like regions, causing the plurality of spot-like regions to come into contact with a chemiluminescent substrate, exposing the stimulable phosphor layer of a stimulable phosphor sheet to chemiluminescence emission in the wavelength of visible light generated by the contact of the chemiluminescent substance and the labeling substance, thereby storing the energy of chemiluminescence emission in the stimulable phosphor layer, irradiating the stimulable phosphor layer with a stimulating ray, and photoelectrically detecting stimulated emission released from the stimulable phosphor layer, thereby effecting biochemical analysis. In this case, chemiluminescence emission released from any particular spot-like region is scattered in the carrier such as a membrane filter, thereby impinging on regions of the stimulable phosphor layer that should be exposed only to the chemiluminescence emission released from neighboring spot-like regions to generate noise in biochemical analysis data produced by photoelectrically detecting stimulated emission, thus making data of neighboring spot-like regions hard to separate and lowering resolution, and to lower the quantitative characteristics of biochemical analysis data.

Further, in the field of biochemical analysis, it is often required to analyze a substance derived from a living organism by forming a plurality of spot-like regions containing specific binding substances spot-like formed at different positions on the surface of a carrier such as a membrane filter or the like, which can specifically bind with a substance derived from a living organism such as a cell, virus, hormone, tumor marker, enzyme, antibody, antigen, abzyme, other protein, a nuclear acid, cDNA, DNA, RNA or the like and whose sequence, base length, composition and the like are known, specifically binding, using a hybridization method or the like, the specific binding substances contained in the plurality of spot-like regions with a substance derived from a living organism labeled with a labeling substance which generates chemiluminescence emission when it contacts a chemiluminescent substrate and/or a fluorescent substance, thereby selectively labeling the plurality of spot-like regions, and causing it to contact a chemiluminescent substrate, thereby photoelectrically detecting the chemiluminescence emission in the wavelength of visible light, or irradiating it with a stimulating ray, thereby photoelectrically detecting fluorescence emission released from a fluorescent substance. In these cases, chemiluminescence emission or fluorescence emission released from the plurality of spot-like regions is scattered in the carrier such as a membrane filter or chemiluminescence emission or fluorescence emission released from any particular spot-like region is scattered and mixed with chemiluminescence emission or fluorescence emission released from neighboring spot-like regions, thereby generating noise in biochemical analysis data produced by photoelectrically detecting chemiluminescence emission and/or fluorescence emission.

### SUMMARY OF THE INVENTION

It is therefore an object of the present invention to provide a biochemical analysis unit and a method for manufacturing the same which can prevent noise caused by the scattering of electron beams (β rays) released from a radioactive labeling substance from being generated in biochemical analysis data even in the case of forming in the biochemical analysis unit at a high density a plurality of spot-like regions of specific binding substances which can specifically bind with a substance derived from a living organism and whose sequence, base length, composition and the like are known, selectively labeling the plurality of spot-like regions with a radioactive labeling substance, thereby preparing the biochemical analysis unit, bringing the thus prepared biochemical analysis unit into close contact with a stimulable phosphor layer, exposing the stimulable phosphor layer to the radioactive labeling substance, irradiating the stimulable phosphor layer with a stimulating ray to excite the stimulable phosphor, photoelectrically detecting the stimulated emission released from the stimulable phosphor layer, and producing biochemical analysis data.

It is another object of the present invention to provide a biochemical analysis unit and a method for manufacturing the same which can prevent noise caused by the scattering of chemiluminescence emission released from a plurality of spot-like regions of a biochemical analysis unit from being generated in biochemical analysis data even in the case of forming in the biochemical analysis unit at a high density the plurality of spot-like regions containing specific binding substances which can specifically bind with a substance derived from a living organism and whose sequence, base length, composition and the like are known, selectively labeling the plurality of spot-like regions with a labeling substance which generates chemiluminescence emission when it contacts a chemiluminescent substrate, thereby preparing the biochemical analysis unit, bringing a chemiluminescent substrate into contact with the biochemical analysis unit, thereby causing the plurality of spot-like regions of the biochemical analysis unit to release chemiluminescence emission, holding the biochemical analysis unit formed with the plurality of spot-like regions which are selectively releasing chemiluminescence emission in close contact with a stimulable phosphor layer, exposing the stimulable phosphor layer to chemiluminescence emission, irradiating the stimulable phosphor layer with a stimulating ray, photoelectrically detecting stimulated emission released from the stimulable phosphor layer, and producing biochemical analysis data.

It is a further object of the present invention to provide a biochemical analysis unit and a method for manufacturing the same which can prevent noise caused by scattering chemiluminescence emission or fluorescence emission released from a plurality of spot-like regions of a biochemical analysis unit from being generated in biochemical analysis data even in the case of forming in the biochemical analysis unit at a high density the plurality of spot-like regions containing specific binding substances which can specifically bind with a substance derived from a living organism and whose sequence, base length, composition and the like are known, selectively labeling the plurality of spot-like regions with a labeling substance which generates chemiluminescence emission when it contacts a chemiluminescent substrate and/or a fluorescent substance, photoelectrically detecting chemiluminescence emission or fluorescence emission released from a plurality of spot-like regions of a biochemical analysis unit and producing biochemical analysis unit.

The above other objects of the present invention can be accomplished by a biochemical analysis unit comprising a plurality of absorptive regions two-dimensionally formed so as to be spaced apart from each other by weaving a plurality of light shielding strips made of a material capable of attenuating radiation energy and/or light energy and a plurality of absorptive strips made of an absorptive material so that the light shielding strip is present between neighboring absorptive regions.

In one mode of use of the biochemical analysis unit according to the present invention, in the case where the light shielding strips are made of a material capable of attenuating radiation energy, specific binding substances, which can specifically bind with a substance derived from a living organism and whose sequence, base length, composition and the like are known, are spotted and absorbed in the plurality of absorption regions formed so as to be spaced apart from each other in the biochemical analysis unit and a substance derived from a living organism and labeled with a radioactive substance is specifically bound, using a hybridization method or the like, with the specific binding substances absorbed in the plurality of absorptive regions, thereby selectively labeling the plurality of absorptive regions therewith. Next, a stimulable phosphor layer formed on a stimulable phosphor sheet is exposed to the radioactive labeling substance contained in the plurality of absorptive regions by facing the biochemical analysis unit toward the stimulable phosphor layer. Since the light shielding strip made of a material capable of attenuating radiation energy is present between neighboring absorptive regions, it is possible to effectively prevent electron beams (β rays) released from the radioactive labeling substance contained in the individual absorptive regions from scattering in the plurality of light shielding strips and to effectively prevent electron beams (β rays) scattered in the light shielding strips from entering a region of the stimulable phosphor layer to be exposed to a radioactive labeling substance contained in the neighboring absorptive regions. Therefore, when biochemical analysis data are produced by irradiating the stimulable phosphor layer exposed to a radioactive labeling substance with a stimulating ray for analyzing a substance derived from a living organism, it is possible to prevent noise caused by the scattering of electron beams (β rays) from being generated in the biochemical analysis data.

Further, in another mode of use of the biochemical analysis unit according to the present invention, in the case where the light shielding strips are made of a material capable of attenuating light energy, specific binding substances, which can specifically bind with a substance derived from a living organism and whose sequence, base length, composition and the like are known, are spotted and absorbed in the plurality of absorption regions formed so as to be spaced apart from each other in the biochemical analysis unit and a substance derived from a living organism and labeled with a labeling substance which generates chemiluminescence emission when it contacts a chemiluminescent substrate is specifically bound, using a hybridization method or the like, with the specific binding substances absorbed in the plurality of absorptive regions, thereby selectively labeling the plurality of absorptive regions therewith. Next, the biochemical analysis unit is brought into contact with a chemiluminescent substrate, thereby causing the plurality of absorptive regions to selectively release chemiluminescence emission and a stimulable phosphor layer formed on a stimulable phosphor sheet is exposed to chemiluminescence emission by facing the biochemical analysis unit formed with the plurality of absorptive regions which are selectively releasing chemiluminescence emission toward the stimulable phosphor layer. Since the light shielding strip made of a material capable of attenuating light energy is present between neighboring absorptive regions, it is possible to effectively prevent chemiluminescence emission from scattering in the plurality of light shielding strips and to effectively prevent chemiluminescence emission scattered in the light shielding strips from entering a region of the stimulable phosphor layer to be exposed to chemiluminescence emission released from the neighboring absorptive regions. Therefore, when biochemical analysis data are produced by irradiating the stimulable phosphor layer exposed to a radioactive labeling substance with a stimulating ray for analyzing a substance derived from a living organism, it is possible to prevent noise caused by the scattering of chemiluminescence emission from being generated in the biochemical analysis data.

Moreover, in a further mode of use of the biochemical analysis unit according to the present invention, in the case where the light shielding strips are made of a material capable of attenuating light energy, specific binding substances, which can specifically bind with a substance derived from a living organism and whose sequence, base length, composition and the like are known, are spotted and absorbed in the plurality of absorption regions formed so as to be spaced apart from each other in the biochemical analysis unit and a substance derived from a living organism and labeled with a labeling substance which generates chemiluminescence emission when it contacts a chemiluminescent substrate and/or a fluorescent substance is specifically bound, using a hybridization method or the like, with the specific binding substances absorbed in the plurality of absorptive regions, thereby selectively labeling the plurality of absorptive regions therewith. Next, the biochemical analysis unit is brought into contact with a chemiluminescent substrate, thereby causing the plurality of absorptive regions to selectively release chemiluminescence emission and chemiluminescence emission released from the absorptive regions is photoelectrically detected or the biochemical analysis unit is irradiated with a stimulating ray to excite the fluorescent substance and fluorescence emission released from the absorptive regions is photoelectrically detected, thereby producing biochemical analysis data. Since the light shielding strip made of a material capable of attenuating light energy is present between neighboring absorptive regions, it is possible to effectively prevent chemiluminescence emission or fluorescence emission from scattering in the plurality of light shielding strips and to effectively prevent chemiluminescence emission or fluorescence emission scattered in the light shielding strips from mixing with chemiluminescence emission or fluorescence emission released from the neighboring absorptive regions. Therefore, it is possible to prevent noise caused by the scattering of chemiluminescence emission or fluorescence emission from being generated in the biochemical analysis data produced by photoelectrically detecting chemiluminescence emission or fluorescence emission.

Further, according to the present invention, since a biochemical analysis unit can be produced only by weaving a plurality of light shielding strips and a plurality of absorptive strips so that a plurality of absorptive regions are two-dimensionally formed so as to be spaced apart from each other and the light shielding strip is present between neighboring absorptive regions, it is possible to easily manufacture a biochemical analysis unit in a desired manner using a textile technique.

The above and other objects of the present invention can be also accomplished by a biochemical analysis unit comprising a plurality of absorptive regions two-dimensionally formed so as to be spaced apart from each other by weaving a plurality of light shielding strips made of a material capable of attenuating radiation energy and/or light energy and a plurality of absorptive strips made of an absorptive material so that the light shielding strip is present between neighboring absorptive regions, the plurality of absorptive regions being selectively labeled with at least one kind of a labeling substance selected from a group consisting of a radioactive labeling substance, a labeling substance which generates chemiluminescence emission when it contacts a chemiluminescent substrate, and a fluorescent substance.

In the present invention, the case where a plurality of absorptive regions of the biochemical analysis unit are selectively labeled with a labeling substance which generates chemiluminescence emission when it contacts a chemiluminescent substrate as termed herein includes the case where a plurality of absorptive regions of the biochemical analysis unit are selectively labeled with a labeling substance which generates chemiluminescence emission when it contacts a chemiluminescent substrate by selectively binding a substance derived from a living organism and labeled with a labeling substance which generates chemiluminescence emission when it contacts a chemiluminescent substrate and the case where a plurality of absorptive regions of the biochemical analysis unit are selectively labeled with a labeling substance which generates chemiluminescence emission when it contacts a chemiluminescent substrate by selectively binding a substance derived from a living organism and labeled with a hapten, and binding an antibody for the hapten labeled with an enzyme which generates chemiluminescence emission when it contacts a chemiluminescent substrate with the hapten by an antigen-antibody reaction.

Further, in the present invention, the case where a plurality of absorptive regions of the biochemical analysis unit are selectively labeled with a fluorescent substance as termed herein includes the case where a plurality of absorptive regions of the biochemical analysis unit are selectively labeled with a fluorescent substance by selectively binding a substance derived from a living organism and labeled with a fluorescent substance with specific binding substances contained in the plurality of absorptive regions and the case where a plurality of absorptive regions of the biochemical analysis unit are selectively labeled with a fluorescent substance by selectively binding a substance derived from a living organism and labeled with a hapten, binding an antibody for the hapten labeled with an enzyme which generates a fluorescent substance when it contacts a fluorescent substrate with the hapten by an antigen-antibody reaction, and causing the enzyme bound with the hapten to come into contact with the fluorescent substrate to generate a fluorescent substance.

In the present invention, illustrative examples of the combination of hapten and antibody include digoxigenin and anti-digoxigenin antibody, theophylline and anti-theophylline antibody, fluorosein and anti-fluorosein antibody, and the like. Further, the combination of biotin and avidin, antigen and antibody may be utilized instead of the combination of hapten and antibody.

In one mode of use of the biochemical analysis unit according to the present invention, in the case where the light shielding strips are made of a material capable of attenuating radiation energy and the plurality of absorptive regions two-dimensionally formed so as to be spaced from each other in the biochemical analysis unit are selectively labeled with a radioactive labeling substance by spotting specific binding substances whose sequence, base length, composition and the like are known in the plurality of absorptive regions and specifically binding a substance derived from a living organism and labeled with the radioactive labeling substance, when a stimulable phosphor layer formed in the stimulable phosphor sheet is exposed to the radioactive labeling substance contained in the absorptive regions by facing the biochemical analysis unit toward the stimulable phosphor layer, since the light shielding strip made of a material capable of attenuating light energy is present between neighboring absorptive regions, it is possible to effectively prevent electron beams (β rays) released from the radioactive labeling substance contained in the individual absorptive regions from scattering in the plurality of light shielding strips and to effectively prevent electron beams (β rays) scattered in the light shielding strips from entering a region of the stimulable phosphor layer to be exposed to a radioactive labeling substance contained in the neighboring absorptive regions. Therefore, when biochemical analysis data are produced by irradiating the stimulable phosphor layer exposed to a radioactive labeling substance with a stimulating ray for analyzing a substance derived from a living organism, it is possible to prevent noise caused by the scattering of electron beams (β rays) from being generated in the biochemical analysis data.

Further, in another mode of use of the biochemical analysis unit according to the present invention, in the case where the light shielding strips are made of a material capable of attenuating light energy and the plurality of absorptive regions two-dimensionally formed so as to be spaced from each other in the biochemical analysis unit are selectively labeled with a labeling substance which generates chemiluminescence emission when it contacts a chemiluminescent substrate by spotting specific binding substances whose sequence, base length, composition and the like are known in the plurality of absorptive regions and specifically binding a substance derived from a living organism and labeled with the labeling substance which generates chemiluminescence emission when it contacts a chemiluminescent substrate, when the biochemical analysis unit is brought into contact with a chemiluminescent substrate, thereby causing the plurality of absorptive regions to selectively release chemiluminescence emission and a stimulable phosphor layer formed on a stimulable phosphor sheet is exposed to chemiluminescence emission by facing the biochemical analysis unit formed with the plurality of absorptive regions which are selectively releasing chemiluminescence emission toward the stimulable phosphor layer, since the light shielding strip made of a material capable of attenuating light energy is present between neighboring absorptive regions, it is possible to effectively prevent chemiluminescence emission from scattering in the plurality of light shielding strips and to effectively prevent chemiluminescence emission scattered in the light shielding strips from entering a region of the stimulable phosphor layer to be exposed to chemiluminescence emission released from the neighboring absorptive regions. Therefore, when biochemical analysis data are produced by irradiating the stimulable phosphor layer exposed to a radioactive labeling substance with a stimulating ray for analyzing a substance derived from a living organism, it is possible to prevent noise caused by the scattering of chemiluminescence emission from being generated in the biochemical analysis data.

Moreover, in a further mode of use of the biochemical analysis unit according to the present invention, in the case where the light shielding strips are made of a material capable of attenuating light energy and the plurality of absorptive regions two-dimensionally formed so as to be spaced from each other in the biochemical analysis unit are selectively labeled with a labeling substance which generates chemiluminescence emission when it contacts a chemiluminescent substrate and/or a fluorescent substance by spotting specific binding substances whose sequence, base length, composition and the like are known in the plurality of absorptive regions and specifically binding a substance derived from a living organism and labeled with the labeling substance which generates chemiluminescence emission when it contacts a chemiluminescent substrate and/or a fluorescent substance, when the biochemical analysis unit is brought into contact with a chemiluminescent substrate, thereby causing the plurality of absorptive regions to selectively release chemiluminescence emission and chemiluminescence emission released from the absorptive regions is photoelectrically detected or the biochemical analysis unit is irradiated with a stimulating ray to excite the fluorescent substance and fluorescence emission released from the absorptive regions is photoelectrically detected, thereby producing biochemical analysis data, since the light shielding strip made of a material capable of attenuating light energy is present between neighboring absorptive regions, it is possible to effectively prevent chemiluminescence emission or fluorescence emission from scattering in the plurality of light shielding strips and to effectively prevent chemiluminescence emission or fluorescence emission scattered in the light shielding strips from mixing with chemiluminescence emission or fluorescence emission released from the neighboring absorptive regions. Therefore, it is possible to prevent noise caused by the scattering of chemiluminescence emission or fluorescence emission from being generated in the biochemical analysis data produced by photoelectrically detecting chemiluminescence emission or fluorescence emission.

Further, according to the present invention, since a biochemical analysis unit can be produced only by weaving a plurality of light shielding strips and a plurality of absorptive strips so that a plurality of absorptive regions are two-dimensionally formed so as to be spaced apart from each other and the light shielding strip is present between neighboring absorptive regions, it is possible to easily manufacture a biochemical analysis unit in a desired manner using a textile technique.

In a preferred aspect of the present invention, the plurality of absorptive regions are selectively labeled with at least one kind of a labeling substance selected from a group consisting of a radioactive labeling substance, a labeling substance which generates chemiluminescence emission when it contacts a chemiluminescent substrate, and a fluorescent substance by spotting specific binding substances whose sequence, base length, composition and the like are known in the plurality of absorptive regions and specifically binding a substance derived from a living organism and labeled with at least one kind of a labeling substance selected from a group consisting of a radioactive labeling substance, a labeling substance which generates chemiluminescence emission when it contacts a chemiluminescent substrate, and a fluorescent substance.

The above and other objects of the present invention can be also accomplished by a method for manufacturing a biochemical analysis unit comprising the step of weaving a plurality of light shielding strips made of a material capable of attenuating radiation energy and/or light energy and a plurality of absorptive strips made of an absorptive material in such a manner that the plurality of light shielding strips and the plurality of absorptive strips extend in a first direction so that at least one light shielding strip is present between neighboring absorptive strips and that the plurality of light shielding strips extend in a second direction perpendicular to the first direction, thereby forming a plurality of absorptive regions so as to be two-dimensionally spaced apart from each other.

According to the present invention, since a biochemical analysis unit manufactured by weaving a plurality of light shielding strips made of a material capable of attenuating radiation energy and/or light energy and a plurality of absorptive strips made of an absorptive material in such a manner that the plurality of light shielding strips and the plurality of absorptive strips extend in a first direction so that at least one light shielding strip is present between neighboring absorptive strips and that the plurality of light shielding strips extend in a second direction perpendicular to the first direction, thereby forming a plurality of absorptive regions so as to be two-dimensionally spaced apart from each other, it is possible to easily manufacture a biochemical analysis unit in a desired manner using a textile technique.

The above and other objects of the present invention can be also accomplished by a method for manufacturing a biochemical analysis unit comprising the steps of weaving a plurality of light shielding strips made of a material capable of attenuating radiation energy and/or light energy and a plurality of absorptive strips made of an absorptive material in such a manner that the plurality of light shielding strips and the plurality of absorptive strips extend in a first direction so that at least one light shielding strip is present between neighboring absorptive strips and that the plurality of light shielding strips extend in a second direction perpendicular to the first direction, thereby forming a plurality of absorptive regions so as to be two-dimensionally spaced apart from each other, and selectively labeling the plurality of absorptive regions with at least one kind of a labeling substance selected from a group consisting of a radioactive labeling substance, a labeling substance which generates chemiluminescence emission when it contacts a chemiluminescent substrate, and a fluorescent substance.

According to the present invention, since a biochemical analysis unit is manufactured by weaving a plurality of light shielding strips made of a material capable of attenuating radiation energy and/or light energy and a plurality of absorptive strips made of an absorptive material in such a manner that the plurality of light shielding strips and the plurality of absorptive strips extend in a first direction so that at least one light shielding strip is present between neighboring absorptive strips and that the plurality of light shielding strips extend in a second direction perpendicular to the first direction, thereby forming a plurality of absorptive regions so as to be two-dimensionally spaced apart from each other, and selectively labeling the plurality of absorptive regions with at least one kind of a labeling substance selected from a group consisting of a radioactive labeling substance, a labeling substance which generates chemiluminescence emission when it contacts a chemiluminescent substrate, and a fluorescent substance, it is possible to easily manufacture a biochemical analysis unit in a desired manner using a textile technique.

In a preferred aspect of the present invention, the plurality of absorptive regions are selectively labeled with at least one kind of a labeling substance selected from a group consisting of a radioactive labeling substance, a labeling substance which generates chemiluminescence emission when it contacts a chemiluminescent substrate, and a fluorescent substance by spotting specific binding substances whose sequence, base length, composition and the like are known in the plurality of absorptive regions and specifically binding a substance derived from a living organism and labeled with at least one kind of a labeling substance selected from a group consisting of a radioactive labeling substance, a labeling substance which generates chemiluminescence emission when it contacts a chemiluminescent substrate, and a fluorescent substance.

In the present invention, a material capable of forming filament, a porous material capable of forming a membrane filter or a fiber material may be preferably used as the absorptive material for forming the absorptive strips of the biochemical analysis unit. The absorptive strips may be formed by combining a porous material and a fiber material.

In the present invention, a porous material for forming the absorptive strips of the biochemical analysis unit may be any type of an organic material or an inorganic material and may be an organic/inorganic composite material.

In the present invention, an organic porous material used for forming the absorptive strips of the biochemical analysis unit is not particularly limited but a carbon porous material such as an activated carbon or a porous material capable of forming a membrane filter is preferably used. Illustrative examples of porous materials capable of forming a membrane filter include nylons such as nylon-6, nylon-6,6, nylon-4,10; cellulose derivatives such as nitrocellulose, acetyl cellulose, butyric-acetyl cellulose; collagen; alginic acids such as alginic acid, calcium alginate, alginic acid/poly-L-lysine polyionic complex; polyolefins such as polyethylene, polypropylene; polyvinyl chloride; polyvinylidene chloride; polyfluoride such as polyvinylidene fluoride, polytetrafluoride; and copolymers or composite materials thereof.

In the present invention, an inorganic porous material used for forming the absorptive strips of the biochemical analysis unit is not particularly limited. Illustrative examples of inorganic porous materials preferably usable in the present invention include metals such as platinum, gold, iron, silver, nickel, aluminum and the like; metal oxides such as alumina, silica, titania, zeolite and the like; metal salts such as hydroxy apatite, calcium sulfate and the like; and composite materials thereof.

In the present invention, a fiber material used for forming the absorptive strips of the biochemical analysis unit is not particularly limited. Illustrative examples of fiber materials preferably usable in the present invention include nylons such as nylon-6, nylon-6,6, nylon-4,10; and cellulose derivatives such as nitrocellulose, acetyl cellulose, butyricacetyl cellulose.

In the present invention, the absorptive regions of the biochemical analysis unit may be formed using an oxidization process such as an electrolytic process, a plasma process, an arc discharge process or the like; a primer process using a silane coupling agent, titanium coupling agent or the like; and a surface-active agent process or the like. It is most preferable for the surface of the absorptive region to have a fractal structure.

In a preferred aspect of the present invention, the absorptive strips of the biochemical analysis unit are formed of an absorptive material comprising a plurality of bundles of fiber material or a porous material. In the present invention, an absorptive material comprising a porous material as termed herein includes a fabric formed of a porous material itself or a compound containing 0.01% to 99.9% of a porous material.

The above and other objects of the present invention can also be accomplished by a biochemical analysis unit comprising a plurality of absorptive regions two-dimensionally formed so as to be spaced apart from each other by weaving a plurality of sheets made of a material capable of attenuating radiation energy and/or light energy, each of which is formed with an absorptive stripe formed by roughening it in a longitudinal direction on the surface thereof, a plurality of light shielding strips made of a material capable of attenuating radiation energy and/or light energy and a plurality of light shielding sheets made of a material capable of attenuating radiation energy and/or light energy so that the light shielding sheet or a portion of the sheet where no absorptive stripe is formed is present between neighboring absorptive regions.

In one mode of use of the biochemical analysis unit according to the present invention, in the case where the sheets, the light shielding sheets and the light shielding strips are made of a material capable of attenuating radiation energy, specific binding substances, which can specifically bind with a substance derived from a living organism and whose sequence, base length, composition and the like are known, are spotted and absorbed in the plurality of absorption regions formed so as to be spaced apart from each other in the biochemical analysis unit and a substance derived from a living organism and labeled with a radioactive substance is specifically bound, using a hybridization method or the like, with the specific binding substances absorbed in the plurality of absorptive regions, thereby selectively labeling the plurality of absorptive regions therewith. Next, a stimulable phosphor layer formed on a stimulable phosphor sheet is exposed to the radioactive labeling substance contained in the plurality of absorptive regions by facing the biochemical analysis unit toward the stimulable phosphor layer. Since the sheets, the light shielding sheets and the light shielding strips are made of a material capable of attenuating radiation energy, it is possible to effectively prevent electron beams (β rays) released from the radioactive labeling substance contained in the individual absorptive regions from scattering in the sheets, the light shielding sheets or the light shielding strips and to effectively prevent the thus scattered electron beams (β rays) from entering a region of the stimulable phosphor layer to be exposed to a radioactive labeling substance contained in the neighboring absorptive regions. Therefore, when biochemical analysis data are produced by irradiating the stimulable phosphor layer exposed to a radioactive labeling substance with a stimulating ray for analyzing a substance derived from a living organism, it is possible to prevent noise caused by the scattering of electron beams (β rays) from being generated in the biochemical analysis data.

Further, in another mode of use of the biochemical analysis unit according to the present invention, in the case where the sheets, the light shielding sheets and the light shielding strips are made of a material capable of attenuating light energy, specific binding substances, which can specifically bind with a substance derived from a living organism and whose sequence, base length, composition and the like are known, are spotted and absorbed in the plurality of absorption regions formed so as to be spaced apart from each other in the biochemical analysis unit and a substance derived from a living organism and labeled with a labeling substance which generates chemiluminescence emission when it contacts a chemiluminescent substrate is specifically bound, using a hybridization method or the like, with the specific binding substances absorbed in the plurality of absorptive regions, thereby selectively labeling the plurality of absorptive regions therewith. Next, the biochemical analysis unit is brought into contact with a chemiluminescent substrate, thereby causing the plurality of absorptive regions to selectively release chemiluminescence emission and a stimulable phosphor layer formed on a stimulable phosphor sheet is exposed to chemiluminescence emission by facing the biochemical analysis unit formed with the plurality of absorptive regions which are selectively releasing chemiluminescence emission toward the stimulable phosphor layer. Since the sheets, the light shielding sheets and the light shielding strips are made of a material capable of attenuating light energy, it is possible to effectively prevent chemiluminescence emission from scattering in the sheets, the light shielding sheets or the light shielding strips and to effectively prevent the thus scattered chemiluminescence emission from entering a region of the stimulable phosphor layer to be exposed to chemiluminescence emission released from the neighboring absorptive regions. Therefore, when biochemical analysis data are produced by irradiating the stimulable phosphor layer exposed to a radioactive labeling substance with a stimulating ray for analyzing a substance derived from a living organism, it is possible to prevent noise caused by the scattering of chemiluminescence emission from being generated in the biochemical analysis data.

Moreover, in a further mode of use of the biochemical analysis unit according to the present invention, in the case where the sheets, the light shielding sheets and the light shielding strips are made of a material capable of attenuating radiation energy, specific binding substances, which can specifically bind with a substance derived from a living organism and whose sequence, base length, composition and the like are known, are spotted and absorbed in the plurality of absorption regions formed so as to be spaced apart from each other in the biochemical analysis unit and a substance derived from a living organism and labeled with a labeling substance which generates chemiluminescence emission when it contacts a chemiluminescent substrate and/or a fluorescent substance is specifically bound, using a hybridization method or the like, with the specific binding substances absorbed in the plurality of absorptive regions, thereby selectively labeling the plurality of absorptive regions therewith. Next, the biochemical analysis unit is brought into contact with a chemiluminescent substrate, thereby causing the plurality of absorptive regions to selectively release chemiluminescence emission and chemiluminescence emission released from the absorptive regions is photoelectrically detected or the biochemical analysis unit is irradiated with a stimulating ray to excite the fluorescent substance and fluorescence emission released from the absorptive regions is photoelectrically detected, thereby producing biochemical analysis data. Since the sheets, the light shielding sheets and the light shielding strips are made of a material capable of attenuating light energy, it is possible to effectively prevent chemiluminescence emission or fluorescence emission from scattering in the sheets, the light shielding sheets or the light shielding strips and to effectively prevent the thus scattered chemiluminescence emission or fluorescence emission from mixing with chemiluminescence emission or fluorescence emission released from the neighboring absorptive regions. Therefore, it is possible to prevent noise caused by the scattering of chemiluminescence emission or fluorescence emission from being generated in the biochemical analysis data produced by photoelectrically detecting chemiluminescence emission or fluorescence emission.

Further, according to the present invention, since a biochemical analysis unit can be produced only by weaving a plurality of sheets, each of which is formed with an absorptive stripe on the surface thereof, a plurality of light shielding strips and a plurality of light shielding sheets so that the light shielding sheet or a portion of the sheet where no absorptive stripe is formed is present between neighboring absorptive regions, it is possible to easily manufacture a biochemical analysis unit in a desired manner using a textile technique.

The above and other objects of the present invention can be also accomplished by a biochemical analysis unit comprising a plurality of absorptive regions two-dimensionally formed so as to be spaced apart from each other by weaving a plurality of sheets made of a material capable of attenuating radiation energy and/or light energy, each of which is formed with an absorptive stripe formed by roughening it in a longitudinal direction on the surface thereof, a plurality of light shielding strips made of a material capable of attenuating radiation energy and/or light energy and a plurality of light shielding sheets made of a material capable of attenuating radiation energy and/or light energy so that the light shielding sheet or a portion of the sheet where no absorptive stripe is formed is present between neighboring absorptive regions, the plurality of absorptive regions being selectively labeled with at least one kind of a labeling substance selected from a group consisting of a radioactive labeling substance, a labeling substance which generates chemiluminescence emission when it contacts a chemiluminescent substrate, and a fluorescent substance.

In one mode of use of the biochemical analysis unit according to the present invention, in the case where the sheets, the light shielding sheets and the light shielding strips are made of a material capable of attenuating radiation energy and the plurality of absorptive regions two-dimensionally formed so as to be spaced from each other in the biochemical analysis unit are selectively labeled with a radioactive labeling substance by spotting specific binding substances whose sequence, base length, composition and the like are known in the plurality of absorptive regions and specifically binding a substance derived from a living organism and labeled with the radioactive labeling substance, when a stimulable phosphor layer formed in the stimulable phosphor sheet is exposed to the radioactive labeling substance contained in the absorptive regions by facing the biochemical analysis unit toward the stimulable phosphor layer, since the sheets, the light shielding sheets and the light shielding strips are made of a material capable of attenuating radiation energy, it is possible to effectively prevent electron beams (β rays) released from the radioactive labeling substance contained in the individual absorptive regions from scattering in the sheets, the light shielding sheets or the light shielding strips and to effectively prevent the thus scattered electron beams (β rays) from entering a region of the stimulable phosphor layer to be exposed to a radioactive labeling substance contained in the neighboring absorptive regions. Therefore, when biochemical analysis data are produced by irradiating the stimulable phosphor layer exposed to a radioactive labeling substance with a stimulating ray for analyzing a substance derived from a living organism, it is possible to prevent noise caused by the scattering of electron beams (β rays) from being generated in the biochemical analysis data.

Further, in another mode of use of the biochemical analysis unit according to the present invention, in the case where the sheets, the light shielding sheets and the light shielding strips are made of a material capable of attenuating light energy and the plurality of absorptive regions two-dimensionally formed so as to be spaced from each other in the biochemical analysis unit are selectively labeled with a labeling substance which generates chemiluminescence emission when it contacts a chemiluminescent substrate by spotting specific binding substances whose sequence, base length, composition and the like are known in the plurality of absorptive regions and specifically binding a substance derived from a living organism and labeled with the labeling substance which generates chemiluminescence emission when it contacts a chemiluminescent substrate, when the biochemical analysis unit is brought into contact with a chemiluminescent substrate, thereby causing the plurality of absorptive regions to selectively release chemiluminescence emission and a stimulable phosphor layer formed on a stimulable phosphor sheet is exposed to chemiluminescence emission by facing the biochemical analysis unit formed with the plurality of absorptive regions which are selectively releasing chemiluminescence emission toward the stimulable phosphor layer, since the sheets, the light shielding sheets and the light shielding strips are made of a material capable of attenuating light energy, it is possible to effectively prevent chemiluminescence emission from scattering in the sheets, the light shielding sheets or the light shielding strips and to effectively prevent the thus scattered chemiluminescence emission from entering a region of the stimulable phosphor layer to be exposed to chemiluminescence emission released from the neighboring absorptive regions. Therefore, when biochemical analysis data are produced by irradiating the stimulable phosphor layer exposed to a radioactive labeling substance with a stimulating ray for analyzing a substance derived from a living organism, it is possible to prevent noise caused by the scattering of chemiluminescence emission from being generated in the biochemical analysis data.

Moreover, in a further mode of use of the biochemical analysis unit according to the present invention, in the case where the sheets, the light shielding sheets and the light shielding strips are made of a material capable of attenuating light energy and the plurality of absorptive regions two-dimensionally formed so as to be spaced from each other in the biochemical analysis unit are selectively labeled with a labeling substance which generates chemiluminescence emission when it contacts a chemiluminescent substrate and/or a fluorescent substance by spotting specific binding substances whose sequence, base length, composition and the like are known in the plurality of absorptive regions and specifically binding a substance derived from a living organism and labeled with the labeling substance which generates chemiluminescence emission when it contacts a chemiluminescent substrate and/or a fluorescent substance, when the biochemical analysis unit is brought into contact with a chemiluminescent substrate, thereby causing the plurality of absorptive regions to selectively release chemiluminescence emission and chemiluminescence emission released from the absorptive regions is photoelectrically detected or the biochemical analysis unit is irradiated with a stimulating ray to excite the fluorescent substance and fluorescence emission released from the absorptive regions is photoelectrically detected, thereby producing biochemical analysis data, since the sheets, the light shielding sheets and the light shielding strips are made of a material capable of attenuating light energy, it is possible to effectively prevent chemiluminescence emission or fluorescence emission from scattering in the sheets, the light shielding sheets or the light shielding strips and to effectively prevent the thus scattered chemiluminescence emission or fluorescence emission from mixing with chemiluminescence emission or fluorescence emission released from the neighboring absorptive regions. Therefore, it is possible to prevent noise caused by the scattering of chemiluminescence emission or fluorescence emission from being generated in the biochemical analysis data produced by photoelectrically detecting chemiluminescence emission or fluorescence emission.

Further, according to the present invention, since a biochemical analysis unit can be produced only by weaving a plurality of sheets, each of which is formed with an absorptive stripe on the surface thereof, a plurality of light shielding strips and a plurality of light shielding sheets so that the light shielding sheet or a portion of the sheet where no absorptive stripe is formed is present between neighboring absorptive regions, it is possible to easily manufacture a biochemical analysis unit in a desired manner using a textile technique.

In a preferred aspect of the present invention, the plurality of absorptive regions are selectively labeled with at least one kind of a labeling substance selected from a group consisting of a radioactive labeling substance, a labeling substance which generates chemiluminescence emission when it contacts a chemiluminescent substrate, and a fluorescent substance by spotting specific binding substances whose sequence, base length, composition and the like are known in the plurality of absorptive regions and specifically binding a substance derived from a living organism and labeled with at least one kind of a labeling substance selected from a group consisting of a radioactive labeling substance, a labeling substance which generates chemiluminescence emission when it contacts a chemiluminescent substrate, and a fluorescent substance.

The above and other objects of the present invention can be also accomplished by a method for producing a biochemical analysis unit comprising a step of weaving a plurality of sheets made of a material capable of attenuating radiation energy and/or light energy, each of which is formed with an absorptive stripe formed by roughening it in a longitudinal direction on the surface thereof, a plurality of light shielding strips made of a material capable of attenuating radiation energy and/or light energy and a plurality of light shielding sheets made of a material capable of attenuating radiation energy and/or light energy in such a manner that the absorptive stripes of the plurality of sheets are located below the light shielding sheets and above the light shielding strips, thereby two-dimensionally forming a plurality of absorptive regions so as to be spaced apart from each other.

According to the present invention, since a biochemical analysis unit can be produced by weaving a plurality of sheets, each of which is formed with an absorptive stripe formed by roughening it in a longitudinal direction on the surface thereof, a plurality of light shielding strips and a plurality of light shielding sheets in such a manner that the absorptive stripes of the plurality of sheets are located below the light shielding sheets and above the light shielding strips, thereby two-dimensionally forming a plurality of absorptive regions so as to be spaced apart from each other, it is possible to easily manufacture a biochemical analysis unit in a desired manner using a textile technique.

The above and other objects of the present invention can be also accomplished by a method for producing a biochemical analysis unit comprising the steps of weaving a plurality of sheets made of a material capable of attenuating radiation energy and/or light energy, each of which is formed with an absorptive stripe formed by roughening it in a longitudinal direction on the surface thereof, a plurality of light shielding strips made of a material capable of attenuating radiation energy and/or light energy and a plurality of light shielding sheets made of a material capable of attenuating radiation energy and/or light energy in such a manner that the absorptive stripes of the plurality of sheets are located below the light shielding sheets and above the light shielding strips, thereby two-dimensionally forming a plurality of absorptive regions so as to be spaced apart from each other, and selectively labeling the plurality of absorptive regions with at least one kind of a labeling substance selected from a group consisting of a radioactive labeling substance, a labeling substance which generates chemiluminescence emission when it contacts a chemiluminescent substrate, and a fluorescent substance.

According to the present invention, since a biochemical analysis unit can be produced by weaving a plurality of sheets made of a material capable of attenuating radiation energy and/or light energy, each of which is formed with an absorptive stripe formed by roughening it in a longitudinal direction on the surface thereof, a plurality of light shielding strips made of a material capable of attenuating radiation energy and/or light energy and a plurality of light shielding sheets made of a material capable of attenuating radiation energy and/or light energy in such a manner that the absorptive stripes of the plurality of sheets are located below the light shielding sheets and above the light shielding strips, thereby two-dimensionally forming a plurality of absorptive regions so as to be spaced apart from each other, and selectively labeling the plurality of absorptive regions with at least one kind of a labeling substance selected from a group consisting of a radioactive labeling substance, a labeling substance which generates chemiluminescence emission when it contacts a chemiluminescent substrate, and a fluorescent substance, it is possible to easily manufacture a biochemical analysis unit in a desired manner using a textile technique.

In a preferred aspect of the present invention, the plurality of absorptive regions are selectively labeled with at least one kind of a labeling substance selected from a group consisting of a radioactive labeling substance, a labeling substance which generates chemiluminescence emission when it contacts a chemiluminescent substrate, and a fluorescent substance by spotting specific binding substances whose sequence, base length, composition and the like are known in the plurality of absorptive regions and specifically binding a substance derived from a living organism and labeled with at least one kind of a labeling substance selected from a group consisting of a radioactive labeling substance, a labeling substance which generates chemiluminescence emission when it contacts a chemiluminescent substrate, and a fluorescent substance.

In a preferred aspect of the present invention, the surface of the absorptive stripe is roughened so as to have a fractal structure.

According to this preferred aspect of the present invention, since the surface of the absorptive stripe is roughened so as to have a fractal structure, each of the absorptive regions has a hundred times or more the absorptive surface area of that having a smooth surface and it is therefore possible for each of the absorptive regions to absorb a sufficient amount of a specific binding substance.

In a preferred aspect of the present invention, the substance derived from a living organism is specifically bound with specific binding substances by a reaction selected from a group consisting of hybridization, antigen-antibody reaction and receptor-ligand reaction.

In a preferred aspect of the present invention, the material capable of attenuating radiation energy has a property of reducing the energy of radiation to ⅕ or less when the radiation travels in the material by a distance equal to that between neighboring absorptive regions.

In a further preferred aspect of the present invention, the material capable of attenuating radiation energy has a property of reducing the energy of radiation to 1/10 or less when the radiation travels in the material by a distance equal to that between neighboring absorptive regions.

In a further preferred aspect of the present invention, the material capable of attenuating radiation energy has a property of reducing the energy of radiation to 1/50 or less when the radiation travels in the material by a distance equal to that between neighboring absorptive regions.

In a further preferred aspect of the present invention, the material capable of attenuating radiation energy has a property of reducing the energy of radiation to 1/100 or less when the radiation travels in the material by a distance equal to that between neighboring absorptive regions.

In a further preferred aspect of the present invention, the material capable of attenuating radiation energy has a property of reducing the energy of radiation to 1/500 or less when the radiation travels in the material by a distance equal to that between neighboring absorptive regions.

In a further preferred aspect of the present invention, the material capable of attenuating radiation energy has a property of reducing the energy of radiation to 1/1,000 or less when the radiation travels in the material by a distance equal to that between neighboring absorptive regions.

In a preferred aspect of the present invention, the material capable of attenuating light energy has a property of reducing the energy of light to ⅕ or less when the light travels in the material by a distance equal to that between neighboring absorptive regions.

In a further preferred aspect of the present invention, the material capable of attenuating light energy has a property of reducing the energy of light to 1/10 or less when the light travels in the material by a distance equal to that between neighboring absorptive regions.

In a further preferred aspect of the present invention, the material capable of attenuating light energy has a property of reducing the energy of light to 1/50 or less when the light travels in the material by a distance equal to that between neighboring absorptive regions.

In a further preferred aspect of the present invention, the material capable of attenuating light energy has a property of reducing the energy of light to 1/100 or less when the light travels in the material by a distance equal to that between neighboring absorptive regions.

In a further preferred aspect of the present invention, the material capable of attenuating light energy has a property of reducing the energy of light to 1/500 or less when the light travels in the material by a distance equal to that between neighboring absorptive regions.

In a further preferred aspect of the present invention, the material capable of attenuating light energy has a property of reducing the energy of light to 1/1,000 or less when the light travels in the material by a distance equal to that between neighboring absorptive regions.

The material capable of attenuating radiation energy and/or light energy and usable in the present invention is not particularly limited but may be any type of inorganic compound material or organic compound material. The material capable of attenuating radiation energy and/or light energy may be preferably a metal material, a ceramic material or a plastic material.

Illustrative examples of inorganic compound materials preferably usable in the present invention and capable of attenuating radiation energy and/or light energy include metals such as gold, silver, copper, zinc, aluminum, titanium, tantalum, chromium, iron, nickel, cobalt, lead, tin, selenium and the like; alloys such as brass, stainless steel, bronze and the like; silicon materials such as silicon, amorphous silicon, glass, quartz, silicon carbide, silicon nitride and the like; metal oxides such as aluminum oxide, magnesium oxide, zirconium oxide and the like; and inorganic salts such as tungsten carbide, calcium carbide, calcium sulfate, hydroxy apatite, gallium arsenide and the like. These may have either a monocrystal structure or a polycrystal sintered structure such as amorphous, ceramic or the like.

In the present invention, a high molecular compound is preferably used as an organic compound material as a material capable of attenuating radiation energy and/or light energy. Illustrative examples of high molecular compounds preferably usable in the present invention include polyolefins such as polyethylene, polypropylene and the like; acrylic resins such as polymethyl methacrylate, polybutylacrylate/polymethyl methacrylate copolymer and the like; polyacrylonitrile; polyvinyl chloride; polyvinylidene chloride; polyvinylidene fluoride; polytetrafluoroethylene; polychlorotrifuluoroethylene; polycarbonate; polyesters such as polyethylene naphthalate, polyethylene terephthalate and the like; nylons such as nylon-6, nylon-6,6, nylon-4,10 and the like; polyimide; polysulfone; polyphenylene sulfide; silicon resins such as polydiphenyl siloxane and the like; phenol resins such as novolac and the like; epoxy resin; polyurethane; polystyrene, butadiene-styrene copolymer; polysaccharides such as cellulose, acetyl cellulose, nitrocellulose, starch, calcium alginate, hydroxypropyl methyl cellulose and the like; chitin; chitosan; urushi (Japanese lacquer); polyamides such as gelatin, collagen, keratin and the like; and copolymers of these high molecular materials. These may be a composite compound, and metal oxide particles, glass fiber or the like may be added thereto as occasion demands. Further, an organic compound material may be blended therewith.

Since the capability of attenuating radiation energy generally increases as specific gravity increases, it is preferable to employ a compound material or a composite material having specific gravity of 1.0 g/cm³ or more as a material capable of attenuating radiation energy and it is more preferable to employ a compound material or a composite material having specific gravity of 1.5 g/cm³ to 23 g/cm³ as a material capable of attenuating radiation energy.

Since the capability of attenuating light energy generally increases as scattering and/or absorption of light increases, it is preferable to employ a material having absorbance of 0.3 per cm (thickness) or more as a material capable of attenuation light energy and more preferably, a material having absorbance of 1 per cm (thickness) or more is employed. The absorbance can be determined by placing an integrating sphere immediately behind a plate-like member having a thickness of T cm, measuring an amount A of transmitted light at a wavelength of probe light or emission light used for measurement by a spectrophotometer, and calculating A/T. In the present invention, a light scattering substance or a light absorbing substance may be added to the material capable of attenuating light energy in order to improve the capability of attenuating light energy.

In a preferred aspect of the present invention, the biochemical analysis unit is formed with 10 or more absorptive regions.

In a further preferred aspect of the present invention, the biochemical analysis unit is formed with 50 or more absorptive regions.

In a further preferred aspect of the present invention, the biochemical analysis unit is formed with 100 or more absorptive regions.

In a further preferred aspect of the present invention, the biochemical analysis unit is formed with 500 or more absorptive regions.

In a further preferred aspect of the present invention, the biochemical analysis unit is formed with 1,000 or more absorptive regions.

In a further preferred aspect of the present invention, the biochemical analysis unit is formed with 5,000 or more absorptive regions.

In a further preferred aspect of the present invention, the biochemical analysis unit is formed with 10,000 or more absorptive regions.

In a further preferred aspect of the present invention, the biochemical analysis unit is formed with 50,000 or more absorptive regions.

In a further preferred aspect of the present invention, the biochemical analysis unit is formed with 100,000 or more absorptive regions.

In a preferred aspect of the present invention, each of the plurality of absorptive regions formed in the biochemical analysis unit has a size of less than 5 mm².

In a further preferred aspect of the present invention, each of the plurality of absorptive regions formed in the biochemical analysis unit has a size of less than 1 mm².

In a further preferred aspect of the present invention, each of the plurality of absorptive regions formed in the biochemical analysis unit has a size of less than 0.5 mm².

In a further preferred aspect of the present invention, each of the plurality of absorptive regions formed in the biochemical analysis unit has a size of less than 0.1 mm².

In a further preferred aspect of the present invention, each of the plurality of absorptive regions formed in the biochemical analysis unit has a size of less than 0.05 mm².

In a further preferred aspect of the present invention, each of the plurality of absorptive regions formed in the biochemical analysis unit has a size of less than 0.01 mm².

In the present invention, the density of the absorptive regions formed in the biochemical analysis unit is determined depending upon the kind of the material capable of attenuating radiation energy and/or light energy to be employed, the kind of electron beam released from a radioactive substance or the like.

In a preferred aspect of the present invention, the plurality of absorptive regions are formed in the biochemical analysis unit at a density of 10 or more per cm².

In a further preferred aspect of the present invention, the plurality of absorptive regions are formed in the biochemical analysis unit at a density of 50 or more per cm².

In a further preferred aspect of the present invention, the plurality of absorptive regions are formed in the biochemical analysis unit at a density of 100 or more per cm².

In a further preferred aspect of the present invention, the plurality of absorptive regions are formed in the biochemical analysis unit at a density of 500 or more per cm².

In a further preferred aspect of the present invention, the plurality of absorptive regions are formed in the biochemical analysis unit at a density of 1,000 or more per cm².

In a further preferred aspect of the present invention, the plurality of absorptive regions are formed in the biochemical analysis unit at a density of 5,000 or more per cm².

In a further preferred aspect of the present invention, the plurality of absorptive regions are formed in the biochemical analysis unit at a density of 10,000 or more per cm².

In a further preferred aspect of the present invention, the plurality of absorptive regions are formed in the biochemical analysis unit at a density of 50,000 or more per cm².

In a further preferred aspect of the present invention, the plurality of absorptive regions are formed in the biochemical analysis unit at a density of 100,000 or more per cm².

In the present invention, the stimulable phosphor usable for storing radiation energy may be of any type insofar as it can store radiation energy or electron beam energy and can be stimulated by an electromagnetic wave to release the radiation energy or the electron beam energy stored therein in the form of light. More specifically, preferably employed stimulable phosphors include alkaline earth metal fluorohalide phosphors (Ba₁₋ₓ, M²⁺ₓ)FX:yA (where M²⁺ is at least one alkaline earth metal selected from the group consisting of Mg, Ca, Sr, Zn and Cd; X is at least one element selected from the group consisting of Cl, Br and I, A is at least one element selected from the group consisting of Eu, Tb, Ce, Tm, Dy, Pr, Ho, Nd, Yb and Er; x is equal to or greater than 0 and equal to or less than 0.6 and y is equal to or greater than 0 and equal to or less than 0.2) disclosed in U.S. Pat. No. 4,239,968, alkaline earth metal fluorohalide phosphors SrFX:Z (where X is at least one halogen selected from the group consisting of Cl, Br and I; Z is at least one of Eu and Ce) disclosed in Japanese Patent Application Laid Open No. 2-276997, europium activated complex halide phosphors BaFXxNaX′:aEu²⁺ (where each of X or X′ is at least one halogen selected from the group consisting of Cl, Br and I; x is greater than 0 and equal to or less than 2; and y is greater than 0 and equal to or less than 0.2) disclosed in Japanese Patent Application Laid Open No. 59-56479, cerium activated trivalent metal oxyhalide phosphors MOX:xCe (where M is at least one trivalent metal selected from the group consisting of Pr, Nd, Pm, Sm, Eu, Tb, Dy, Ho, Er, Tm, Yb and Bi; X is at least one halogen selected from the group consisting of Br and I; and x is greater than 0 and less than 0.1) disclosed in Japanese Patent Application laid Open No. 58-69281, cerium activated rare earth oxyhalide phosphors LnOX:xCe (where Ln is at least one rare earth element selected from the group consisting of Y, La, Gd and Lu; X is at least one halogen selected from the group consisting of Cl, Br and I; and x is greater than 0 and equal to or less than 0.1) disclosed in U.S. Pat. No. 4,539,137, and europium activated complex halide phosphors M^{II}FXaM^{I}X′bM′^{II}X″₂cM^{III}X″′₃xA:yEu²⁺ (where M^{II} is at least one alkaline earth metal selected from the group consisting of Ba, Sr and Ca; M^{I} is at least one alkaline metal selected from the group consisting of Li, Na, K, Rb and Cs; M′^{II} is at least one divalent metal selected from the group consisting of Be and Mg; M^{III} is at least one trivalent metal selected from the group consisting of Al, Ga, In and Ti; A is at least one metal oxide; X is at least one halogen selected from the group consisting of Cl, Br and I; each of X′, X″ and X″′ is at least one halogen selected from the group consisting of F, Cl, Br and I; a is equal to or greater than 0 and equal to or less than 2; b is equal to or greater than 0 and equal to or less than 10⁻²; c is equal to or greater than 0 and equal to or less than 10⁻²; a+b+c is equal to or greater than 10⁻²; x is greater than 0 and equal to or less than 0.5; and y is greater than 0 and equal to or less than 0.2) disclosed in U.S. Pat. No. 4,962,047.

In the present invention, the stimulable phosphor usable for storing the energy of chemiluminescence emission may be of any type insofar as it can store the energy of light in the wavelength band of visible light and can be stimulated by an electromagnetic wave to release in the form of light the energy of light in the wavelength band of visible light stored therein. More specifically, preferably employed stimulable phosphors include at least one selected from the group consisting of metal halophosphates, rare-earth-activated sulfide-host phosphors, aluminate-host phosphors, silicate-host phosphors, fluoride-host phosphors and mixtures of two, three or more of these phosphors. Among them, rare-earth-activated sulfide-host phosphors are more preferable and, particularly, rare-earth-activated alkaline earth metal sulfide-host phosphors disclosed in U.S. Pat. Nos. 5,029,253 and 4,983,834, zinc germanate such as Zn₂GeO₄:Mn, V; Zn₂GeO₄:Mn disclosed in Japanese Patent Application Laid Open No. 2001-131545, alkaline-earth aluminate such as Sr₄Al₁₄O₂₅:Ln (wherein Ln is a rare-earth element) disclosed in Japanese Patent Application Laid Open No. 2001-123162, Y_{0.8}Lu_{1.2}SiO₅:Ce, Zr; GdOCl:Ce disclosed in Japanese Patent Publication No. 6-31904 and the like are most preferable.

The above and other objects and features of the present invention will become apparent from the following description made with reference to the accompanying drawings.

### BRIEF DESCRIPTION OF THE DRAWINGS

FIG. 1 is a schematic partial plan view showing a biochemical analysis unit which is a preferred embodiment of the present invention.

FIG. 2 is a schematic front view showing a spotting device.

FIG. 3 is a schematic longitudinal cross sectional view showing a hybridization reaction vessel.

FIG. 4 is a schematic perspective view showing a stimulable phosphor sheet.

FIG. 5 is a schematic cross-sectional view showing a method for exposing a number of stimulable phosphor layer regions formed in a stimulable phosphor sheet to a radioactive labeling substance contained in a number of absorptive regions formed in a biochemical analysis unit.

FIG. 6 is a schematic view showing one example of a scanner.

FIG. 7 is a schematic perspective view showing details in the vicinity of a photomultiplier of a scanner shown in FIG. 6.

FIG. 8 is a schematic cross-sectional view taken along a line A-A in FIG. 7.

FIG. 9 is a schematic cross-sectional view taken along a line B-B in FIG. 7.

FIG. 10 is a schematic cross-sectional view taken along a line C-C in FIG. 7.

FIG. 11 is a schematic cross-sectional view taken along a line D-D in FIG. 7.

FIG. 12 is a schematic plan view of a scanning mechanism of an optical head.

FIG. 13 is a block diagram of a control system, an input system, a drive system and a detection system of the scanner shown in FIG. 6.

FIG. 14 is a schematic perspective view showing a stimulable phosphor sheet onto which chemiluminescence data are to be transferred.

FIG. 15 is a schematic view showing another example of a scanner.

FIG. 16 is a schematic perspective view showing details in the vicinity of a photomultiplier of a scanner shown in FIG. 15.

FIG. 17 is a schematic cross-sectional view taken along a line E-E in FIG. 16.

FIG. 18 is a schematic front view showing a data producing system.

FIG. 19 is a schematic longitudinal cross sectional view showing a cooled CCD camera of a data producing system.

FIG. 20 is a schematic longitudinal cross sectional view showing a dark box of a data producing system.

FIG. 21 is a block diagram of a personal computer and peripheral devices thereof.

FIG. 22 is a schematic partial plan view of a biochemical analysis unit which is another preferred embodiment of the present invention.

FIG. 23 is schematic plan view showing each of aluminum sheets extending in a direction indicated by an arrow A in FIG. 22.

FIG. 24 is schematic plan view showing a repetition unit in a direction indicated by an arrow B in FIG. 22 of aluminum sheets extending in the direction indicated by the arrow B and aluminum strip

### DESCRIPTION OF THE PREFERRED EMBODIMENTS

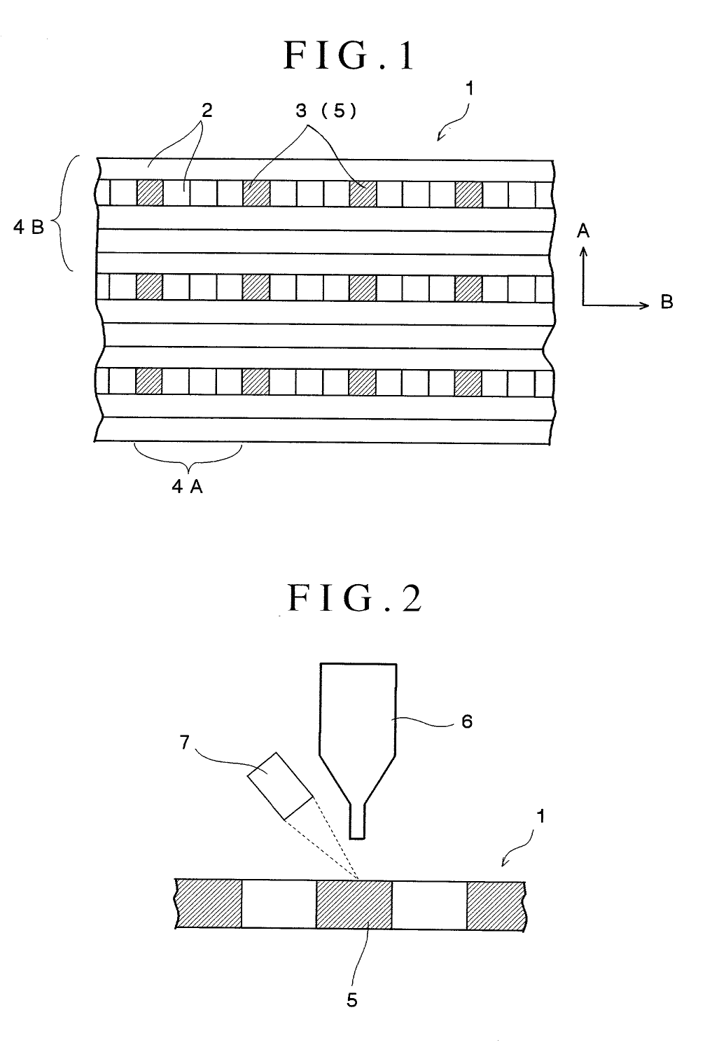

FIG. 1 is a schematic partial plan view showing a biochemical analysis unit which is a preferred embodiment of the present invention.

As shown in FIG. 1, a biochemical analysis unit 1 according to this embodiment is formed by weaving aluminum strips 2 having a property of attenuating radiation energy and light energy and absorptive strips 3 formed of a plurality of bundles of nylon-6 fibers.

In this embodiment, square absorptive regions 5 each having a size of 100 microns×100 microns are two-dimensionally formed so as to be spaced apart from each other by weaving the aluminum strips 2 and the absorptive strips 3 in such a manner that a repetition unit 4A is constituted by three aluminum strips 2 each having a width of 100 microns and a single absorptive strip 3 having a width of 100 microns and consisting of a plurality of bundles of fibers in a direction indicated by an arrow A and a repetition unit 4B is constituted by the four aluminum strips 2 in a direction indicated by an arrow B and perpendicular to the direction indicated by the arrow A.

More specifically, as shown in FIG. 1, the repetition unit 4A consisting of the three aluminum strips 2 each having a width of 100 microns extending in the direction indicated by the arrow A and the one absorptive strip 3 consisting of a plurality of bundles of fibers and having a width of 100 microns is woven so as to be located above the repetition unit 4B consisting of the four aluminum strips 3 extending in the direction indicated by the arrow B each having a width of 100 microns in FIG. 1 every the repetition unit of the three aluminum strips 3 extending in the direction indicated by the arrow B and as a result, square absorptive regions 5 each having a size of 100 microns×100 microns are formed so as to be spaced apart from each other in the direction indicated by the arrow A and the direction indicated by the arrow B by a pitch of 400 microns FIG. 2 is a schematic front view showing a spotting device.

As shown in FIG. 2, when biochemical analysis is performed, a solution containing specific binding substances such as a plurality of cDNAs whose sequences are known but differ from each other are spotted using a spotting device onto a number of the absorptive regions 5 of the biochemical analysis unit 1 and the specific binding substances are fixed therein.

As shown in FIG. 2, the spotting device includes an injector 6 for ejecting a solution of specific binding substances toward the biochemical analysis unit 1 and a CCD camera 7 and is constituted so that the solution of specific binding substances such as cDNAs are spotted from the injector 6 when the tip end portion of the injector 6 and the center of the absorptive region 5 into which the solution containing specific binding substances is to be spotted are determined to coincide with each other as a result of viewing them using the CCD camera, thereby ensuring that the solution of specific binding substances can be accurately spotted into a number of the absorptive regions 5 of the biochemical analysis unit 1.

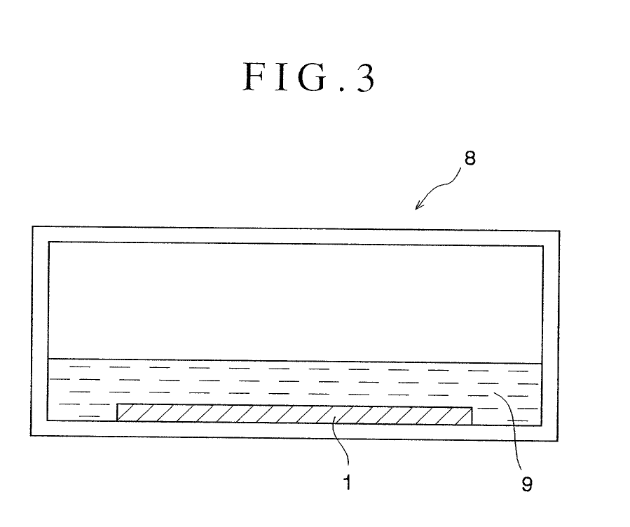

FIG. 3 is a schematic longitudinal cross sectional view showing a hybridization reaction vessel.

As shown in FIG. 3, a hybridization reaction vessel 8 is formed to have a substantially rectangular cross section and accommodates a hybridization reaction solution 9 containing a substance derived from a living organism labeled with a labeling substance as a probe therein.

In the case where a specific binding substance such as cDNA is to be labeled with a radioactive labeling substance, a hybridization reaction solution 9 containing a substance derived from a living organism and labeled with a radioactive labeling substance as a probe is prepared and is accommodated in the hybridization reaction vessel 8.

On the other hand, in the case where a specific binding substance such as cDNA is to be labeled with a labeling substance which generates chemiluminescence emission when it contacts a chemiluminescent substrate, a hybridization reaction solution 9 containing a substance derived from a living organism and labeled with a labeling substance which generates chemiluminescence emission when it contacts a chemiluminescent substrate as a probe is prepared and is accommodated in the hybridization reaction vessel 8.

Further, in the case where a specific binding substance such as cDNA is to be labeled with a fluorescent substance such as a fluorescent dye, a hybridization reaction solution 9 containing a substance derived from a living organism and labeled with a fluorescent substance such as a fluorescent dye as a probe is prepared and is accommodated in the hybridization reaction vessel 8.

It is possible to prepare a hybridization reaction solution 9 containing two or more substances derived from a living organism among a substance derived from a living organism and labeled with a radioactive labeling substance, a substance derived from a living organism and labeled with a labeling substance which generates chemiluminescence emission when it contacts a chemiluminescent substrate and a substance derived from a living organism and labeled with a fluorescent substance such as a fluorescent dye and accommodate it in the hybridization vessel 8. In this embodiment, a hybridization reaction solution 9 containing a substance derived from a living organism and labeled with a radioactive labeling substance, a substance derived from a living organism and labeled with a labeling substance which generates chemiluminescence emission when it contacts a chemiluminescent substrate and a substance derived from a living organism and labeled with a fluorescent substance such as a fluorescent dye is prepared and accommodated in the hybridization reaction vessel 8.

When hybridization is to be performed, the biochemical analysis unit 1 containing specific binding substances such as a plurality of cDNAs spotted into a number of absorptive regions 5 is accommodated in the hybridization reaction vessel 8.

As a result, specific binding substances spotted in a number of the absorptive regions 5 of the biochemical analysis unit 1 can be selectively hybridized with a substance derived from a living organism, labeled with a radioactive labeling substance and contained in the hybridization reaction solution 9, a substance derived from a living organism, labeled with a labeling substance which generates chemiluminescence emission when it contacts a chemiluminescent substrate and contained in the hybridization reaction solution 9 and a substance derived from a living organism, labeled with a fluorescent substance such as a fluorescent dye and contained in the hybridization reaction solution 9.

In this manner, radiation data of a radioactive labeling substance, chemiluminescence data of a labeling substance which generates chemiluminescence emission when it contacts a chemiluminescent substrate and fluorescence data of a fluorescent substance such as a fluorescent dye are recorded in a number of absorptive regions 5 formed in the biochemical analysis unit 1.

In this embodiment, since specific binding substances are absorbed in the absorptive regions 5 formed of the absorptive strips 3 made of nylon-6 and absorbed in a region having a small volume, the rate of hybridization reaction can be improved. Further, since the hybridization reaction solution 9 can be brought into contact with the absorptive regions 5 having a large surface area, it is possible to increase the probability of a substance derived from a living organism associating with the specific binding substances absorbed in the absorptive regions 5. Therefore, the efficiency of hybridization can be markedly improved.

Fluorescence data recorded in a number of absorptive regions. 5 formed in the biochemical analysis unit 1 are read by a scanner described later, thereby producing biochemical analysis data.

On the other hand, radiation data of the radioactive labeling substance recorded in a number of absorptive regions 5 formed in the biochemical analysis unit 1 are transferred onto a stimulable phosphor sheet and read by the scanner described later, thereby producing biochemical analysis data.

Further, chemiluminescence data recorded in a number of absorptive regions 5 formed in the biochemical analysis unit 1 are transferred onto a stimulable sheet described later or read by a cooled CCD camera of a data producing system described later, thereby producing biochemical analysis data.

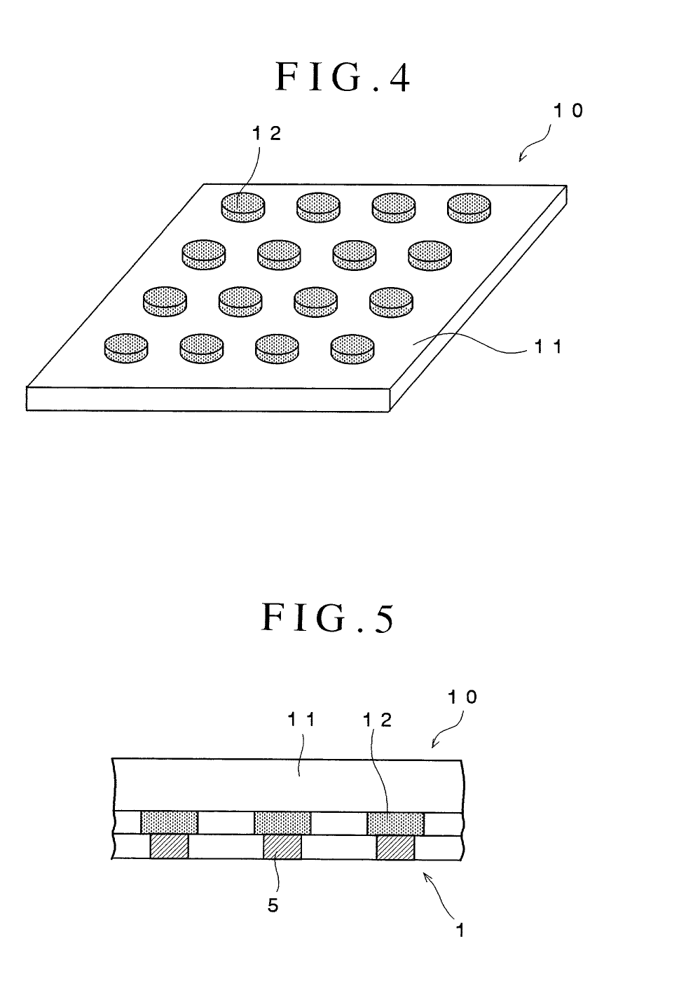

FIG. 4 is a schematic perspective view showing a stimulable phosphor sheet.

As shown in FIG. 4, a stimulable phosphor sheet 10 includes a support 11 and a number of substantially circular stimulable phosphor layer regions 12 are formed on the one surface of the support 11 in the same pattern as that of a number of the absorptive regions 5 formed in the biochemical analysis unit 1.

In this embodiment, the support 11 of the stimulable phosphor sheet 10 is made of stainless steel capable of attenuating radiation energy and each of the substantially circular stimulable phosphor layer regions 12 has a lager size than each of the absorptive regions 5 having a size of 100 microns×100 microns so that it can completely cover the corresponding absorptive region 5 of the biochemical analysis unit 1 when the stimulable phosphor sheet 10 is superposed on the biochemical analysis unit 1.

In this embodiment, each of number of the stimulable phosphor layer regions 12 contains BaFX system stimulable phosphor (where X is at least one halogen atom selected from the group consisting of Cl, Br and I) capable of absorbing and storing radiation energy and a binder.

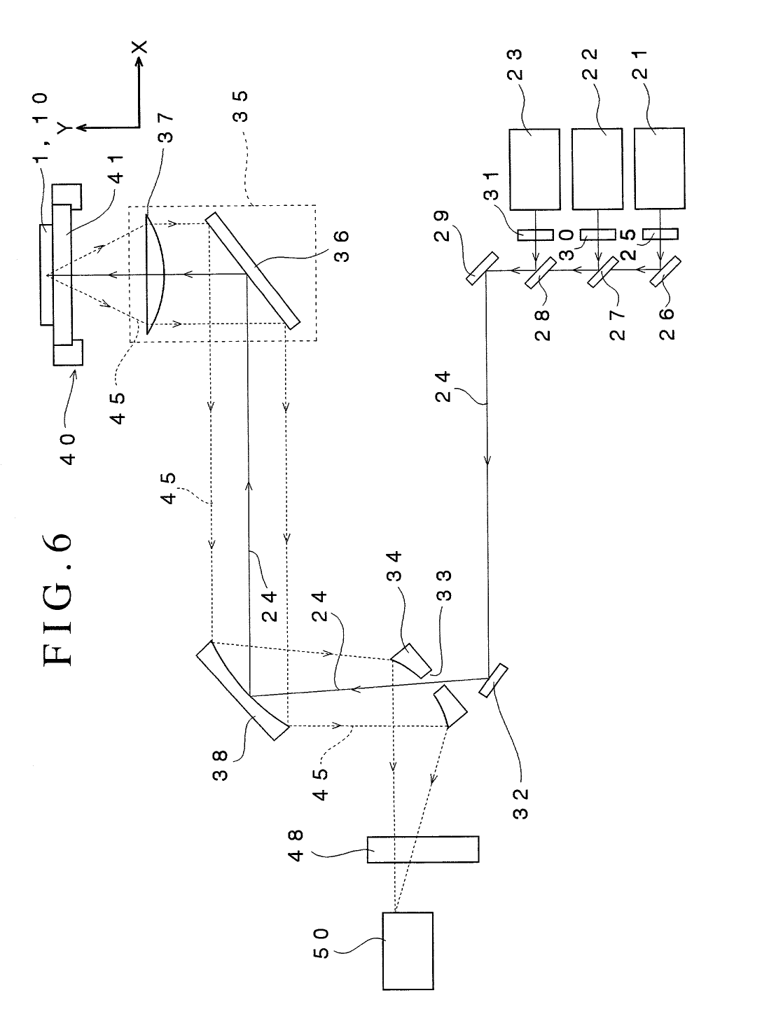

FIG. 5 is a schematic cross-sectional view showing a method for exposing a number of the stimulable phosphor layer regions12 formed on the support 11 of the stimulable phosphor sheet 19 to a radioactive labeling substance contained in a number of the absorptive regions 5 formed in the biochemical analysis unit 1.

As shown in FIG. 5, when the stimulable phosphor layer regions 12 of a stimulable phosphor sheet 10 are to be exposed, the stimulable phosphor sheet 10 is superposed on the biochemical analysis unit 1 in such a manner that each of the stimulable phosphor layer regions 12 formed on the support 11 of the stimulable phosphor sheet 10 faces the corresponding absorptive region 5 formed in the biochemical analysis unit 1.

In this embodiment, since 90% or more of the biochemical analysis unit 1 is formed of the aluminum strips 2, the biochemical analysis unit 1 does not substantially stretch or shrink even when it is subjected to liquid processing such as hybridization and, therefore, it is possible to easily and accurately superpose the stimulable phosphor sheet 10 on the biochemical analysis unit 1 so that each of the stimulable phosphor layer regions 12 formed in the stimulable phosphor sheet 10 accurately faces the corresponding absorptive region 5 formed in the biochemical analysis unit 1, thereby exposing the stimulable phosphor layer regions 12.

In this manner, each of the stimulable phosphor layer regions 12 formed in the stimulable phosphor sheet 10 is kept to be in close contact with the corresponding absorptive region 5 formed in the biochemical analysis unit 1 for a predetermined time period, whereby a number of the stimulable phosphor layer regions 12 formed in the stimulable phosphor sheet 10 are exposed to the radioactive labeling substance selectively contained in a number of the absorptive regions 5 formed in the biochemical analysis unit 1.

During the exposure operation, electron beams (β rays) are released from the radioactive labeling substance contained in the absorptive regions 5 of the biochemical analysis unit 1. However, since the aluminum strips 2 capable of attenuating radiation energy are present around each of the absorptive regions 5, electron beams (β rays) released from the radioactive labeling substance contained in the absorptive regions 5 of the biochemical analysis unit 1 can be efficiently prevented from scattering in the biochemical analysis unit 1. Further, since the support 11 of the stimulable phosphor sheet 10 is made of stainless steel capable of attenuating radiation energy, electron beams (β rays) released from the radioactive labeling substance contained in the absorptive regions 5 of the biochemical analysis unit 1 can be efficiently prevented from scattering in the support 11 of the stimulable phosphor sheet 10 and impinging on the stimulable phosphor layer regions 12 neighboring absorptive regions 5 face.

Therefore, it is possible to selectively expose the stimulable phosphor layer regions 12 formed on the support 11 of the stimulable phosphor sheet 10 to only a radioactive labeling substance contained in the corresponding absorptive regions 5 of the biochemical analysis unit 1.

In this manner, radiation data of a radioactive labeling substance are recorded in a number of the stimulable phosphor layer regions 12 formed on the support 11 of the stimulable phosphor sheet 10.

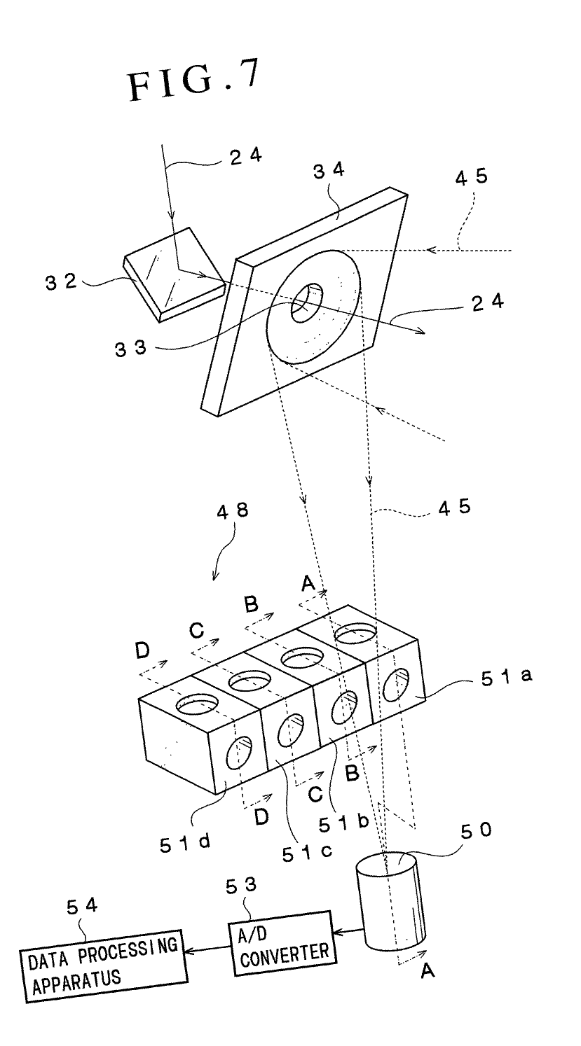

FIG. 6 is a schematic view showing a scanner for reading radiation data of a radioactive labeling substance recorded in a number of the stimulable phosphor layer regions 12 formed on the support 11 of the stimulable phosphor sheet 10 and fluorescence data of a fluorescent substance such as a fluorescent dye recorded in a number of the absorptive regions 5 formed in the biochemical analysis unit 1 and producing biochemical analysis data, and FIG. 7 is a schematic perspective view showing details in the vicinity of a photomultiplier of the scanner.

The scanner shown in FIG. 6 is constituted so as to read radiation data of a radioactive labeling substance recorded in a number of the stimulable phosphor layer regions 12 formed on the support 11 of the stimulable phosphor sheet 10 and fluorescence data of a fluorescent substance such as a fluorescent dye recorded in a number of the absorptive regions 5 formed in the biochemical analysis unit 1 to produce biochemical analysis data and includes a first laser stimulating ray source 21 for emitting a laser beam having a wavelength of 640 nm, a second laser stimulating ray source 22 for emitting a laser beam having a wavelength of 532 nm and a third laser stimulating ray source 23 for emitting a laser beam having a wavelength of 473 nm.

In this embodiment, the first laser stimulating ray source 21 is constituted by a semiconductor laser beam source and the second laser stimulating ray source 22 and the third laser stimulating ray source 23 are constituted by a second harmonic generation element.

A laser beam 24 emitted from the first laser stimulating source 21 passes through a collimator lens 25, thereby being made a parallel beam, and is reflected by a mirror 26. A first dichroic mirror 27 for transmitting light having a wavelength of 640 nm but reflecting light having a wavelength of 532 nm and a second dichroic mirror 28 for transmitting light having a wavelength equal to and longer than 532 nm but reflecting light having a wavelength of 473 nm are provided in the optical path of the laser beam 24 emitted from the first laser stimulating ray source 21. The laser beam 24 emitted from the first laser stimulating ray source 21 and reflected by the mirror 26 passes through the first dichroic mirror 27 and the second dichroic mirror 28 and advances to a mirror 29.

On the other hand, the laser beam 24 emitted from the second laser stimulating ray source 22 passes through a collimator lens 30, thereby being made a parallel beam, and is reflected by the first dichroic mirror 27, thereby changing its direction by 90 degrees. The laser beam 24 then passes through the second dichroic mirror 28 and advances to the mirror 29.

Further, the laser beam 24 emitted from the third laser stimulating ray source 23 passes through a collimator lens 31, thereby being made a parallel beam, and is reflected by the second dichroic mirror 28, thereby changing its direction by 90 degrees. The laser beam 24 then advances to the mirror 29.

The laser beam 24 advancing to the mirror 29 is reflected by the mirror 29 and advances to a mirror 32 to be reflected thereby.

A perforated mirror 34 formed with a hole 33 at the center portion thereof is provided in the optical path of the laser beam 24 reflected by the mirror 32. The laser beam 24 reflected by the mirror 32 passes through the hole 33 of the perforated mirror 34 and advances to a concave mirror 38.

The laser beam 24 advancing to the concave mirror 38 is reflected by the concave mirror 38 and enters an optical head 35.

The optical head 35 includes a mirror 36 and an aspherical lens 37. The laser beam 24 entering the optical head 35 is reflected by the mirror 36 and condensed by the aspherical lens 37 onto the stimulable phosphor sheet 10 or the biochemical analysis unit 1 placed on the glass plate 41 of a stage 40.

When the laser beam 24 impinges on the stimulable phosphor layer region 12 formed in the stimulable phosphor sheet 10, stimulable phosphor contained in the stimulable phosphor layer region 12 formed in the stimulable phosphor 10 is excited, thereby releasing stimulated emission 45. On the other hand, when the laser beam 24 impinges on the absorptive region 5 formed in the biochemical analysis unit 1, a fluorescent dye or the like contained in the absorptive region 5 formed in the biochemical analysis unit is excited, thereby releasing fluorescence emission 45.

The stimulated emission 45 released from the stimulable phosphor layer region 12 formed in the stimulable phosphor 10 or the fluorescence emission 45 released from the absorptive region 5 formed in the biochemical analysis unit 1 is condensed onto the mirror 36 by the aspherical lens 37 provided in the optical head 35 and reflected by the mirror 36 on the side of the optical path of the laser beam 24, thereby being made a parallel beam to advance to the concave mirror 38.

The stimulated emission 45 or the fluorescence emission 45 advancing to the concave mirror 38 is reflected by the concave mirror 38 and advances to the perforated mirror 34.

As shown in FIG. 7, the stimulated emission 45 or the fluorescence emission 45 advancing to the perforated mirror 34 is reflected downward by the perforated mirror 34 formed as a concave mirror and advances to a filter unit 48, whereby light having a predetermined wavelength is cut. The stimulated emission 45 or the fluorescence emission 45 then impinges on a photomultiplier 50, thereby being photoelectrically detected.

As shown in FIG. 7, the filter unit 48 is provided with four filter members 51a, 51b, 51c and 51d and is constituted to be laterally movable in FIG. 7 by a motor (not shown).

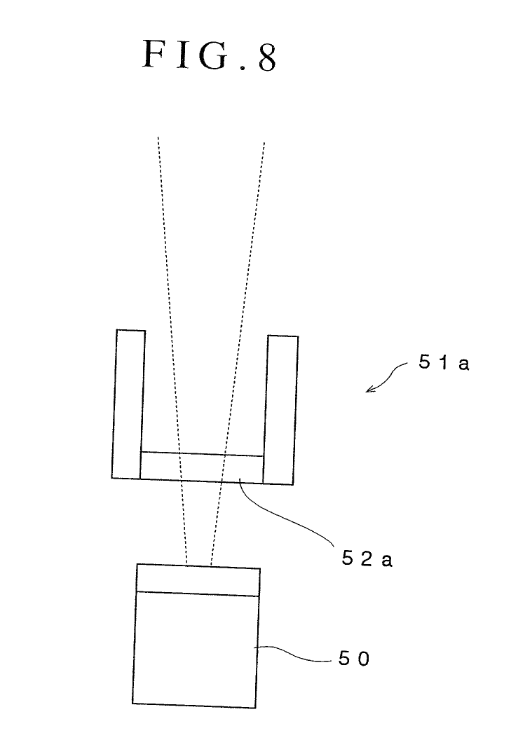

FIG. 8 is a schematic cross-sectional view taken along a line A-A in FIG. 7.

As shown in FIG. 8, the filter member 51a includes a filter 52a and the filter 52a is used for reading fluorescence emission 45 by stimulating a fluorescent substance such as a fluorescent dye contained in a number of the absorptive regions 5 formed in the biochemical analysis unit 1 using the first laser stimulating ray source 21 and has a property of cutting off light having a wavelength of 640 nm but transmitting light having a wavelength longer than 640 nm.

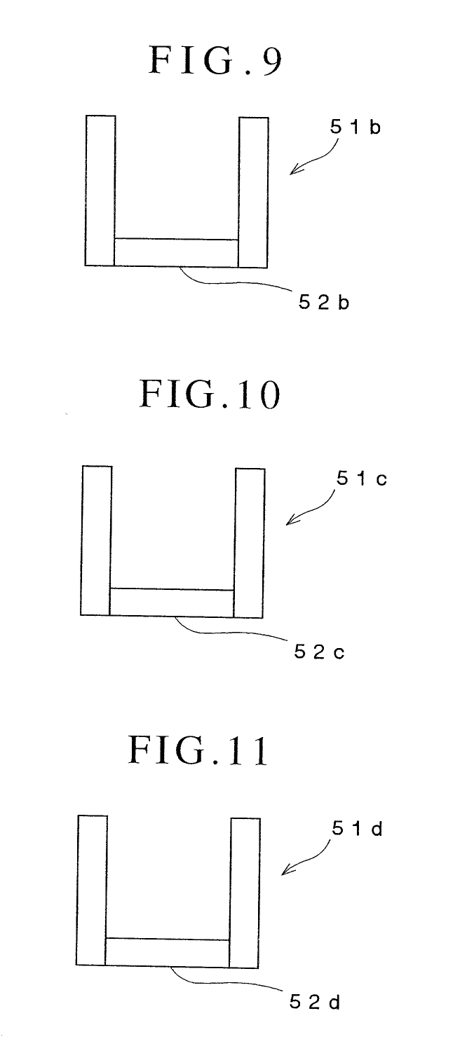

FIG. 9 is a schematic cross-sectional view taken along a line B-B in FIG. 7.

As shown in FIG. 9, the filter member 51b includes a filter 52b and the filter 52b is used for reading fluorescence emission 45 by stimulating a fluorescent substance such as a fluorescent dye contained in a number of the absorptive regions 5 formed in the biochemical analysis unit 1 using the second laser stimulating ray source 22 and has a property of cutting off light having a wavelength of 532 nm but transmitting light having a wavelength longer than 532 nm.

FIG. 10 is a schematic cross-sectional view taken along a line C-C in FIG. 7.

As shown in FIG. 10, the filter member Sic includes a filter 52c and the filter 52c is used for reading fluorescence emission 45 by stimulating a fluorescent substance such as a fluorescent dye contained in in a number of the absorptive regions 5 formed in the biochemical analysis unit 1 using the third laser stimulating ray source 23 and has a property of cutting off light having a wavelength of 473 nm but transmitting light having a wavelength longer than 473 nm.

FIG. 11 is a schematic cross-sectional view taken along a line D-D in FIG. 7.

As shown in FIG. 11, the filter member 51d includes a filter 52d and the filter 52d is used for reading stimulated emission released from stimulable phosphor contained in the stimulable phosphor layer 12 formed in the stimulable phosphor sheet 10 upon being stimulated using the first laser stimulating ray source 21 and has a property of transmitting only light having a wavelength corresponding to that of stimulated emission emitted from stimulable phosphor and cutting off light having a wavelength of 640 nm.

Therefore, in accordance with the kind of a stimulating ray source to be used, one of these filter members 51a, 51b, 51c, 51d is selectively positioned in front of the photomultiplier 50, thereby enabling the photomultiplier 50 to photoelectrically detect only light to be detected.

The analog data produced by photoelectrically detecting light with the photomultiplier 50 are converted by an AID converter 53 into digital data and the digital data are fed to a data processing apparatus 54.

Although not shown in FIG. 8, the optical head 35 is constituted to be movable by a scanning mechanism in a main scanning direction indicated by an arrow X and a sub-scanning direction indicated by an arrow Y in FIG. 8 so that all of the stimulable phosphor layer regions 12 formed in the stimulable phosphor sheet 10 or all of the absorptive regions 5 formed in the biochemical analysis unit 1 can be scanned by the laser beam 24.

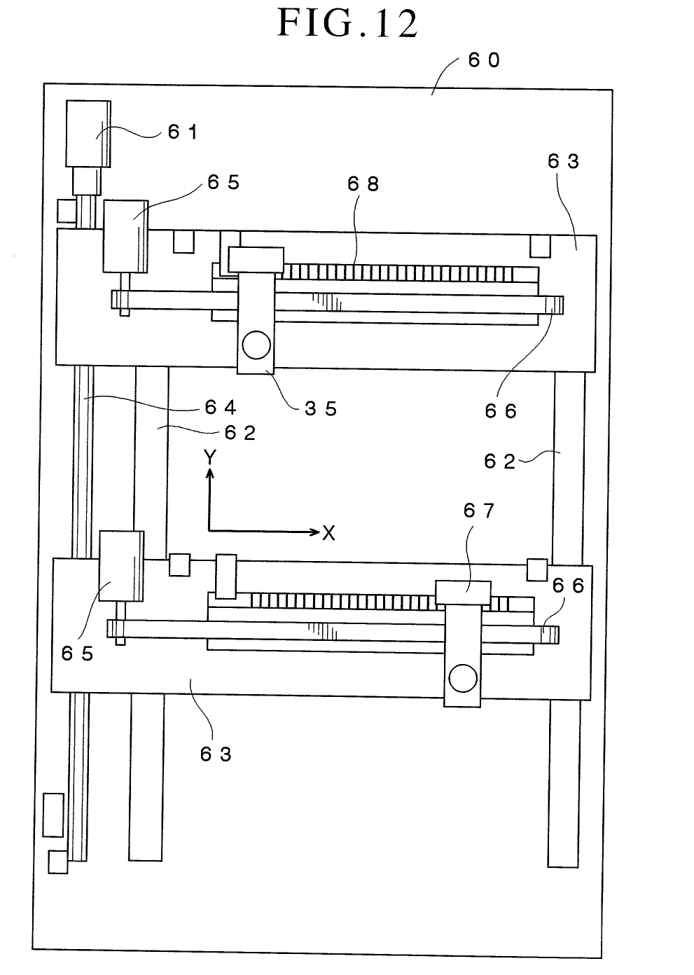

FIG. 12 is a schematic plan view showing the scanning mechanism of the optical head 35.

In FIG. 12, optical systems other than the optical head 35 and the paths of the laser beam 24 and stimulated emission 45 or fluorescence emission 45 are omitted for simplification.

As shown in FIG. 12, the scanning mechanism of the optical head 35 includes a base plate 60, and a sub-scanning pulse motor 61 and a pair of rails 62, 62 are fixed on the base plate 60. A movable base plate 63 is further provided so as to be movable in the sub-scanning direction indicated by an arrow Y in FIG. 12.

The movable base plate 63 is formed with a threaded hole (not shown) and a threaded rod 64 rotated by the sub-scanning pulse motor 61 is engaged with the inside of the hole.

A main scanning stepping motor 65 is provided on the movable base plate 63. The main scanning stepping motor 65 is adapted for intermittently driving an endless belt 66 by a pitch equal to the distance between neighboring absorptive regions 5 formed in the biochemical analysis unit 1, namely, the distance between neighboring stimulable phosphor layer regions 12 formed in the stimulable phosphor sheet 10.

The optical head 35 is fixed to the endless belt 66 and when the endless belt 66 is driven by the main scanning stepping motor 65, the optical head 35 is moved in the main scanning direction indicated by an arrow X in FIG. 12.

In FIG. 12, the reference numeral 67 designates a linear encoder for detecting the position of the optical head 35 in the main scanning direction and the reference numeral 68 designates slits of the linear encoder 67.

Therefore, the optical head 35 is moved in the main scanning direction indicated by the arrow X and the sub-scanning direction indicated by the arrow Y in FIG. 12 by driving the endless belt 66 in the main scanning direction by the main scanning stepping motor 65 and intermittently moving the movable base plate 63 in the sub-scanning direction by the sub-scanning pulse motor 61, thereby scanning all of the stimulable phosphor layer regions 12 formed in the stimulable phosphor sheet 10 or all of the absorptive regions 5 formed in the biochemical analysis unit 1 with the laser beam 24.

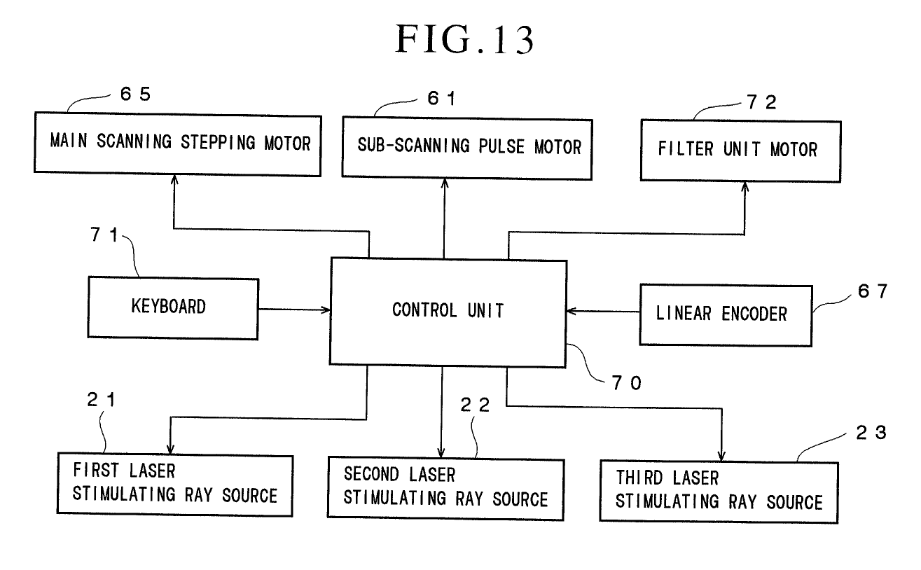

FIG. 13 is a block diagram of a control system, an input system, a drive system and a detection system of the scanner shown in FIG. 8.

As shown in FIG. 13, the control system of the scanner includes a control unit 70 for controlling the overall operation of the first scanner and the data processing apparatus 54, and the input system of the first scanner includes a keyboard 71 which can be operated by a user and through which various instruction signals can be input.

As shown in FIG. 13, the drive system of the scanner includes the main scanning stepping motor 65 for intermittently moving the optical head 35 in the main scanning direction, the sub-scanning pulse motor 61 for moving the optical head 35 in the sub-scanning direction and a filter unit motor 72 for moving the filter unit 48 provided with the four filter members 51a, 51b, 51c and 51d.

The control unit 70 is adapted for selectively outputting a drive signal to the first laser stimulating ray source 21, the second laser stimulating ray source 22 or the third laser stimulating ray source 23 and outputting a drive signal to the filter unit motor 72.

As shown in FIG. 13, the detection system of the first scanner includes the photomultiplier 50 and the linear encoder 67 for detecting the position of the optical head 35 in the main scanning direction.

In this embodiment, the control unit 70 is adapted to control the on and off operation of the first laser stimulating ray source 21, the second laser stimulating ray source 22 or the third laser stimulating ray source 23 in accordance with a detection signal indicating the position of the optical head 35 input from the linear encoder 67.

The thus constituted scanner reads radiation data recorded in a stimulable phosphor sheet 10 by exposing a number of the stimulable phosphor layer regions 12 to a radioactive labeling substance contained in a number of the absorptive regions 5 formed in the biochemical analysis unit 1 and produces biochemical analysis data in the following manner.

A stimulable phosphor sheet 10 is first set on the glass plate 41 of the stage 40 by a user.

An instruction signal indicating that radiation data recorded in the stimulable phosphor layer 12 formed in the stimulable phosphor sheet 10 are to be read is then input through the keyboard 71 by the user.

The instruction signal input through the keyboard 71 is input to the control unit 70 and the control unit 70 outputs a drive signal to the filter unit motor 72 in accordance with the instruction signal, thereby moving the filter unit 48 so as to locate the filter member 51d provided with the filter 52d having a property of transmitting only light having a wavelength corresponding to that of stimulated emission emitted from stimulable phosphor but cutting off light having a wavelength of 640 nm in the optical path of stimulated emission 45.

The control unit 70 further outputs a drive signal to the main scanning stepping motor 65 to move the optical head 35 in the main scanning direction and when it determines based on a detection signal indicating the position of the optical head 35 input from the linear encoder 67 that the optical head 35 has reached a position where a laser beam 24 can be projected onto a first stimulable phosphor layer region 12 among a number of the stimulable phosphor layer regions 12 formed in the stimulable phosphor sheet 10, it outputs a drive stop signal to the main scanning stepping motor 65 and a drive signal to the first laser stimulating ray source 21, thereby actuating it to emit a laser beam 24 having a wavelength of 640 nm.

A laser beam 24 emitted from the first laser stimulating source 21 passes through the collimator lens 25, thereby being made a parallel beam, and is reflected by the mirror 26.

The laser beam 24 reflected by the mirror 26 passes through the first dichroic mirror 27 and the second dichroic mirror 28 and advances to the mirror 29.

The laser beam 24 advancing to the mirror 29 is reflected by the mirror 29 and advances to the mirror 32 to be reflected thereby.

The laser beam 24 reflected by the mirror 32 passes through the hole 33 of the perforated mirror 34 and advances to the concave mirror 38.

The laser beam 24 advancing to the concave mirror 38 is reflected by the concave mirror 38 and enters the optical head 35.

The laser beam 24 entering the optical head 35 is reflected by the mirror 36 and condensed by the aspherical lens 37 onto the first stimulable phosphor layer region 12 of the stimulable phosphor sheet 10 placed on the glass plate 41 of a stage 40.

In this embodiment, since the stimulable phosphor layer regions 12 are formed on the support 11 made of stainless steel capable of attenuating light energy, it is possible to effectively prevent the laser beam 24 from scattering in each of the stimulable phosphor layer regions 12 and entering the neighboring stimulable phosphor layer regions 12 to excite stimulable phosphor contained in the neighboring stimulable phosphor layer regions 12.

When the laser beam 24 impinges onto the first stimulable phosphor layer region 12 formed on the support 11 of the stimulable phosphor sheet 10, stimulable phosphor contained in the first stimulable phosphor layer region 12 formed in the stimulable phosphor sheet 10 is excited by the laser beam 24, thereby releasing stimulated emission 45 from the first stimulable phosphor layer region 12.

The stimulated emission 45 released from the first stimulable phosphor layer region 12 is condensed onto the mirror 36 by the aspherical lens 37 provided in the optical head 35 and reflected by the mirror 36 on the side of the optical path of the laser beam 24, thereby being made a parallel beam to advance to the concave mirror 38.

The stimulated emission 45 advancing to the concave mirror 38 is reflected by the concave mirror 38 and advances to the perforated mirror 34.

As shown in FIG. 7, the stimulated emission 45 advancing to the perforated mirror 34 is reflected downward by the perforated mirror 34 formed as a concave mirror and advances to the filter 52d of the filter unit 48.

Since the filter 52d has a property of transmitting only light having a wavelength corresponding to that of stimulated emission emitted from stimulable phosphor and cutting off light having a wavelength of 640 nm, light having a wavelength of 640 nm corresponding to that of the stimulating ray is cut off by the filter 52d and only light having a wavelength corresponding to that of stimulated emission passes through the filter 52d to be photoelectrically detected by the photomultiplier 50.

Analog data produced by photoelectrically detecting stimulated emission 45 with the photomultiplier 50 are converted by an A/D converter 53 into digital data and the digital data are fed to a data processing apparatus 54.

When a predetermined time, for example, several microseconds, has passed after the first laser stimulating ray source 21 was turned on, the control unit 70 outputs a drive stop signal to the first laser stimulating ray source 21, thereby turning it off and outputs a drive signal to the main scanning stepping motor 65, thereby moving the optical head 35 by one pitch equal to the distance between neighboring stimulable phosphor layer regions 12 formed on the support 11 of the stimulable phosphor sheet 10.

When the control unit 70 determines based on a detection signal indicating the position of the optical head 35 input from the linear encoder 67 that the optical head 35 has been moved by one pitch equal to the distance between neighboring stimulable phosphor layer regions 12 and has reached a position where a laser beam 24 can be projected onto a second stimulable phosphor layer region 12 next to the first stimulable phosphor layer region 12 formed in the stimulable phosphor sheet 10, it outputs a drive signal to the first laser stimulating ray source 21 to turn it on, thereby causing the laser beam 24 to excite stimulable phosphor contained in the second stimulable phosphor layer region 12 formed in the stimulable phosphor sheet 10 next to the first stimulable phosphor layer region 12.

Similarly to the above, the second stimulable phosphor layer region 12 formed in the stimulable phosphor sheet 10 is irradiated with the laser beam 24 for a predetermined time and when stimulated emission 45 released from the second stimulable phosphor layer region 12 is photoelectrically detected by the photomultiplier 50, the control unit 70 outputs a drive stop signal to the first laser stimulating ray source 21, thereby turning it off and outputs a drive signal to the main scanning stepping motor 65, thereby moving the optical head 35 by one pitch equal to the distance between neighboring stimulable phosphor layer regions 12.

In this manner, the on and off operation of the first laser stimulating ray source 21 is repeated in synchronism with the intermittent movement of the optical head 35 and when the control unit 70 determines based on a detection signal indicating the position of the optical head 35 input from the linear encoder 67 that the optical head 35 has been moved by one scanning line in the main scanning direction and that the stimulable phosphor layer regions 12 included in a first line of the stimulable phosphor layer regions 12 formed in the stimulable phosphor sheet 10 have been scanned with the laser beam 24, it outputs a drive signal to the main scanning stepping motor 65, thereby returning the optical head 35 to its original position and outputs a drive signal to the sub-scanning pulse motor 61, thereby causing it to move the movable base plate 63 by one scanning line in the sub-scanning direction.

When the control unit 70 determines based on a detection signal indicating the position of the optical head 35 input from the linear encoder 67 that the optical head 35 has been returned to its original position and determines that the movable base plate 63 has been moved by one scanning line in the sub-scanning direction, similarly to the manner in which the stimulable phosphor layer regions 12 included in the first line of the stimulable phosphor layer regions 12 formed in the stimulable phosphor sheet 10 were sequentially irradiated with the laser beam 24 emitted from the first laser stimulating ray source 21, the stimulable phosphor layer regions 12 included in a second line of the stimulable phosphor layer regions 12 formed in the stimulable phosphor sheet 10 are sequentially irradiated with the laser beam 24 emitted from the first laser stimulating ray source 21, thereby exciting stimulable phosphor contained in the stimulable phosphor layer regions 12 included in the second line and stimulated emission 45 released from the stimulable phosphor layer regions 12 is sequentially and photoelectrically detected by the photomultiplier 50.

Analog data produced by photoelectrically detecting stimulated emission 45 with the photomultiplier 50 are converted by an A/D converter 53 into digital data and the digital data are fed to a data processing apparatus 54.

When all of the stimulable phosphor layer regions 12 formed in the stimulable phosphor sheet 10 have been scanned with the laser beam 24 to excite stimulable phosphor contained in the stimulable phosphor layer regions 12 and digital data produced by photoelectrically detecting stimulated emission 45 released from the stimulable phosphor layer regions 12 by the photomultiplier 50 to produce analog data and digitizing the analog data by the A/D converter 53 have been forwarded to the data processing apparatus 54, the control unit 70 outputs a drive stop signal to the first laser stimulating ray source 21, thereby turning it off.

As described above, radiation data of the radioactive labeling substance recorded in a number of the stimulable phosphor layer regions 12 of the stimulable phosphor sheet 10 are read by the scanner to produce biochemical analysis data.

On the other hand, when fluorescence data of a fluorescent substance recorded in a number of the absorptive regions 5 formed in the biochemical analysis unit 1 are to be read to produce biochemical analysis data, the biochemical analysis unit 1 is first set by the user on the glass plate 41 of the stage 40.

A fluorescent substance identification signal for identifying the kind of fluorescent substance as a labeling substance is then input through the keyboard 71 by the user together with an instruction signal indicating that fluorescence data are to be read.

The fluorescent substance identification signal and the instruction signal are input to the control unit 70 and when the control unit 70 receives them, it determines the laser stimulating ray source to be used in accordance with a table stored in a memory (not shown) and also determines what filter is to be positioned in the optical path of fluorescence emission 45 among the filters 52a, 52b and 52c.

For example, when Rhodamine (registered trademark), which can be most efficiently stimulated by a laser beam having a wavelength of 532 nm, is used as a fluorescent substance for labeling a substance derived from a living organism and a signal indicating such a fact is input, the control unit 70 selects the second laser stimulating ray source 22 and the filter 52b and outputs a drive signal to the filter unit motor 72, thereby moving the filter unit 48 so that the filter member 51b inserting the filter 52b having a property of cutting off light having a wavelength of 532 nm but transmitting light having a wavelength longer than 532 nm in the optical path of the fluorescence emission 45.

The control unit 70 further outputs a drive signal to the main scanning stepping motor 65 to move the optical head 35 in the main scanning direction and when it determines based on a detection signal indicating the position of the optical head 35 input from the linear encoder 67 that the optical head 35 has reached a position where a laser beam 24 can be projected onto a first absorptive region 5 among a number of the absorptive regions 5 formed in the biochemical analysis unit 1, it outputs a drive stop signal to the main scanning stepping motor 65 and a drive signal to the second laser stimulating ray source 22, thereby actuating it to emit a laser beam 24 having a wavelength of 532 nm.

The laser beam 24 emitted from the second laser stimulating ray source 22 is made a parallel beam by the collimator lens 30, advances to the first dichroic mirror 27 and is reflected thereby.

The laser beam 24 reflected by the first dichroic mirror 27 transmits through the second dichroic mirror 28 and advances to the mirror 29.

The laser beam 24 advancing to the mirror 29 is reflected by the mirror 29 and further advances to the mirror 32 to be reflected thereby.

The laser beam 24 reflected by the mirror 32 advances to the perforated mirror 34 and passes through the hole 33 of the perforated mirror 34. Then, the laser beam 24 advances to the concave mirror 38.

The laser beam 24 advancing to the concave mirror 38 is reflected thereby and enters the optical head 35.

The laser beam 24 entering the optical head 35 is reflected by the mirror 36 and condensed by the aspherical lens 37 onto the first absorptive region 5 of the biochemical analysis unit 1 placed on the glass plate 41 of the stage 40.

In this embodiment, since the aluminum strips 2 capable of attenuating light energy are present around each of the absorptive regions 5 of the biochemical analysis unit 1, it is possible to effectively prevent the laser beam 24 from scattering in each of the absorptive regions 5 and entering the neighboring absorptive regions 5 to excite a fluorescent substance contained in the neighboring absorptive regions 5.

When the laser beam 24 impinges onto the first absorptive region 5 formed in the biochemical analysis unit 1, a fluorescent substance such as a fluorescent dye, for instance, Rhodamine, contained in the absorptive region 5 formed in the biochemical analysis unit 1 is stimulated by the laser beam 24 and fluorescence emission 45 is released from Rhodamine.

In this embodiment, since the aluminum strips 2 capable of attenuating light energy are present around each of the absorptive regions 5 of the biochemical analysis unit 1, it is possible to effectively prevent fluorescence emission 45 released from a fluorescent substance from scattering in the biochemical analysis unit 1 and being mixed with fluorescence emission 45 released from a fluorescent substance contained in the neighboring absorptive regions 5.

The fluorescence emission 45 released from Rhodamine is condensed by the aspherical lens 37 provided in the optical head 35 and reflected by the mirror 36 on the side of an optical path of the laser beam 24, thereby being made a parallel beam to advance to the concave mirror 38.

The fluorescence emission 45 advancing to the concave mirror 38 is reflected by the concave mirror 38 and advances to the perforated mirror 34.

As shown in FIG. 7, the fluorescence emission 45 advancing to the perforated mirror 34 is reflected downward by the perforated mirror 34 formed as a concave mirror and advances to the filter 52b of a filter unit 48.

Since the filter 52b has a property of cutting off light having a wavelength of 532 nm but transmitting light having a wavelength longer than 532 nm, light having the same wavelength of 532 nm as that of the stimulating ray is cut off by the filter 52b and only light in the wavelength of the fluorescence emission 45 released from Rhodamine passes through the filter 52b to be photoelectrically detected by the photomultiplier 50.

Analog data produced by photoelectrically detecting stimulated emission 45 with the photomultiplier 50 are converted by an A/D converter 53 into digital data and the digital data are fed to a data processing apparatus 54.

When a predetermined time, for example, several microseconds, has passed after the second laser stimulating ray source 22 was turned on, the control unit 70 outputs a drive stop signal to the second laser stimulating ray source 22, thereby turning it off and outputs a drive signal to the main scanning stepping motor 65, thereby moving the optical head 35 by one pitch equal to the distance between neighboring absorptive regions 5 formed in the biochemical analysis unit 1.

When the control unit 70 determines based on a detection signal indicating the position of the optical head 35 input from the linear encoder 67 that the optical head 35 has been moved by one pitch equal to the distance between neighboring absorptive regions 5 and has reached a position where a laser beam 24 can be projected onto a second absorptive region 5 next to the first absorptive region 5 formed in the biochemical analysis unit 1, it outputs a drive signal to the second laser stimulating ray source 22 to turn it on, thereby causing the laser beam 24 to excite a fluorescent substance, for example, Rhodamine, contained in the second absorptive region 5 formed in the biochemical analysis unit 1 next to the first absorptive region 5.

Similarly to the above, the second absorptive region 5 formed in the biochemical analysis unit 1 is irradiated with the laser beam 24 for a predetermined time and when fluorescence emission 45 released from the second absorptive region 5 is photoelectrically detected by the photomultiplier 50, the control unit 70 outputs a drive stop signal to the second laser stimulating ray source 21, thereby turning it off and outputs a drive signal to the main scanning stepping motor 65, thereby moving the optical head 35 by one pitch equal to the distance between neighboring absorptive regions 5.

In this manner, the on and off operation of the second laser stimulating ray source 22 is repeated in synchronism with the intermittent movement of the optical head 35 and when the control unit 70 determines based on a detection signal indicating the position of the optical head 35 input from the linear encoder 67 that the optical head 35 has been moved by one scanning line in the main scanning direction and that the absorptive regions 5 included in a first line of the absorptive regions 5 formed in the biochemical analysis unit 1 have been scanned with the laser beam 24, it outputs a drive signal to the main scanning stepping motor 65, thereby returning the optical head 35 to its original position and outputs a drive signal to the sub-scanning pulse motor 61, thereby causing it to move the movable base plate 63 by one scanning line in the sub-scanning direction.

When the control unit 70 determines based on a detection signal indicating the position of the optical head 35 input from the linear encoder 67 that the optical head 35 has been returned to its original position and determines that the movable base plate 63 has been moved by one scanning line in the sub-scanning direction, similarly to the manner in which the absorptive regions 5 included in the first line of the absorptive regions 5 formed in the biochemical analysis unit 1 were sequentially irradiated with the laser beam 24 emitted from the second laser stimulating ray source 22, the absorptive regions 5 included in a second line of the absorptive regions 5 formed in the biochemical analysis unit 1 are sequentially irradiated with the laser beam 24 emitted from the second laser stimulating ray source 22, thereby exciting Rhodamine contained in the absorptive regions 5 included in the second line and fluorescence emission 45 released from the absorptive regions 5 included in the second line is sequentially and photoelectrically detected by the photomultiplier 50.

Analog data produced by photoelectrically detecting stimulated emission 45 with the photomultiplier 50 are converted by an AID converter 53 into digital data and the digital data are fed to a data processing apparatus 54.

When all of the absorptive regions 5 formed in the biochemical analysis unit 1 have been scanned with the laser beam 24 to excite Rhodamine contained in the absorptive regions 5 and digital data produced by photoelectrically detecting fluorescence emission 45 released from the absorptive regions 5 by the photomultiplier 50 to produce analog data and digitizing the analog data by the A/D converter 53 have been forwarded to the data processing apparatus 54, the control unit 70 outputs a drive stop signal to the second laser stimulating ray source 22, thereby turning it off.

As described above, fluorescence data recorded in a number of the absorptive regions 5 of the biochemical analysis unit 1 are read by the scanner to produce biochemical analysis data.

Chemiluminescence data of a labeling substance recorded in absorptive regions 5 formed in the biochemical analysis unit 1, which generates chemiluminescence emission when it contacts a chemiluminescent substrate are transferred onto a stimulable phosphor sheet or read by a cooled CCD camera of a data processing system described later.

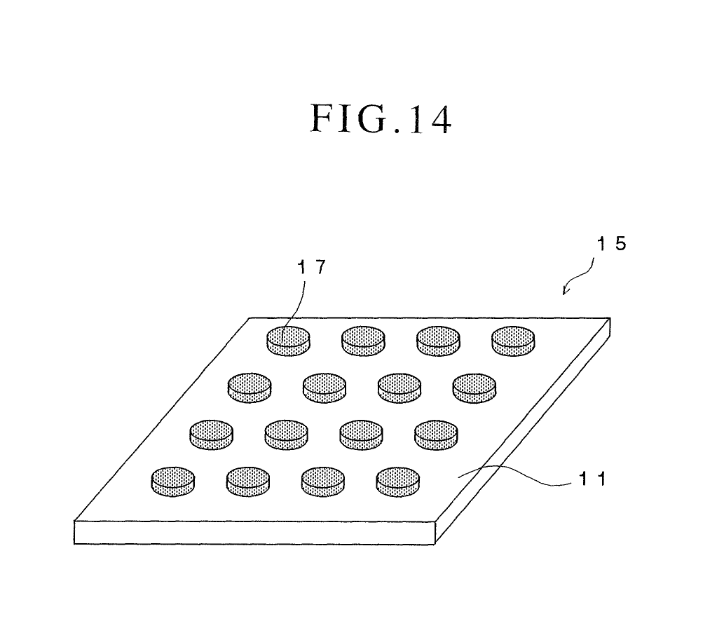

FIG. 14 is a schematic perspective view showing a stimulable phosphor sheet onto which chemiluminescence data are to be transferred.

A stimulable phosphor sheet 15 shown in FIG. 14 has the same configuration as that of the stimulable phosphor sheet 10 shown in FIG. 4 except that a number of stimulable phosphor layer regions 17 formed on one surface of the support 11 made of stainless steel in the same pattern as that of a number of absorptive regions 5 formed in the biochemical analysis unit 1 contain SrS system stimulable phosphor capable of absorbing and storing light energy and a binder.

Chemiluminescence data recorded in a number of the absorptive regions 5 of the biochemical analysis unit 1 are transferred onto a number of the stimulable phosphor layer regions 17 of the stimulable phosphor sheet 15 shown in FIG. 14.

When chemiluminescence data recorded in a number of the absorptive regions 5 of the biochemical analysis unit 1 are to be transferred onto a number of the stimulable phosphor layer regions 17 of the stimulable phosphor sheet 15, a number of the absorptive regions 5 of the biochemical analysis unit 1 are first brought into contact with a chemiluminescent substrate.

As a result, chemiluminescence emission in a wavelength of visible light is selectively released from a number of the absorptive regions 5 of the biochemical analysis unit 1.

The stimulable phosphor sheet 15 is then superposed on the biochemical analysis unit 1 formed with a number of the absorptive regions 5 selectively releasing chemiluminescence emission in such a manner that a number of the stimulable phosphor layer regions 17 formed in the stimulable phosphor sheet 15 face the corresponding absorptive regions 5 formed in the biochemical analysis unit 1.

In this manner, each of the stimulable phosphor layer regions 17 formed in the stimulable phosphor sheet 15 is kept to face the corresponding absorptive region 5 formed in the biochemical analysis unit 1 for a predetermined time period, whereby a number of the stimulable phosphor layer regions 17 formed in the stimulable phosphor sheet 15 are exposed to chemiluminescence emission released from a number of the absorptive regions 5 formed in the biochemical analysis unit 1.

In this embodiment, since the aluminum strips 2 capable of attenuating light energy are present around each of the absorptive regions 5 of the biochemical analysis unit 1, chemiluminescence emission released from the absorptive regions 5 of the biochemical analysis unit 1 during the exposure operation can be efficiently prevented from scattering in the biochemical analysis unit 1. Further, since the support 11 of the stimulable phosphor sheet 15 is made of stainless steel capable of attenuating light energy, chemiluminescence emission released from the absorptive regions 5 of the biochemical analysis unit 1 can be efficiently prevented from scattering in the support 11 of the stimulable phosphor sheet 15 and impinging on the stimulable phosphor layer regions 17 neighboring absorptive regions 5 face.

In this manner, chemiluminescence data are recorded in a number of the stimulable phosphor layer regions 17 formed in the stimulable phosphor sheet 15.

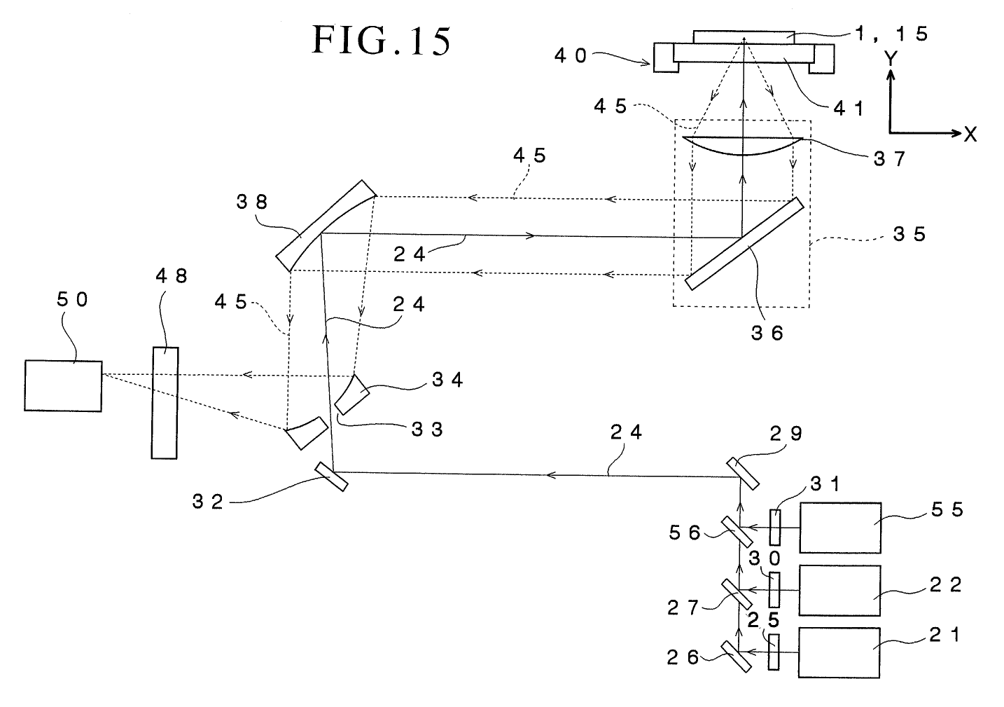

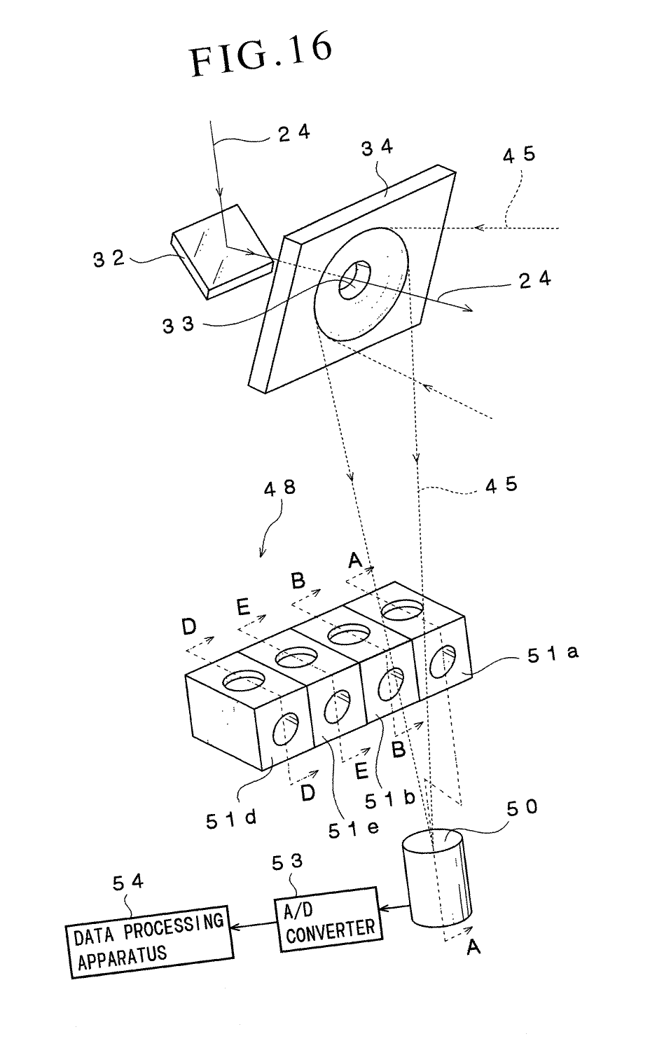

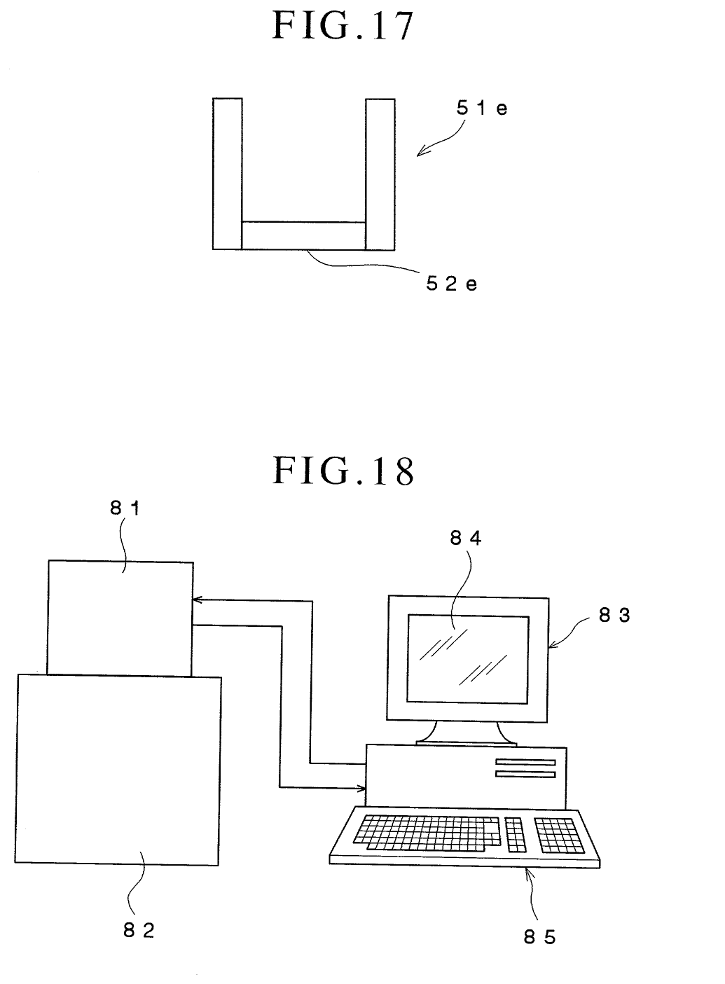

FIG. 15 is a schematic view showing a scanner for reading chemiluminescence data recorded in a number of the stimulable phosphor layer regions 17 formed in the stimulable phosphor sheet 15 and producing biochemical analysis data. FIG. 16 is a schematic perspective view showing details in the vicinity of a photomultiplier of a scanner shown in FIG. 15 and FIG. 17 is a schematic cross-sectional view taken along a line E-E in FIG. 16.

The scanner shown in FIGS. 15 to 17 has the same configuration as that of the first scanner shown in FIGS. 6 to 13 except that it includes a fourth laser stimulating ray source 55 for emitting a laser beam 24 having a wavelength of 980 nm which can effectively stimulate SrS system stimulable phosphor instead of the third laser stimulating ray source 23 for emitting a laser beam 24 having a wavelength of 473 nm, includes a filter member 51e provided with a filter having a property of transmitting only light having a wavelength corresponding to that of stimulated emission emitted from stimulable phosphor and cutting off light having a wavelength of 980 nm, and includes a third dichroic mirror 56 for transmitting light having a wavelength equal to and shorter than 640 nm but reflecting light having a wavelength of 980 nm instead of the second dichroic mirror 28 for transmitting light having a wavelength equal to and longer than 532 nm but reflecting light having a wavelength of 473 nm.

The thus constituted scanner reads chemiluminescence data recorded in a number of the stimulable phosphor layer regions 17 of the stimulable phosphor sheet 15 and produces biochemical analysis data in the following manner.

A stimulable phosphor sheet 15 is first set on the glass plate 41 of the stage 40 by a user.

An instruction signal indicating that chemiluminescence data recorded in the stimulable phosphor layer 17 formed in the stimulable phosphor sheet 15 are to be read is then input through the keyboard 71.

The instruction signal input through the keyboard 71 is input to the control unit 70 and the control unit 70 outputs a drive signal to the filter unit motor 72 in accordance with the instruction signal, thereby moving the filter unit 48 so as to locate the filter member 51e provided with the filter 52e having a property of transmitting only light having a wavelength corresponding to that of stimulated emission emitted from the stimulable phosphor layer regions 17 and cutting off light having a wavelength of 980 nm in the optical path of stimulated emission 45.

The control unit 70 further outputs a drive signal to the main scanning stepping motor 65 to move the optical head 35 in the main scanning direction and when it determines based on a detection signal indicating the position of the optical head 35 input from the linear encoder 67 that the optical head 35 has reached a position where a laser beam 24 can be projected onto a first stimulable phosphor layer region 17 among a number of the stimulable phosphor layer regions 17 formed in the stimulable phosphor sheet 15, it outputs a drive stop signal to the main scanning stepping motor 65 and a drive signal to the fourth stimulating ray source 55, thereby actuating it to emit a laser beam 24 having a wavelength of 980 nm.

A laser beam 24 emitted from the fourth laser stimulating ray source 55 passes through a collimator lens 31, thereby being made a parallel beam, and is reflected by the third dichroic mirror 56, thereby changing its direction by 90 degrees. The laser beam 24 then advances to the mirror 29.

The laser beam 24 advancing to the mirror 29 is reflected by the mirror 29 and advances to the mirror 32 to be reflected thereby.

The laser beam 24 reflected by the mirror 32 passes through the hole 33 of the perforated mirror 34 and advances to the concave mirror 38.

The laser beam 24 advancing to the concave mirror 38 is reflected by the concave mirror 38 and enters the optical head 35.

The laser beam 24 entering the optical head 35 is reflected by the mirror 36 and condensed by the aspherical lens 37 onto the first stimulable phosphor layer region 17 of the stimulable phosphor sheet 15 placed on the glass plate 41 of a stage 40.

In this embodiment, since the stimulable phosphor layer regions 12 are formed on the support 11 made of stainless steel capable of attenuating light energy, it is possible to effectively prevent the laser beam 24 from scattering in each of the stimulable phosphor layer regions 12 and entering the neighboring stimulable phosphor layer regions 12 to excite stimulable phosphor contained in the neighboring stimulable phosphor layer regions 12.

When the laser beam 24 impinges onto the first stimulable phosphor layer region 17 formed in the stimulable phosphor sheet 15, stimulable phosphor contained in the first stimulable phosphor layer region 17 formed in the stimulable phosphor sheet 15 is excited by the laser beam 24, thereby releasing stimulated emission 45 from the first stimulable phosphor layer region 17.

The stimulated emission 45 released from the first stimulable phosphor layer region 17 of the stimulable phosphor sheet 15 is condensed onto the mirror 36 by the aspherical lens 37 provided in the optical head 35 and reflected by the mirror 36 on the side of the optical path of the laser beam 24, thereby being made a parallel beam to advance to the concave mirror 38.

The stimulated emission 45 advancing to the concave mirror 38 is reflected by the concave mirror 38 and advances to the perforated mirror 34.

As shown in FIG. 15, the stimulated emission 45 advancing to the perforated mirror 34 is reflected downward by the perforated mirror 34 formed as a concave mirror and advances to the filter 52e of the filter unit 48.

Since the filter 52e (FIG. 16) has a property of transmitting only light having a wavelength corresponding to that of stimulated emission emitted from stimulable phosphor and cutting off light having a wavelength of 980 nm, light having a wavelength of 980 nm corresponding to that of the stimulating ray is cut off by the filter 52e and only light having a wavelength corresponding to that of stimulated emission passes through the filter 52e to be photoelectrically detected by the photomultiplier 50.

Analog data produced by photoelectrically detecting stimulated emission 45 with the photomultiplier 50 are converted by an A/D converter 53 into digital data and the digital data are fed to a data processing apparatus 54.

When a predetermined time has passed after the fourth stimulating ray source 55 was turned on, the control unit 70 outputs a drive stop signal to the fourth stimulating ray source 55, thereby turning it off and outputs a drive signal to the main scanning stepping motor 65, thereby moving the optical head 35 by one pitch equal to the distance between neighboring stimulable phosphor layer regions 17 of the stimulable phosphor sheet 15.

When the control unit 70 determines based on a detection signal indicating the position of the optical head 35 input from the linear encoder 67 that the optical head 35 has been moved by one pitch equal to the distance between neighboring stimulable phosphor layer regions 17, it outputs a drive signal to the fourth stimulating ray source 55 to turn it on, thereby causing the laser beam 24 to excite stimulable phosphor contained in a second stimulable phosphor layer region 17 formed on the support 11 of the stimulable phosphor sheet 15 next to the first stimulable phosphor layer region 17.

Similarly to the above, the second stimulable phosphor layer region 17 formed in the stimulable phosphor sheet 15 is irradiated with the laser beam 24 for a predetermined time and when stimulated emission 45 released from the second stimulable phosphor layer region 17 is photoelectrically detected by the photomultiplier 50, the control unit 70 outputs a drive stop signal to the fourth stimulating ray source 55, thereby turning it off and outputs a drive signal to the main scanning stepping motor 65, thereby moving the optical head 35 by one pitch equal to the distance between neighboring stimulable phosphor layer regions 17.

In this manner, the on and off operation of the fourth stimulating ray source 55 is repeated in synchronism with the intermittent movement of the optical head 35 and when the control unit 70 determines based on a detection signal indicating the position of the optical head 35 input from the linear encoder 67 that the optical head 35 has been moved by one scanning line in the main scanning direction and that the stimulable phosphor layer regions 17 included in a first line of the stimulable phosphor layer regions 17 formed in the stimulable phosphor sheet 15 have been scanned with the laser beam 24, it outputs a drive signal to the main scanning stepping motor 65, thereby returning the optical head 35 to its original position and outputs a drive signal to the sub-scanning pulse motor 61, thereby causing it to move the movable base plate 63 by one scanning line in the sub-scanning direction.

When the control unit 70 determines based on a detection signal indicating the position of the optical head 35 input from the linear encoder 67 that the optical head 35 has been returned to its original position and determines that the movable base plate 63 has been moved by one scanning line in the sub-scanning direction, similarly to the manner in which the stimulable phosphor layer regions 17 included in the first line of the stimulable phosphor layer regions 17 formed in the stimulable phosphor sheet 15 were sequentially irradiated with the laser beam 24 emitted from the fourth laser stimulating ray source 55, the stimulable phosphor layer regions 17 included in a second line of the stimulable phosphor layer regions 17 formed in the stimulable phosphor sheet 15 are sequentially irradiated with the laser beam 24 emitted from the fourth laser stimulating ray source 55, thereby exciting stimulable phosphor contained in the stimulable phosphor layer regions 17 included in the second line and stimulated emission 45 released from the stimulable phosphor layer regions 17 is sequentially and photoelectrically detected by the photomultiplier 50.

Analog data produced by photoelectrically detecting stimulated emission 45 with the photomultiplier 50 are converted by an A/D converter 53 into digital data and the digital data are fed to a data processing apparatus 54.

When all of the stimulable phosphor layer regions 17 formed in the stimulable phosphor sheet 15 have been scanned with the laser beam 24 to excite stimulable phosphor contained in the stimulable phosphor layer regions 17 and digital data produced by photoelectrically detecting stimulated emission 45 released from the stimulable phosphor layer regions 12 by the photomultiplier 50 to produce analog data and digitizing the analog data by the A/D converter 53 have been forwarded to the data processing apparatus 54, the control unit 70 outputs a drive stop signal to the fourth laser stimulating ray source 55, thereby turning it off.

As described above, chemiluminescence data recorded in a number of the stimulable phosphor layer regions 17 of the stimulable phosphor sheet 15 are read by the scanner to produce biochemical analysis data.

Chemiluminescence data of a labeling substance recorded in absorptive regions 5 formed in the biochemical analysis unit 1, which generates chemiluminescence emission when it contacts a chemiluminescent substrate can instead be read by a cooled CCD camera of a data producing system to produce biochemical analysis data without transferring them onto a number of the stimulable phosphor layer regions 17 of the stimulable phosphor sheet 15.

FIG. 18 is a schematic front view showing a data producing system for reading chemiluminescence data of a labeling substance, which generates chemiluminescence emission when it contacts a chemiluminescent substrate, recorded in absorptive regions 5 formed in the biochemical analysis unit 1, and producing biochemical analysis data.

The data producing system shown in FIG. 18 is constituted to be able to also read fluorescence data of a fluorescent substance such as a fluorescent dye recorded in a number of the absorptive regions 5 formed in the biochemical analysis unit 1.

As shown in FIG. 18, the data producing system includes a cooled CCD camera 81, a dark box 82 and a personal computer 83. As shown in FIG. 14, the personal computer 83 is equipped with a CRT 84 and a keyboard 85.

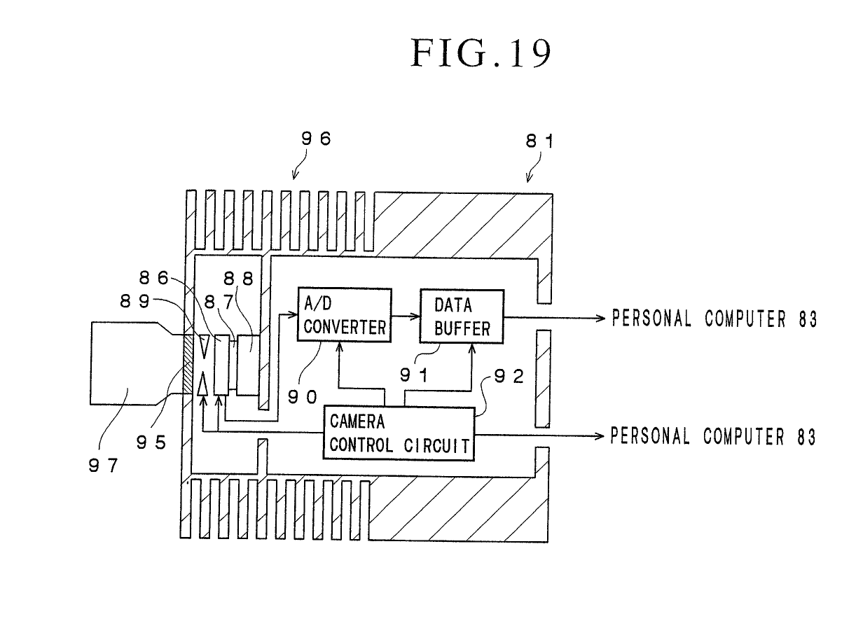

FIG. 19 is a schematic longitudinal cross sectional view showing the cooled CCD camera 81.

As shown in FIG. 19, the cooled CCD camera 81 includes a CCD 86, a heat transfer plate 87 made of metal such as aluminum, a Peltier element 88 for cooling the CCD 86, a shutter 89 disposed in front of the CCD 86, an A/D converter 90 for converting analog data produced by the CCD 86 to digital data, a data buffer 91 for temporarily storing the data digitized by the A/D converter 90, and a camera control circuit 92 for controlling the operation of the cooled CCD camera 81. An opening formed between the dark box 82 and the cooled CCD camera 81 is closed by a glass plate 95 and the periphery of the cooled CCD camera 81 is formed with heat dispersion fins 96 over substantially its entire length for dispersing heat.

A camera lens 97 disposed in the dark box 82 is mounted on the front surface of the glass plate 95 disposed in the cooled CCD camera 81.

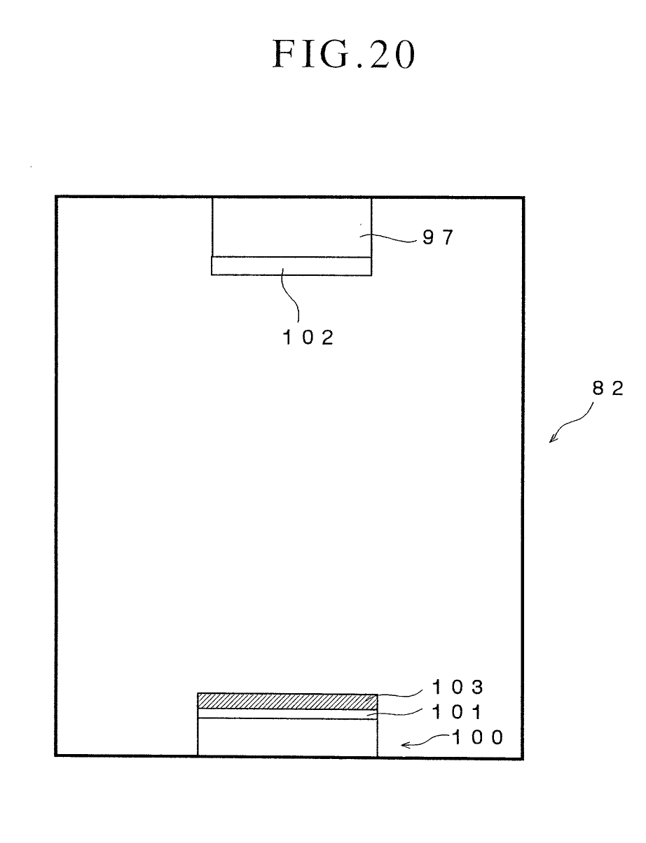

FIG. 20 is a schematic vertical cross sectional view showing the dark box 82 of the data producing system.

As shown in FIG. 20, the dark box 82 is equipped with a light emitting diode stimulating ray source 100 for emitting a stimulating ray. The light emitting diode stimulating ray source 100 is provided with a filter 101 detachably mounted thereon and a diffusion plate 102 mounted on the upper surface of the filter 101. The stimulating ray is emitted via the diffusion plate 102 toward a biochemical analysis unit (not shown) placed on the diffusion plate 102 so as to ensure that the biochemical analysis unit can be uniformly irradiated with the stimulating ray. The filter 101 has a property of cutting light components having a wavelength not close to that of the stimulating ray and harmful to the stimulation of a fluorescent substance and transmitting through only light components having a wavelength in the vicinity of that of the stimulating ray. A filter 102 for cutting light components having a wavelength in the vicinity of that of the stimulating ray is detachably provided on the front surface of the camera lens 97.

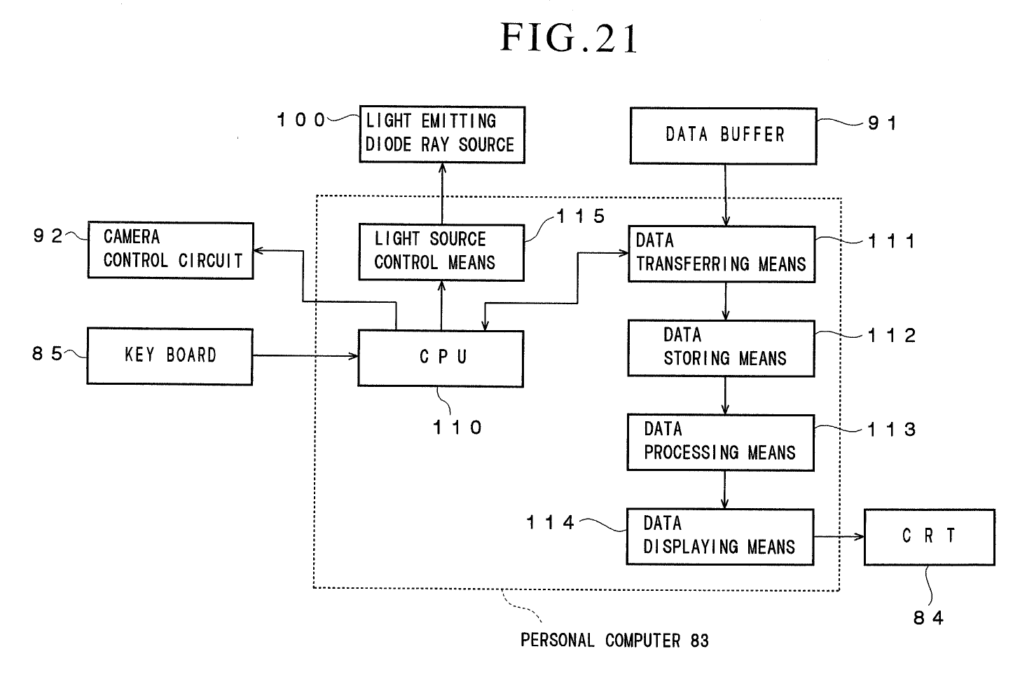

FIG. 21 is a block diagram of the personal computer 83 of the data producing system and peripheral devices thereof.

As shown in FIG. 21, the personal computer 83 includes a CPU 110 for controlling the exposure of the cooled CCD camera 81, a data transferring means 111 for reading the data produced by the cooled CCD camera 81 from the data buffer 91, a storing means 112 for storing data, a data processing means 113 for effecting data processing on the digital data stored in the data storing means 112, and a data displaying means 114 for displaying visual data on the screen of the CRT 84 based on the digital data stored in the data storing means 112. The light emitting diode stimulating ray source 100 is controlled by a light source control means 115 and an instruction signal can be input via the CPU 110 to the light source control means 115 through the keyboard 85. The CPU 110 is constituted so as to output various signals to the camera controlling circuit 93 of the cooled CCD camera 81.

The data producing system shown in FIGS. 18 to 21 is constituted so as to detect chemiluminescence emission generated by the contact of a labeling substance contained in a number of the absorptive regions 5 formed in the biochemical analysis unit 1 and a chemiluminescent substrate, with the CCD 86 of the cooled CCD camera 81 through a camera lens 97, thereby reading chemiluminescence data to produce biochemical analysis data, and irradiate the biochemical analysis unit 1 with a stimulating ray emitted from the light emitting diode stimulating ray source 100 and detect fluorescence emission released from a fluorescent substance such as a fluorescent dye contained in a number of the absorptive regions 5 formed in the biochemical analysis unit 1 upon being stimulated, with the CCD 86 of the cooled CCD camera 81 through a camera lens 97, thereby reading fluorescence data to produce biochemical analysis data.

When biochemical analysis data are to be produced by reading chemiluminescence data, the filter 102 is removed and while the light emitting diode stimulating ray source 100 is kept off, the biochemical analysis unit 1 is placed on the diffusion plate 103. At this time, the biochemical analysis unit 1 is releasing chemiluminescence emission as a result of contact of a labeling substance contained in a number of the absorptive regions 5 formed in the biochemical analysis unit 1 and a chemiluminescent substrate.

The lens focus is then adjusted by the user using the camera lens 97 and the dark box 92 is closed.

When an exposure start signal is input by the user through the keyboard 85, the exposure start signal is input through the CPU 110 to the camera control circuit 92 of the cooled CCD camera 81 so that the shutter 88 is opened by the camera control circuit 92, whereby the exposure of the CCD 86 is started.

Chemiluminescence emission released from a number of the absorptive regions 5 of the biochemical analysis unit 1 impinges on the light receiving surface of the CCD 86 of the cooled CCD camera 81 via the camera lens 97, thereby forming an image on the light receiving surface. The CCD 86 receives light of the thus formed image and accumulates it in the form of electric charges therein.

In this embodiment, since the aluminum strips 2 capable of attenuating light energy are present around each of the absorptive regions 5 formed in the biochemical analysis unit 1, it is possible to reliably prevent chemiluminescence emission released from the labeling substance contained in each of the absorptive regions 5 from being mixed with chemiluminescence emission released from a labeling substance contained in the neighboring absorptive regions 5.

When a predetermined exposure time has passed, the CPU 110 outputs an exposure completion signal to the camera control circuit 92 of the cooled CCD camera 81.

When the camera controlling circuit 92 receives the exposure completion signal from the CPU 110, it transfers analog data accumulated in the CCD 86 in the form of electric charge to the A/D converter 90 to cause the A/D converter 90 to digitize the data and to temporarily store the thus digitized data in the data buffer 91.

At the same time, the CPU 110 outputs a data transfer signal to the data transferring means 111 to cause it to read out the digital data from the data buffer 91 of the cooled CCD camera 81 and to input them to the data storing means 112.

When the user inputs a data producing signal through the keyboard 85, the CPU 110 outputs the digital data stored in the data storing means 112 to the data processing means 113 and causes the data processing means 113 to effect data processing on the digital data in accordance with the user's instructions. The CPU 110 then outputs a data display signal to the displaying means 114 and causes the displaying means 114 to display biochemical analysis data on the screen of the CRT 84 based on the thus processed digital data.

On the other hand, when biochemical analysis data are to be produced by reading fluorescence data, the biochemical analysis unit 1 is first placed on the diffusion plate 103.

The light emitting diode stimulating ray source 100 is then turned on by the user and the lens focus is adjusted using the camera lens 97. The dark box 92 is then closed.

When the user inputs an exposure start signal through the keyboard 85, the light emitting diode stimulating ray source 100 is again turned on by the light source control means 115, thereby emitting a stimulating ray toward the biochemical analysis unit 1.

At the same time, the exposure start signal is input via the CPU 110 to the camera control circuit 92 of the cooled CCD camera 81 and the shutter 89 is opened by the camera control circuit 92, whereby the exposure of the CCD 86 is started.

The stimulating ray emitted from the light emitting diode stimulating ray source 100 passes through the filter 101, whereby light components of wavelengths not in the vicinity of that of the stimulating ray are cut. The stimulating ray then passes through the diffusion plate 103 to be made uniform light and the biochemical analysis unit 1 is irradiated with the uniform stimulating ray.

When the biochemical analysis unit 1 is irradiated with the stimulating ray, a fluorescent substance such as a fluorescent dye contained in a number of the absorptive regions 5 of the biochemical analysis unit 1 is stimulated by the stimulating ray, thereby releasing fluorescence emission from a number of the absorptive regions 5 of the biochemical analysis unit 1.

The fluorescence emission released from a number of the absorptive regions 5 of the biochemical analysis unit 1 impinges on the light receiving surface of the CCD 86 of the cooled CCD camera 81 through the filter 102 and the camera lens 97 and forms an image thereon. The CCD 86 receives light of the thus formed image and accumulates it in the form of electric charges therein. Since light components of wavelength equal to the stimulating ray wavelength are cut by the filter 102, only fluorescence emission released from the fluorescent substance such as a fluorescent dye contained in a number of the absorptive regions 5 of the biochemical analysis unit 1 is received by the CCD 86.

In this embodiment, since the aluminum strips 2 capable of attenuating light energy are present around each of the absorptive regions 5 formed in the biochemical analysis unit 1, it is possible to reliably prevent fluorescence emission released from a fluorescent substance contained in each of the absorptive regions 5 from being mixed with fluorescence emission released from a fluorescent substance contained in the neighboring absorptive regions 5.

When a predetermined exposure time has passed, the CPU 110 outputs an exposure completion signal to the camera control circuit 92 of the cooled CCD camera 81.

When the camera controlling circuit 92 receives the exposure completion signal from the CPU 110, it transfers analog data accumulated in the CCD 86 in the form of electric charge to the A/D converter 90 to cause the A/D converter 90 to digitize the data and to temporarily store the thus digitized data in the data buffer 91.

At the same time, the CPU 110 outputs a data transfer signal to the data transferring means 111 to cause it to read out the digital data from the data buffer 91 of the cooled CCD camera 81 and to input them to the data storing means 112.

When the user inputs a data producing signal through the keyboard 85, the CPU 110 outputs the digital data stored in the data storing means 112 to the data processing apparatus 113 and causes the data processing apparatus 113 to effect data processing on the digital data in accordance with the user's instructions. The CPU 110 then outputs a data display signal to the displaying means 114 and causes the displaying means 114 to display biochemical analysis data on the screen of the CRT 84 based on the thus processed digital data.

When the production of biochemical analysis data has been completed in this manner, the biochemical analysis unit 1 is washed.

In this embodiment, specific binding substances are absorbed in the absorptive regions 5 formed of the absorptive strips 3 and a substance derived from a living organism and labeled with the labeling substances is hybridized with the specific binding substances contained in the absorptive regions 5. Therefore, when the biochemical analysis unit 1 is to be washed, it is sufficient to wash only the absorptive regions 5 and since each of the absorptive regions 5 has a large surface area, it is possible to efficiently wash the biochemical analysis unit 1 for reuse.

According to this embodiment, since the aluminum strips 2 capable of attenuating radiation energy are present around each of the absorptive regions 5 formed in the biochemical analysis unit 1, when a number of the stimulable phosphor layer regions 12 formed on the support 11 of the stimulable phosphor sheet 10 are exposed to a radioactive labeling substance contained in a number of the absorptive regions 5 of the biochemical analysis unit 1, electron beams (β rays) released from the radioactive labeling substance contained in the absorptive regions 5 of the biochemical analysis unit 1 can be efficiently prevented from scattering in the biochemical analysis unit 1. Further, since the support 11 of the stimulable phosphor sheet 10 is made of stainless steel capable of attenuating radiation energy and the stimulable phosphor sheet 10 is superposed on the biochemical analysis unit 1 in such a manner that each of the stimulable phosphor layer regions 12 formed on the support 11 of the stimulable phosphor sheet 11 accurately faces the corresponding absorptive region 5 formed in the biochemical analysis unit 1, thereby exposing the stimulable phosphor layer regions 12, electron beams (β rays) released from the radioactive labeling substance contained in the absorptive regions 5 of the biochemical analysis unit 1 can be efficiently prevented from scattering in the support 11 of the stimulable phosphor sheet 10 and impinging on the stimulable phosphor layer regions 12 neighboring absorptive regions 5 face. Therefore, even in the case where the absorptive regions 5 are formed in the biochemical analysis unit 1 at high density, since it is possible to selectively expose the stimulable phosphor layer regions 12 formed on the support 11 of the stimulable phosphor sheet 10 to only a radioactive labeling substance contained in the corresponding absorptive regions 5 of the biochemical analysis unit 1, it is possible to effectively prevent noise caused by the scattering of electron beams (β rays) from being generated in biochemical analysis data and to markedly improve the quantitative accuracy of biochemical analysis.

Further, according to this embodiment, since a number of the absorptive regions 5 are formed in the absorptive strips 3 and the aluminum strips 2 capable of attenuating light energy are present around each of the absorptive regions 5, when a number of the stimulable phosphor layer regions 17 formed in the stimulable phosphor sheet 15 are exposed to chemiluminescence emission selectively released from a number of the absorptive regions 5 formed in the biochemical analysis unit 1, chemiluminescence emission selectively released from a number of the absorptive regions 5 formed in the biochemical analysis unit 1 can be effectively prevented from scattering in the biochemical analysis unit 1. Moreover, since a number of the stimulable phosphor layer regions 17 of the stimulable phosphor sheet 15 are formed on the surface of the support 11 made of stainless steel capable of attenuating light energy in the same regular pattern as that of a number of the absorptive regions 5 formed in the biochemical analysis unit 1 and the stimulable phosphor sheet 15 is superposed on the biochemical analysis unit 1 in such a manner that each of the stimulable phosphor layer regions 17 accurately faces the corresponding absorptive region 5 in the biochemical analysis unit 1, chemiluminescence emission released from the absorptive regions 5 of the biochemical analysis unit 1 can be effectively prevented from scattering in the support 11 of the stimulable phosphor sheet 15. Therefore, since it is possible to selectively expose only the stimulable phosphor layer region 17 each of the absorptive regions 5 faces to the chemiluminescence emission released from each of the absorptive regions 5, it is possible to prevent noise from being generated in biochemical analysis data produced by exciting stimulable phosphor contained in the stimulable phosphor layer regions 17 of the stimulable phosphor sheet 15 and photoelectrically detecting stimulated emission 45 released from the stimulable phosphor layer regions 17 of the stimulable phosphor sheet 15 and to produce biochemical analysis data having a high quantitative accuracy.

Furthermore, according to this embodiment, since a number of the absorptive regions 5 are formed in the absorptive strips 3 and the aluminum strips 2 capable of attenuating light energy are present around each of the absorptive regions 5, when fluorescence data are read by scanning a number of the absorptive regions 5 of the biochemical analysis unit 1 to produce biochemical analysis data, it is possible to effectively prevent the laser beam 24 from scattering in each of the absorptive regions 5 and entering the neighboring absorptive regions 5 to excite a fluorescent substance contained in the neighboring absorptive regions 5. Therefore, biochemical analysis data having a high quantitative accuracy can be produced.

Moreover, according to this embodiment, since a number of the absorptive regions 5 are formed in the absorptive strips 3 and the aluminum strips 2 capable of attenuating light energy are present around each of the absorptive regions 5, fluorescence emission released from a fluorescent substance such as a fluorescent dye by being irradiated with a laser beam 24 or a stimulating ray emitted from the stimulating ray source 100 and excited thereby can be effectively prevented from scattering in the biochemical analysis unit 1 and being mixed with fluorescence emission released from a fluorescent substance such as a fluorescent dye contained in neighboring absorptive regions 5. Therefore, even in the case where the absorptive regions 5 are formed in the biochemical analysis unit 1 at high density, it is possible to effectively prevent noise caused by the scattering of fluorescence emission from being generated in biochemical analysis data produced by photoelectrically detecting fluorescence emission and to improve the quantitative accuracy of biochemical analysis.

Further, according to this embodiment, since a number of the absorptive regions 5 are formed in the absorptive strips 3 and the aluminum strips 2 capable of attenuating light energy are present around each of the absorptive regions 5, when chemiluminescence emission released from a number of the absorptive regions 5 of the biochemical analysis unit 1 is photoelectrically detected by the cooled CCD camera 81 of the data producing system to produce biochemical analysis data, chemiluminescence emission released from the absorptive regions 5 of the biochemical analysis unit 1 can be effectively prevented from scattering in the biochemical analysis unit 1 and chemiluminescence emission released from neighboring absorptive regions 5 can be effectively prevented from being mixed with each other. Therefore, even in the case where the absorptive regions 5 are formed in the biochemical analysis unit 1 at high density, it is possible to effectively prevent noise caused by the scattering of chemiluminescence emission from being generated in biochemical analysis data produced by photoelectrically detecting chemiluminescence emission and to improve the quantitative accuracy of biochemical analysis.

Furthermore, according to this embodiment, since specific binding substances as a probe are absorbed in the absorptive regions 5 and absorbed in a region having a small volume, the rate of hybridization reaction can be improved. Further, since the hybridization reaction solution 9 can be brought into contact with the absorptive regions 5 having a large surface area, it is possible to increase the probability of a substance derived from a living organism as a target associating with the specific binding substances absorbed in the absorptive regions 5. Therefore, the efficiency of hybridization can be markedly improved.

Moreover, according to this embodiment, since specific binding substances are absorbed in the absorptive regions 5 formed of the absorptive strips 3 and a substance derived from a living organism and labeled with the labeling substances is hybridized with the specific binding substances contained in the absorptive regions 5, when the biochemical analysis unit 1 is to be washed, it is sufficient to wash only the absorptive regions 5. Further, since each of the absorptive regions 5 has a large surface area, it is possible to efficiently wash the biochemical analysis unit 1 for reuse.

Further, according to this embodiment, since 90% or more of the biochemical analysis unit 1 is formed of the aluminum strips 2, the biochemical analysis unit 1 does not substantially stretch or shrink when it is subjected to liquid processing such as hybridization and, therefore, it is possible to easily and accurately superpose the stimulable phosphor sheet 10, 15 on the biochemical analysis unit 1 so that each of the stimulable phosphor layer regions 12, 17 formed in the stimulable 15 phosphor sheet 10, 15 accurately faces the corresponding absorptive region 5 formed in the biochemical analysis unit 1, thereby exposing the stimulable phosphor layer regions 12, 17.

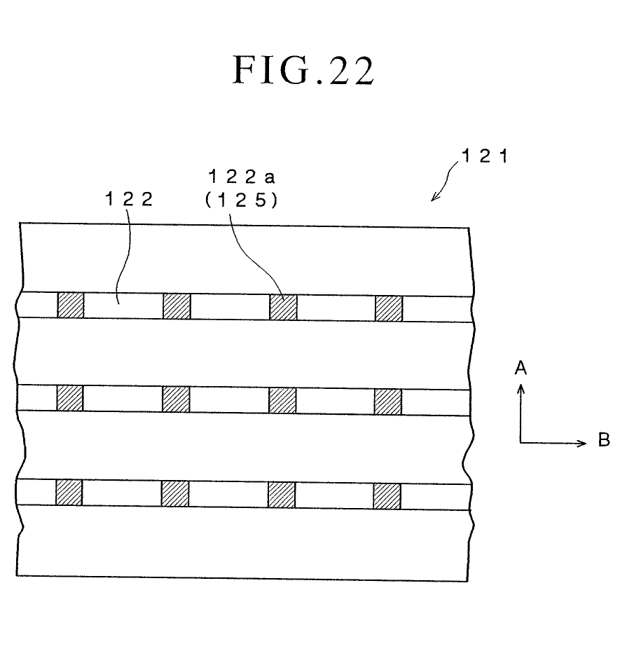

FIG. 22 is a schematic partial plan view of a biochemical analysis unit which is another preferred embodiment of the present invention.

As shown in FIG. 22, a biochemical analysis unit 121 according to this embodiment is formed by weaving a plurality of aluminum sheets 122 capable of attenuating radiation energy and light energy, each of which is formed with a roughened absorptive stripe (not shown in FIG. 22), a plurality of aluminum sheets, and a plurality of aluminum strips (not shown in FIG. 22).

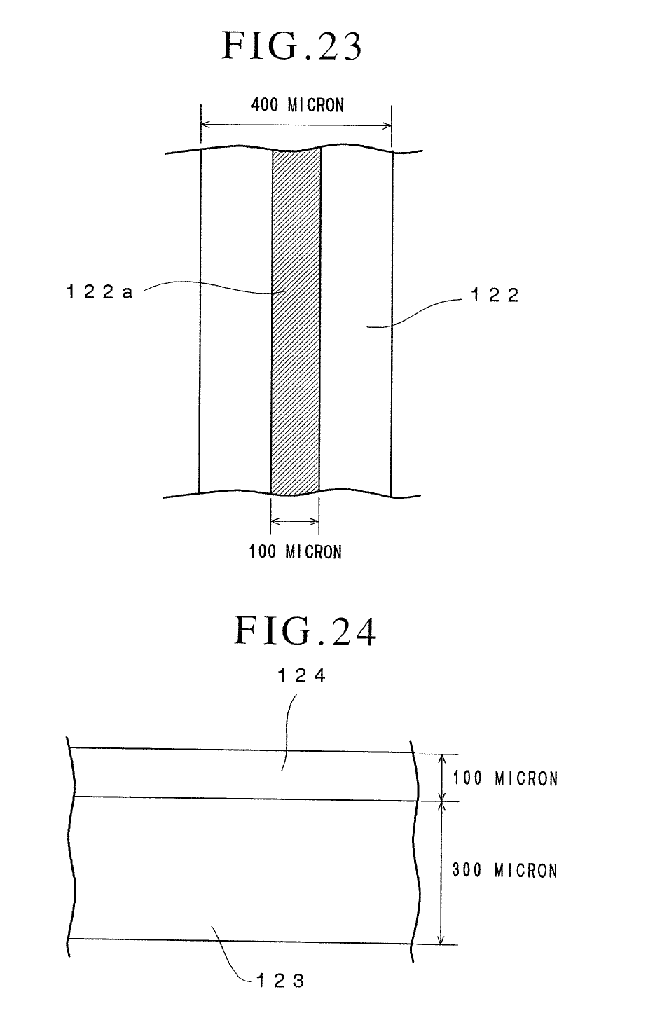

FIG. 23 is schematic plan view showing one of the aluminum sheets 122 extending in a direction indicated by an arrow A in FIG. 22

As shown in FIG. 23, each of the aluminum sheets 122 has a width of 400 microns and is formed with an absorptive stripe 122a having a width of 100 microns on the surface thereof in the longitudinal direction thereof.

FIG. 24 is schematic plan view showing a repetition unit in a direction indicated by an arrow B in FIG. 22 of an aluminum sheet extending in the direction indicated by the arrow B and an aluminum strip.

As shown in FIG. 24, the repetition unit extending in the direction indicated by the arrow B is constituted by an aluminum sheet 123 having a width of 300 microns and an aluminum strip 124 having a width of 100 microns.

The biochemical analysis unit 121 according to this embodiment is formed by weaving the plurality of aluminum sheets 122, each having a width of 400 microns and being formed with the absorptive stripes 122a having a width of 100 microns on the surface thereof in a longitudinal direction thereof, and a plurality of the repetition units, each extending in the direction indicated by the arrow B and being constituted by the aluminum sheet 123 having a width of 300 microns and the aluminum strip 124 having a width of 100 microns, so that the absorptive stripes 122a formed on the aluminum sheets 122 are located above the aluminum strips 124 having a width of 100 microns and below the aluminum sheets 123 having a width of 300 microns.

Therefore, the biochemical analysis unit 121 is formed by the absorptive stripes 122a with a number of absorptive regions 125, each having a size of 100 microns×100 microns, so as to be spaced from each other at a pitch of 400 microns in the direction indicated by the arrow A and the direction indicated by the arrow B in FIG. 22 and a portion of the aluminum sheets 122 having a width of 300 microns and formed with no absorptive stripe 122a, and the aluminum sheet 123 having a width of 300 microns are present between neighboring absorptive regions 125.

In this embodiment, the surface of each of the absorptive stripes 122a is roughened so as to have a fractal structure.

Similarly to the biochemical analysis unit 1 shown in FIG. 1, in this embodiment, a solution containing specific binding substances such as cDNAs is spotted onto the plurality of absorptive regions 125, whereby the specific binding substances are absorbed therein.

In the biochemical analysis unit 121 according to this embodiment, since the surface of each of the absorptive regions 125 is processed so as to have a fractal structure, thereby increasing the surface area thereof, a sufficient amount of specific binding substances can be absorbed in each of the absorptive regions 125.

Further, as shown in FIG. 3, the biochemical analysis unit 121 is set in the hybridization reaction vessel 8 accommodating a hybridization reaction solution 9 containing a substance derived from a living organism and labeled with a radioactive labeling substance. a substance derived from a living organism and labeled with a fluorescent substance such as a fluorescent dye and a substance derived from a living organism and labeled with a labeling substance which generates chemiluminescence emission when it contacts a chemiluminescent substrate. As a result, specific binding substances absorbed in a number of the absorptive regions 125 can be selectively hybridized with a substance derived from a living organism, labeled with a radioactive labeling substance and contained in the hybridization reaction solution 9, a substance derived from a living organism, labeled with a fluorescent substance such as a fluorescent dye and contained in the hybridization reaction solution 9, and a substance derived from a living organism, labeled with a labeling substance which generates chemiluminescence emission when it contacts a chemiluminescent substrate and contained in the hybridization reaction solution 9.

Thus, radiation data, fluorescence data and chemiluminescence data are recorded in a number of the absorptive regions 125 of the biochemical analysis unit 121.

Similarly to the previous embodiment, fluorescence data recorded in a number of the absorptive regions 125 of the biochemical analysis unit 121 are read by the scanner shown in FIGS. 6 to 13 or the cooled CCD camera 81 of the data producing system shown in FIGS. 18 to 21 to produce biochemical analysis data.

To the contrary, radiation data recorded in a number of the absorptive regions 125 of the biochemical analysis unit 121 are transferred onto a number of the stimulable phosphor layer regions 12 of the stimulable phosphor sheet 10 shown in FIG. 4.

Specifically, similarly to what is shown in FIG. 5, the stimulable phosphor sheet 10 is superposed on the biochemical analysis unit 121 in such a manner that each of the stimulable phosphor layer regions 12 formed on the support 11 of the stimulable phosphor sheet 10 faces the corresponding absorptive region 125 formed in the biochemical analysis unit 121, thereby exposing a number of the stimulable phosphor layer regions 12 formed on the support 11 of the stimulable phosphor sheet 10 to a radioactive labeling substance contained in a number of the absorptive regions 125 of the biochemical analysis unit 1.

Radiation data thus transferred onto a number of the stimulable phosphor layer regions 12 formed on the support 11 of the stimulable phosphor sheet 10 are read, similarly to the previous embodiment, by the scanner shown in FIGS. 6 to 13 to produce biochemical analysis data.

On the other hand, similarly to the previous embodiment, chemiluminescence data recorded in a number of the absorptive regions 125 of the biochemical analysis unit 121 are transferred onto a number of the stimulable phosphor layer regions 17 of the stimulable phosphor sheet 15 shown in FIG. 14 and read by the scanner shown in FIGS. 15 to 17 to produce biochemical analysis data or read by the cooled CCD camera 81 of the data producing system shown in FIGS. 18 to 21 to produce biochemical analysis data.

According to this embodiment, since the aluminum sheet 122 or the aluminum sheet 124 capable of attenuating radiation energy is present between neighboring absorptive regions 125 formed in the biochemical analysis unit 1, when a number of the stimulable phosphor layer regions 12 formed on the support 11 of the stimulable phosphor sheet 10 are exposed to a radioactive labeling substance contained in a number of the absorptive regions 125 of the biochemical analysis unit 121, electron beams (β rays) released from the absorptive regions 125 of the biochemical analysis unit 121 can be efficiently prevented from scattering in the biochemical analysis unit 121. Further, since the support 11 of the stimulable phosphor sheet 10 is made of stainless steel capable of attenuating radiation energy and the stimulable phosphor sheet 10 is superposed on the biochemical analysis unit 121 in such a manner that each of the stimulable phosphor layer regions 12 formed on the support 11 of the stimulable phosphor sheet 11 faces the corresponding absorptive region 125 formed in the biochemical analysis unit 121, thereby exposing the stimulable phosphor layer regions 12, electron beams (β rays) released from the radioactive labeling substance contained in the absorptive regions 125 of the biochemical analysis unit 121 can be efficiently prevented from scattering in the support 11 of the stimulable phosphor sheet 10 and impinging on the stimulable phosphor layer regions 12 neighboring absorptive regions 125 face. Therefore, even in the case where the absorptive regions 125 are formed in the biochemical analysis unit 121 at high density, since it is possible to selectively expose the stimulable phosphor layer regions 12 formed on the support 11 of the stimulable phosphor sheet 10 to only a radioactive labeling substance contained in the corresponding absorptive regions 125 of the biochemical analysis unit 121, it is possible to effectively prevent noise caused by the scattering of electron beams (β rays) from being generated in biochemical analysis data and to markedly improve the quantitative accuracy of biochemical analysis.

Further, according to this embodiment, since specific binding substances as a probe are absorbed in the absorptive regions 125 and absorbed in a region having a small volume, the rate of hybridization reaction can be improved. Further, since the hybridization reaction solution 9 can be brought into contact with the absorptive regions 125 having a large surface area, it is possible to increase the probability of a substance derived from a living organism as a target associating with the specific binding substances absorbed in the absorptive regions 125. Therefore, the efficiency of hybridization can be markedly improved.

Moreover, according to this embodiment, since specific binding substances are absorbed in the absorptive regions 125 and a substance derived from a living organism and labeled with the labeling substances is hybridized with the specific binding substances contained in the absorptive regions 125, when the biochemical analysis unit 1 is to be washed, it is sufficient to wash only the absorptive regions 125. Further, since each of the absorptive regions 125 has a large surface area, it is possible to efficiently wash the biochemical analysis unit 121 for reuse.

Further, according to this embodiment, since the surface of each of the absorptive stripes 122a is processed so as to have a fractal structure and the surface area thereof is increased, a sufficient amount of the specific binding substance can be absorbed in each of the absorptive regions 125.

The present invention has thus been shown and described with reference to specific embodiments. However, it should be noted that the present invention is in no way limited to the details of the described arrangements but changes and modifications may be made without departing from the scope of the appended claims.

For example, in the above-described embodiments, as specific binding substances, cDNAs each of which has a known base sequence and is different from the others are used. However, specific binding substances usable in the present invention are not limited to cDNAs but all specific binding substances capable of specifically binding with a substance derived from a living organism such as a cell, virus, hormone, tumor marker, enzyme, antibody, antigen, abzyme, other protein, a nuclear acid, cDNA, DNA, RNA or the like and whose sequence, base length, composition and the like are known, can be employed in the present invention as a specific binding substance.

Further, in the above-described embodiments, although the aluminum strips 2 are used in the embodiment shown in FIG. 1 and the aluminum sheets 122, the aluminum strips 123 and the aluminum sheets 124 are used in the embodiment shown in FIG. 22, it is not absolutely necessary to form the strips 2, the sheets 122, the strips 123 and the sheets 124 of the biochemical analysis unit 1 and the biochemical analysis unit 121 of aluminum and the strips 2, the sheets 122, the strips 123 and the sheets 124 of the biochemical analysis unit 1 and the biochemical analysis unit 121 may be formed of any material insofar as it can attenuate radiation energy and/or light energy. The material usable for forming the strips 2, the sheets 122, the strips 123 and the sheets 124 of the biochemical analysis unit 1 and the biochemical analysis unit 121 and capable of attenuating radiation energy and/or light energy is not particularly limited but may be any type of inorganic compound material or organic compound material. A metal material, a ceramic material or a plastic material is preferably used for forming the strips 2, the sheets 122, the strips 123 and the sheets 124 of the biochemical analysis unit 1 and the biochemical analysis unit 121. Illustrative examples of inorganic compound materials preferably usable for forming the strips 2, the sheets 122, the strips 123 and the sheets 124 of the biochemical analysis unit 1 and the biochemical analysis unit 121 and capable of attenuating radiation energy and/or light energy include metals such as gold, silver, copper, zinc, aluminum, titanium, tantalum, chromium, iron, nickel, cobalt, lead, tin, selenium and the like; alloys such as brass, stainless steel, bronze and the like; silicon materials such as silicon, amorphous silicon, glass, quartz, silicon carbide, silicon nitride and the like; metal oxides such as aluminum oxide, magnesium oxide, zirconium oxide and the like; and inorganic salts such as tungsten carbide, calcium carbide, calcium sulfate, hydroxy apatite, gallium arsenide and the like. These may have either a monocrystal structure or a polycrystal sintered structure such as amorphous, ceramic or the like. A high molecular compound is preferably used as an organic compound material preferably usable for forming the strips 2, the sheets 122, the strips 123 and the sheets 124 of the biochemical analysis unit 1 and the biochemical analysis unit 121 and capable of attenuating radiation energy and/or light energy. Illustrative examples of high molecular compounds preferably usable for forming the strips 2, the sheets 122, the strips 123 and the sheets 124 of the biochemical analysis unit 1 and the biochemical analysis unit 121 include polyolefins such as polyethylene, polypropylene and the like; acrylic resins such as polymethyl methacrylate, polybutylacrylate/polymethyl methacrylate copolymer and the like; polyacrylonitrile; polyvinyl chloride; polyvinylidene chloride; polyvinylidene fluoride; polytetrafluoroethylene; polychlorotrifuluoroethylene; polycarbonate; polyesters such as polyethylene naphthalate, polyethylene terephthalate and the like; nylons such as nylon-6, nylon-6,6, nylon-4,10 and the like; polyimide; polysulfone; polyphenylene sulfide; silicon resins such as polydiphenyl siloxane and the like; phenol resins such as novolac and the like; epoxy resin; polyurethane; polystyrene, butadiene-styrene copolymer; polysaccharides such as cellulose, acetyl cellulose, nitrocellulose, starch, calcium alginate, hydroxypropyl methyl cellulose and the like; chitin; chitosan; urushi (Japanese lacquer); polyamides such as gelatin, collagen, keratin and the like; and copolymers of these high molecular materials. These may be a composite compound, and metal oxide particles, glass fiber or the like may be added thereto as occasion demands. Further, an organic compound material may be blended therewith.

Furthermore, in the above described embodiments, the strips 2, the sheets 122, the strips 123 and the sheets 124 of the biochemical analysis unit 1 and the biochemical analysis unit 121 are formed of aluminum capable of attenuating radiation energy and light energy. However, it is not absolutely necessary to form the strips 2, the sheets 122, the strips 123 and the sheets 124 of the biochemical analysis unit 1 and the biochemical analysis unit 121 of a material capable of attenuating both radiation energy and light energy. In the case where biochemical analysis data are produced by reading only radiation data recorded in a number of the stimulable phosphor layer regions 12 of the stimulable phosphor sheet 10, the strips 2, the sheets 122, the strips 123 and the sheets 124 of the biochemical analysis unit 1 and the biochemical analysis unit 121 may be formed of a material having a property of transmitting light but attenuating radiation energy. On the other hand, in the case where biochemical analysis data are produced by reading only chemiluminescence data or fluorescence data, the strips 2, the sheets 122, the strips 123 and the sheets 124 of the biochemical analysis unit 1 and the biochemical analysis unit 121 may be formed of a material having a property of transmitting radiation but attenuating light energy.

Moreover, in the embodiment shown in FIG. 1 and the embodiment shown in FIG. 22, although the biochemical analysis unit 1 and the biochemical analysis unit 121 include a number of the square absorptive regions 5, 125 having a size of 100 microns×100 microns and two-dimensionally formed at a pitch of 400 microns, it is not absolutely necessary to form each of the absorptive regions 5, 125 to be square and each of the absorptive regions 5, 125 may be formed to have an arbitrary shape using textile technique.

Further, in the embodiment shown in FIG. 1 and the embodiment shown in FIG. 22, although the biochemical analysis unit 1 and the biochemical analysis unit 121 include a number of the square absorptive regions 5, 125 having a size of 100 microns×100 microns and two-dimensionally formed at a pitch of 400 microns, it is not absolutely necessary to form each of the absorptive regions 5, 125 to have a size of 100 microns×100 microns and the size of each the absorptive regions 5, 125 may be arbitrarily determined. Each the absorptive regions 5, 125 is preferably formed to have a size of 5 mm² or less.

Furthermore, in the embodiment shown in FIG. 1 and the embodiment shown in FIG. 22, although the biochemical analysis unit 1 and the biochemical analysis unit 121 include a number of the square absorptive regions 5, 125 having a size of 100 microns×100 microns and two-dimensionally formed at a pitch of 400 microns, it is not absolutely necessary to two-dimensionally form a number of the absorptive regions 5, 125 at a pitch of 400 microns but a number of the absorptive regions 5, 125 can be formed at arbitrary density. Preferably, 10 or more of the absorptive regions 5, 125 are formed in the biochemical analysis unit 1 and the biochemical analysis unit 121 at a density of 10/cm² or greater.

Moreover, in the embodiment shown in FIG. 1 and the embodiment shown in FIG. 22, although the biochemical analysis unit 1 and the biochemical analysis unit 121 include a number of the square absorptive regions 5, 125 having a size of 100 microns×100 microns and two-dimensionally formed at a pitch of 400 microns, it is not absolutely necessary to regularly form a number of the absorptive regions 5, 125.

Further, in the above described embodiments, a hybridization reaction solution 9 containing a substance derived from a living organism and labeled with a radioactive labeling substance, a substance derived from a living organism and labeled with a labeling substance which generates chemiluminescence emission when it contacts a chemiluminescent substrate and a substance derived from a living organism and labeled with a fluorescent substance such as a fluorescent dye is prepared. However, it is not absolutely necessary for the hybridization reaction solution 9 to contain a substance derived from a living organism and labeled with a radioactive labeling substance, a substance derived from a living organism and labeled with a labeling substance which generates chemiluminescence emission when it contacts a chemiluminescent substrate and a substance derived from a living organism and labeled with a fluorescent substance such as a fluorescent dye but it is sufficient for the hybridization reaction solution 9 to contain a substance derived from a living organism and labeled with at least one labeling substance selected from a group consisting of a radioactive labeling substance, a labeling substance which generates chemiluminescence emission when it contacts a chemiluminescent substrate, and a fluorescent substance.

Furthermore, in the above described embodiments, specific binding substances are hybridized with substances derived from a living organism and labeled with a radioactive labeling substance, a labeling substance which generates chemiluminescence emission when it contacts a chemiluminescent substrate, and a fluorescent substance. However, it is not absolutely necessary to hybridize substances derived from a living organism with specific binding substances and substances derived from a living organism may be specifically bound with specific binding substances by means of antigen-antibody reaction, receptor-ligand reaction or the like instead of hybridization.

Moreover, in the above described embodiments, a number of substantially circular stimulable phosphor layer regions 12, 17 are regularly formed on one surface of the support 11 of the stimulable phosphor sheet 10, 15 in the same pattern as that of a number of the absorptive regions 5, 125 formed in the biochemical analysis unit 1, 121 so that each of them has a size larger than that of each of the absorptive regions 5, 125. However, it is not absolutely necessary to form a number of the stimulable phosphor layer regions 12, 17 on one surface of the support 11 of the stimulable phosphor sheet 10, 15 but a stimulable phosphor layer may be uniformly formed on one surface of the support 11 of the stimulable phosphor sheet 10, 15.

Further, in the above described embodiments, a number of substantially circular stimulable phosphor layer regions 12, 17 are regularly formed on one surface of the support 11 of the stimulable phosphor sheet 10, 15 in the same pattern as that of a number of the absorptive regions 5, 125 formed in the biochemical analysis unit 1, 121 so that each of them has a size larger than that of each of the absorptive regions 5, 125. However, it is sufficient for a number of the stimulable phosphor layer regions 12, 17 to be formed in the same pattern as that of a number of the absorptive regions 5, 125 formed in the biochemical analysis unit 1, 121 and it is not absolutely necessary to regularly form a number of the stimulable phosphor layer regions 12, 17.

Moreover, in the above described embodiments, a number of substantially circular stimulable phosphor layer regions 12, 17 are regularly formed on one surface of the support 11 of the stimulable phosphor sheet 10, 15 in the same pattern as that of a number of the absorptive regions 5, 125 formed in the biochemical analysis unit 1, 121 so that each of them has a size larger than that of each of the absorptive regions 5, 125. However, the shape of each of the stimulable phosphor layer regions 12, 17 is not limited to substantially a circular shape but may be formed in an arbitrary shape, for example, a square shape or a rectangular shape.

Furthermore, in the above described embodiments, a number of substantially circular stimulable phosphor layer regions 12, 17 are regularly formed on one surface of the support 11 of the stimulable phosphor sheet 10, 15 in the same pattern as that of a number of the absorptive regions 5, 125 formed in the biochemical analysis unit 1, 121 so that each of them has a size larger than that of each of the absorptive regions 5, 125. However, it is not absolutely necessary to form each of the stimulable phosphor layer regions 12, 17 to be larger than each of the absorptive regions 5, 125 but the size of each of the stimulable phosphor layer regions 12, 17 can be arbitrarily determined in accordance with the purpose. Preferably, each of the stimulable phosphor layer regions 12, 17 is formed so as to have a size equal to or larger than that of each of the absorptive regions 5, 125.

Moreover, in the above described embodiments, although a number of the stimulable phosphor layer regions 12, 17 of the stimulable phosphor sheet 10, 15 are formed on the surface of the support 11, it is not absolutely necessary to form a number of the stimulable phosphor layer regions 12, 17 on the surface of the support 11. A number of the stimulable phosphor layer regions 12, 17 may be formed by charging or embedding stimulable phosphor in a number of through-holes formed in the support 11 or may be formed by charging or embedding stimulable phosphor in a number of recesses formed in the support 11.

Further, in the above described embodiments, although the support 11 of the stimulable phosphor sheet 10, 15 is made of stainless steel, it is not absolutely necessary to make the support 11 of the stimulable phosphor sheet 10, 15 of stainless steel but the support 11 of the stimulable phosphor sheet 10, 15 may be made of other material. The support 11 of the stimulable phosphor sheet 10, 15 is preferably made of material capable of attenuating radiation energy and/or light energy but the material for forming the support 11 of the stimulable phosphor sheet 10, 15 is not particularly limited. The support 11 of the stimulable phosphor sheet 10, 15 can be formed of either inorganic compound material or organic compound material and is preferably formed of metal material, ceramic material or plastic material. Illustrative examples of inorganic compound materials usable for forming the support 11 of the stimulable phosphor sheet 10, 15 include metals such as gold, silver, copper, zinc, aluminum, titanium, tantalum, chromium, steel, nickel, cobalt, lead, tin, selenium and the like; alloys such as brass, stainless, bronze and the like; silicon materials such as silicon, amorphous silicon, glass, quartz, silicon carbide, silicon nitride and the like; metal oxides such as aluminum oxide, magnesium oxide, zirconium oxide and the like; and inorganic salts such as tungsten carbide, calcium carbide, calcium sulfate, hydroxy apatite, gallium arsenide and the like. High molecular compounds are preferably used as organic compound material usable for forming the support 11 of the stimulable phosphor sheet 10, 15 and illustrative examples thereof include polyolefins such as polyethylene, polypropylene and the like; acrylic resins such as polymethyl methacrylate, polybutylacrylate/polymethyl methacrylate copolymer and the like; polyacrylonitrile; polyvinyl chloride; polyvinylidene chloride; polyvinylidene fluoride; polytetrafluoroethylene; polychlorotrifluoroethylene; polycarbonate; polyesters such as polyethylene naphthalate, polyethylene terephthalate and the like; nylons such as nylon-6, nylon-6,6, nylon-4,10 and the like; polyimide; polysulfone; polyphenylene sulfide; silicon resins such as polydiphenyl siloxane and the like; phenol resins such as novolac and the like; epoxy resin; polyurethane; polystyrene, butadiene-styrene copolymer; polysaccharides such as cellulose, acetyl cellulose, nitrocellulose, starch, calcium alginate, hydroxypropyl methyl cellulose and the like; chitin; chitosan; urushi (Japanese lacquer); polyamides such as gelatin, collagen, keratin and the like; and copolymers of these high molecular materials.

Furthermore, although the absorptive regions 5 of the biochemical analysis unit 1 are formed of a plurality of bundles of nylon-6 fibers in the embodiment shown in FIG. 1, it is not absolutely necessary to form the absorptive regions 5 of a plurality of bundles of nylon-6 fibers. The absorptive regions 5 of the biochemical analysis unit 1 may be formed of other fiber material or porous material and the absorptive regions 5 of the biochemical analysis unit 1 may be formed by combining a porous material and a fiber material. A porous material for forming the absorptive regions 5 of the biochemical analysis unit 1 may be any type of an organic material or an inorganic material and may be an organic/inorganic composite material. An organic porous material used for forming the absorptive regions 5 of the biochemical analysis unit 1 is not particularly limited but a carbon porous material such as an activated carbon or a porous material capable of forming a membrane filter can be preferably used. Illustrative examples of porous materials include nylons such as nylon-6, nylon-6,6, nylon-4,10; cellulose derivatives such as nitrocellulose, acetyl cellulose, butyric-acetyl cellulose; collagen; alginic acids such as alginic acid, calcium alginate, alginic acid/poly-L-lysine polyionic complex; polyolefins such as polyethylene, polypropylene; polyvinyl chloride; polyvinylidene chloride; polyfluoride such as polyvinylidene fluoride, polytetrafluoride; and copolymers or composite materials thereof. An inorganic porous material used for forming the absorptive regions 5 of the biochemical analysis unit 1 is not particularly limited. Illustrative examples of inorganic porous materials preferably usable in the present invention include metals such as platinum, gold, iron, silver, nickel, aluminum and the like; metal oxides such as alumina, silica, titania, zeolite and the like; metal salts such as hydroxy apatite, calcium sulfate and the like; and composite materials thereof. A fiber material used for forming the absorptive regions 5 of the biochemical analysis unit 1 is not particularly limited. Illustrative examples of fiber materials preferably usable in the present invention include nylons such as nylon-6, nylon-6,6, nylon-4,10; and cellulose derivatives such as nitrocellulose, acetyl cellulose, butyric-acetyl cellulose.

Moreover, although the surface of each of the absorptive stripes 122a is processed so as to have a fractal structure, it is not absolutely necessary for the surface of each of the absorptive stripes 122a to have a fractal structure but it is sufficient for the surface of each of the absorptive stripe 122a to be processed by roughening so as to have a multiple projection structure, a micro-pore structure or the like.

Further, in the above described embodiments, the scanner shown in FIGS. 6 to 13 is constituted so as to read radiation data recorded in a number of the stimulable phosphor layer regions 12 formed in the stimulable phosphor sheet 10 and fluorescence data of a fluorescent substance such as a fluorescent dye recorded in a number of absorptive regions 5, 125 formed in the biochemical analysis unit 1, 121, thereby producing biochemical analysis data and includes the first laser stimulating ray source 21 for emitting a laser beam 24 having a wavelength of 640 nm, the second laser stimulating ray source 22 for emitting a laser beam 24 having a wavelength of 532 nm and the third laser stimulating ray source 23 for emitting a laser beam 24 having a wavelength of 473 nm. However, it is not absolutely necessary to read radiation data recorded in a number of the stimulable phosphor layer regions 12 formed in the stimulable phosphor sheet 10 and fluorescence data of a fluorescent substance such as a fluorescent dye recorded in a number of absorptive regions 5, 125 formed in the biochemical analysis unit 1, 121 by a single scanner to produce biochemical analysis data and radiation data recorded in a number of the stimulable phosphor layer regions 12 formed in the stimulable phosphor sheet 10 and fluorescence data of a fluorescent substance such as a fluorescent dye recorded in a number of absorptive regions 5, 125 formed in the biochemical analysis unit 1, 121 can be read by separate scanners to produce biochemical analysis data.

Furthermore, in the above described embodiments, biochemical analysis data are produced by reading radiation data of a radioactive labeling substance recorded in a number of the stimulable phosphor layer regions 12 formed in the stimulable phosphor sheet 10 and fluorescence data of a fluorescent substance such as a fluorescent dye recorded in a number of the absorptive regions 5, 125 formed in the biochemical analysis unit 1, 121 using the scanner shown in FIGS. 6 to 13. However, it is sufficient for a scanner for reading radiation data of a radioactive labeling substance and fluorescence data of a fluorescent substance to enable a number of the stimulable phosphor layer regions 12 formed in the stimulable phosphor sheet 10 and a number of the absorptive regions 5, 125 formed in the biochemical analysis unit 1, 120 to be scanned with a laser beam 24 or a stimulating ray, thereby exciting stimulable phosphor and a fluorescent substance and it is not absolutely necessary to read radiation data of a radioactive labeling substance and fluorescence data of a fluorescent substance using the scanner shown in FIGS. 6 to 13.

Moreover, in the above described embodiments, although the scanner shown in FIGS. 6 to 13 includes the first laser stimulating ray source 21 for emitting a laser beam 24 having a wavelength of 640 nm, the second laser stimulating ray source 22 for emitting a laser beam 24 having a wavelength of 532 nm and the third laser stimulating ray source 23 for emitting a laser beam 24 having a wavelength of 473 nm, it is not absolutely necessary for the scanner to include the three laser stimulating ray sources.

Furthermore, in the above described embodiments, the scanner shown in FIGS. 15 to 17 is constituted so as to read chemiluminescence data recorded in a number of the stimulable phosphor layer regions 17 formed in the stimulable phosphor sheet 15, thereby producing biochemical analysis data and includes the first laser stimulating ray source 21 for emitting a laser beam 24 having a wavelength of 640 nm, the second laser stimulating ray source 22 for emitting a laser beam 24 having a wavelength of 532 nm and the fourth laser stimulating ray source 55 for emitting a laser beam 24 having a wavelength of 980 nm. However, it is sufficient for the scanner to be constituted so as to read chemiluminescence data recorded in a number of the stimulable phosphor layer regions 17 formed in the stimulable phosphor sheet 15, thereby producing biochemical analysis data. Therefore, it is sufficient for the scanner to include the fourth laser stimulating ray source 55 for emitting a laser beam 24 having a wavelength of 980 nm and it is not absolutely necessary for the scanner to include the first laser stimulating ray source 21 for emitting a laser beam 24 having a wavelength of 640 nm and the second laser stimulating ray source 22 for emitting a laser beam 24 having a wavelength of 532 nm.

Moreover, in the above described embodiments, although the scanners includes the stimulating ray sources 21, 22, 23, 55 for emitting a laser beam 24, it is not absolutely necessary to employ a laser stimulating ray source as a stimulating ray source and an LED (light emitting diode) light source may be employed as a stimulating ray source instead of a laser stimulating ray source. Further, it is possible to employ a halogen lamp as a stimulating ray source and to provide a spectral filter to cut wavelength components which cannot contribute to the excitation.

Furthermore, in the above-described embodiments, the data producing system shown in FIGS. 18 to 21 is constituted so as to photoelectrically detect fluorescence emission and chemiluminescence emission and read fluorescence data and chemiluminescence data recorded in a number of the absorptive regions 5, 125 formed in the biochemical analysis unit 1, 121. However, it is not absolutely necessary for the data producing system to be constituted so as to read fluorescence data and chemiluminescence data but the data producing system can be constituted so as to only read chemiluminescence data. In such a case, the light emitting diode stimulating ray source 100, the filter 101, the filter 102 and the diffusion plate 102 can be omitted from the data producing system shown in FIGS. 18 to 21.

Moreover, in the above described embodiments, the scanner shown in FIGS. 6 to 13 and the scanner shown in FIGS. 15 to 17 are constituted so that all of the stimulable phosphor layer regions 12, 17 formed in the stimulable phosphor sheet 10, 15 or all of the absorptive regions 5, 125 formed in the biochemical analysis unit 1, 121 are scanned with a laser beam 24 to excite stimulable phosphor or a fluorescent substance such as a fluorescent dye by moving the optical head 35 using a scanning mechanism in the main scanning direction indicated by the arrow X direction and the sub-scanning direction indicated by the arrow Y in FIG. 13. However, all of the stimulable phosphor layer regions 12, 17 formed in the stimulable phosphor sheet 10, 15 or all of the absorptive regions 5, 125 formed in the biochemical analysis unit 1, 121 may be scanned with a laser beam 24 to excite stimulable phosphor or a fluorescent substance such as a fluorescent dye by moving the stage 40 in the main scanning direction indicated by the arrow X direction and the sub-scanning direction indicated by the arrow Y in FIG. 13, while holding the optical head 35 stationary, or moving the optical head 35 in the main scanning direction indicated by the arrow X direction or the sub-scanning direction indicated by the arrow Y in FIG. 13 and moving the stage 40 in the sub-scanning direction indicated by the arrow Y or the main scanning direction indicated by the arrow X in FIG. 14.

Further, in the above described embodiments, the scanner shown in FIGS. 6 to 13 and the scanner shown in FIGS. 15 to 17 are constituted so as to photoelectrically detect stimulated emission and fluorescence emission using the photomultiplier 50 as a light detector. However, it is sufficient for the light detector used in the present invention to be able to photoelectrically detect fluorescence emission or stimulated emission and it is possible to employ a light detector such as a line CCD or a two-dimensional CCD instead of the photomultiplier 50.

Furthermore, in the above-described embodiments, a solution containing specific binding substances such as cDNAs are spotted using the spotting device including an injector 6 and a CCD camera 7 so that when the tip end portion of the injector 6 and the center of the absorptive region 5, 125 into which a solution containing specific binding substances is to be spotted are determined to coincide with each other as a result of viewing them using the CCD camera 7, the solution containing the specific binding substances such as cDNA is spotted from the injector 6. However, the solution containing specific binding substances such as cDNAs can be spotted by detecting the positional relationship between a number of the absorptive regions 5, 125 formed in the biochemical analysis unit 1, 121 and the tip end portion of the injector 6 in advance and two-dimensionally moving the biochemical analysis unit 1, 121 or the tip end portion of the injector 6 so that the tip end portion of the injector 6 coincides with each of the absorptive regions 5, 125.

According to the present invention, it is possible to provide a biochemical analysis unit and a method for manufacturing the same which can prevent noise caused by the scattering of electron beams (β rays) released from a radioactive labeling substance from being generated in biochemical analysis data even in the case of forming in the biochemical analysis unit at a high density a plurality of spot-like regions of specific binding substances which can specifically bind with a substance derived from a living organism and whose sequence, base length, composition and the like are known, selectively labeling the plurality of spot-like regions with a radioactive labeling substance, thereby preparing the biochemical analysis unit, bringing the thus prepared biochemical analysis unit into close contact with a stimulable phosphor layer, exposing the stimulable phosphor layer to the radioactive labeling substance, irradiating the stimulable phosphor layer with a stimulating ray to excite the stimulable phosphor, photoelectrically detecting the stimulated emission released from the stimulable phosphor layer, and producing biochemical analysis data.

According to the present invention, it is also possible to provide a biochemical analysis unit and a method for manufacturing the same which can prevent noise caused by scattering chemiluminescence emission or fluorescence emission released from a plurality of spot-like regions of a biochemical analysis unit from being generated in biochemical analysis data even in the case of forming in the biochemical analysis unit at a high density the plurality of spot-like regions containing specific binding substances which can specifically bind with a substance derived from a living organism and whose sequence, base length, composition and the like are known, selectively labeling the plurality of spot-like regions with a labeling substance which generates chemiluminescence emission when it contacts a chemiluminescent substrate and/or a fluorescent substance, photoelectrically detecting chemiluminescence emission or fluorescence emission released from a plurality of spot-like regions of a biochemical analysis unit and producing biochemical analysis unit.

1. A biochemical analysis unit comprising a plurality of absorptive regions two-dimensionally formed so as to be spaced apart from each other by weaving a plurality of light shielding strips made of a material capable of attenuating radiation energy and/or light energy and a plurality of absorptive strips made of an absorptive material so that the light shielding strip is present between neighboring absorptive regions.

2. A biochemical analysis unit comprising a plurality of absorptive regions two-dimensionally formed so as to be spaced apart from each other by weaving a plurality of light shielding strips made of a material capable of attenuating radiation energy and/or light energy and a plurality of absorptive strips made of an absorptive material so that the light shielding strip is present between neighboring absorptive regions, the plurality of absorptive regions being selectively labeled with at least one kind of a labeling substance selected from a group consisting of a radioactive labeling substance, a labeling substance which generates chemiluminescence emission when it contacts a chemiluminescent substrate, and a fluorescent substance.

3. A biochemical analysis unit in accordance with claim 1 wherein each of the plurality of absorptive regions is formed of a porous material.

4. A biochemical analysis unit in accordance with claim 1 wherein each of the plurality of absorptive regions is formed of a carbon porous material or a porous material capable of forming a membrane filter.

5. A biochemical analysis unit in accordance with claim 2 wherein each of the plurality of absorptive regions is formed of a carbon porous material or a porous material capable of forming a membrane filter.

6. A biochemical analysis unit in accordance with claim 1 wherein each of the plurality of absorptive regions is formed of a plurality of bundles of fiber material.

7. A biochemical analysis unit in accordance with claim 1 wherein 10 or more absorptive regions are formed.

8. A biochemical analysis unit in accordance with claim 1 wherein each of the plurality of absorptive regions has a size of less than 5 mm².

9. A biochemical analysis unit in accordance with claim 1 wherein the plurality of absorptive regions are formed at a density of 10 or more per cm².

10. A biochemical analysis unit in accordance with claim 1 wherein the material capable of attenuating radiation energy and/or light energy has a property of reducing the energy of radiation and/or the energy of light to ⅕ or less when the radiation and/or light travels in the material by a distance equal to that between neighboring absorptive regions.

11. A biochemical analysis unit in accordance with claim 10 wherein material capable of attenuating radiation energy and/or light energy is selected from a group consisting of a metal material, a ceramic material and a plastic material.

12. A biochemical analysis unit comprising a plurality of absorptive regions two-dimensionally formed so as to be spaced apart from each other by weaving a plurality of sheets made of a material capable of attenuating radiation energy and/or light energy, each of which is formed with an absorptive stripe formed by roughening it in a longitudinal direction on the surface thereof, a plurality of light shielding strips made of a material capable of attenuating radiation energy and/or light energy and a plurality of light shielding sheets made of a material capable of attenuating radiation energy and/or light energy so that the light shielding sheet or a portion of the sheet where no absorptive stripe is formed is present between neighboring absorptive regions.

13. A biochemical analysis unit comprising a plurality of absorptive regions two-dimensionally formed so as to be spaced apart from each other by weaving a plurality of sheets made of a material capable of attenuating radiation energy and/or light energy, each of which is formed with an absorptive stripe formed by roughening it in a longitudinal direction on the surface thereof, a plurality of light shielding strips made of a material capable of attenuating radiation energy and/or light energy and a plurality of light shielding sheets made of a material capable of attenuating radiation energy and/or light energy so that the light shielding sheet or a portion of the sheet where no absorptive stripe is formed is present between neighboring absorptive regions, the plurality of absorptive regions being selectively labeled with at least one kind of a labeling substance selected from a group consisting of a radioactive labeling substance, a labeling substance which generates chemiluminescence emission when it contacts a chemiluminescent substrate, and a fluorescent substance.

14. A biochemical analysis unit in accordance with claim 12 wherein the surface of the absorptive stripe is roughened so as to have a fractal structure.

15. A biochemical analysis unit in accordance with claim 12 wherein 10 or more absorptive regions are formed.

16. A biochemical analysis unit in accordance with claim 12 wherein each of the plurality of absorptive regions has a size of less than 5 mm².

17. A biochemical analysis unit in accordance with claim 12 wherein the plurality of absorptive regions are formed at a density of 10 or more per cm².

18. A biochemical analysis unit in accordance with claim 12 wherein the material capable of attenuating radiation energy and/or light energy has a property of reducing the energy of radiation and/or the energy of light to ⅕ or less when the radiation and/or light travels in the material by a distance equal to that between neighboring absorptive regions.

19. A biochemical analysis unit in accordance with claim 18 wherein material capable of attenuating radiation energy and/or light energy is selected from a group consisting of a metal material, a ceramic material and a plastic material.

20. A method for manufacturing a biochemical analysis unit comprising the step of weaving a plurality of light shielding strips made of a material capable of attenuating radiation energy and/or light energy and a plurality of absorptive strips made of an absorptive material in such a manner that the plurality of light shielding strips and the plurality of absorptive strips extend in a first direction so that at least one light shielding strip is present between neighboring absorptive strips and that the plurality of light shielding strips extend in a second direction perpendicular to the first direction, thereby forming a plurality of absorptive regions so as to be two-dimensionally spaced apart from each other.

21. A method for manufacturing a biochemical analysis unit comprising the steps of weaving a plurality of light shielding strips made of a material capable of attenuating radiation energy and/or light energy and a plurality of absorptive strips made of an absorptive material in such a manner that the plurality of light shielding strips and the plurality of absorptive strips extend in a first direction so that at least one light shielding strip is present between neighboring absorptive strips and that the plurality of light shielding strips extend in a second direction perpendicular to the first direction, thereby forming a plurality of absorptive regions so as to be two-dimensionally spaced apart from each other, and selectively labeling the plurality of absorptive regions with at least one kind of a labeling substance selected from a group consisting of a radioactive labeling substance, a labeling substance which generates chemiluminescence emission when it contacts a chemiluminescent substrate, and a fluorescent substance.

22. A method for manufacturing a biochemical analysis unit in accordance with claim 20 wherein each of the plurality of absorptive regions is formed of a porous material.

23. A method for manufacturing a biochemical analysis unit in accordance with claim 20 wherein each of the plurality of absorptive regions is formed of a carbon porous material or a porous material capable of forming a membrane filter.

24. A method for manufacturing a biochemical analysis unit in accordance with claim 20 wherein each of the plurality of absorptive regions is formed of a plurality of bundles of fiber material.

25. A method for manufacturing a biochemical analysis unit in accordance with claim 20, which comprises a step of weaving the plurality of light shielding strips and the plurality of absorptive strips so as to form 10 or more absorptive regions.

26. A method for manufacturing a biochemical analysis unit in accordance with claim 20, which comprises a step of weaving the plurality of light shielding strips and the plurality of absorptive strips so that each of the plurality of absorptive regions has a size of less than 5 mm².

27. A method for manufacturing a biochemical analysis unit in accordance with claim 20, which comprises a step of weaving the plurality of light shielding strips and the plurality of absorptive strips so that the plurality of absorptive regions are formed at a density of 10 or more per cm².

28. A method for producing a biochemical analysis unit in accordance with claim 20 wherein the material capable of attenuating radiation energy and/or light energy has a property of reducing the energy of radiation and/or the energy of light to ⅕ or less when the radiation and/or light travels in the material by a distance equal to that between neighboring absorptive regions.

29. A method for producing a biochemical analysis unit in accordance with claim 20 wherein material capable of attenuating radiation energy and/or light energy is selected from a group consisting of a metal material, a ceramic material and a plastic material.

30. A method for producing a biochemical analysis unit comprising a step of weaving a plurality of sheets made of a material capable of attenuating radiation energy and/or light energy, each of which is formed with an absorptive stripe formed by roughening it in a longitudinal direction on the surface thereof, a plurality of light shielding strips made of a material capable of attenuating radiation energy and/or light energy and a plurality of light shielding sheets made of a material capable of attenuating radiation energy and/or light energy in such a manner that the absorptive stripes of the plurality of sheets are located below the light shielding sheets and above the light shielding strips, thereby two-dimensionally forming a plurality of absorptive regions so as to be spaced apart from each other.

31. A method for producing a biochemical analysis unit comprising the steps of weaving a plurality of sheets made of a material capable of attenuating radiation energy and/or light energy, each of which is formed with an absorptive stripe formed by roughening it in a longitudinal direction on the surface thereof, a plurality of light shielding strips made of a material capable of attenuating radiation energy and/or light energy and a plurality of light shielding sheets made of a material capable of attenuating radiation energy and/or light energy in such a manner that the absorptive stripes of the plurality of sheets are located below the light shielding sheets and above the light shielding strips, thereby two-dimensionally forming a plurality of absorptive regions so as to be spaced apart from each other, and selectively labeling the plurality of absorptive regions with at least one kind of a labeling substance selected from a group consisting of a radioactive labeling substance, a labeling substance which generates chemiluminescence emission when it contacts a chemiluminescent substrate, and a fluorescent substance.

32. A method for producing a biochemical analysis unit in accordance with claim 30 wherein the surface of the absorptive stripe is roughened so as to have a fractal structure.

33. A method for producing a biochemical analysis unit in accordance with claim 30, which comprises a step of weaving the plurality of sheets, the plurality of light shielding strips and the plurality of light shielding sheets so as to form 10 or more absorptive regions.

34. A method for producing a biochemical analysis unit in accordance with claim 30, which comprises a step of weaving the plurality of sheets, the plurality of light shielding strips and the plurality of light shielding sheets so that each of the plurality of absorptive regions has a size of less than 5 mm².

35. A method for producing a biochemical analysis unit in accordance with claim 30, which comprises a step of weaving the plurality of sheets, the plurality of light shielding strips and the plurality of light shielding sheets so that the plurality of absorptive regions are formed at a density of 10 or more per cm².

36. A method for producing a biochemical analysis unit in accordance with claim 30 wherein the material capable of attenuating radiation energy and/or light energy has a property of reducing the energy of radiation and/or the energy of light to ⅕ or less when the radiation and/or light travels in the material by a distance equal to that between neighboring absorptive regions.

37. A method for producing a biochemical analysis unit in accordance with claim 30 wherein material capable of attenuating radiation energy and/or light energy is selected from a group consisting of a metal material, a ceramic material and a plastic material.
